(19) United States
(12) Patent Application Publication
(10) Pub. No.: US 2004/0181800 A1
(43) Pub. Date: Sep. 16, 2004

(54) Thin DOCSIS in-band management for interactive HFC service delivery

(76) Inventors: Selim Shlomo Rakib, Cupertino, CA (US); Paul Alan Lind, Santa Cruz, CA (US); David Alan Pechner, San Jose, CA (US)

Correspondence Address: RONALD CRAIG FISH, RONALD CRAIG FISH, A LAW CORPORATION, POST OFFICE BOX 2258, MORGAN HILL, CA, 95038, US

(21) Appl. No.: 10/678,674

(22) Filed: Oct. 2, 2003

Related U.S. Application Data
(63) Continuation-in-part of application No. 10/389,728, filed on Mar. 13, 2003.

(51) Int. Cl. H04N 7/173; H04N 7/16

(52) U.S. Cl. 725/25; 725/100; 725/131

(57) ABSTRACT

Circuitry and processes carried out thereby are disclosed for implementing simple single tuner set top box decoders which do not require a separate tuner for an out of band management and control channel. Removable smart card conditional access circuitry and replaceable modules having decoding circuitry for different compression schemes and encoding circuitry for different format television circuits is disclosed. An embodiment with a single tuner and a full DOCSIS compatible modem which can interface to personal computers, etc. is also disclosed to make the set top box a simple, inexpensive home gateway is also disclosed.

### BACKGROUND OF THE INVENTION

The invention pertains to use of a DOCSIS in-band management channel for management of broadband services delivery such as video-on-demand over cable television Hybrid Fiber Coaxial (HFC) cable systems and the resulting simplification of set top adapters for receiving digital television transmissions.

Video services such as video-on-demand (VOD) has been delivered in the prior art over HFC systems. The treatise Michael Adams, “Open Cable Architecture” (2000 Cisco Press) ISBN 1-57870-1 35-X, the entirety of which is hereby incorporated by reference, describes the state of the prior art of digital cable television. Chapter 4, pp. 49-84 describes digital television technologies for compression of video, audio, data and system information and baseband and broadband transmission mechanisms. Chapter 5 describes adding digital television services to cable systems, and out-of-band data communications for management. Chapter 6 describes the conventional digital set top converters for digital television. Chapters 8 and 10 describes interactive and on-demand services such as movies and music on demand, post broadcast on demand, distance learning and other services. Chapter 9 and 11 describes case studies in interactive and on demand cable systems.

Interactive services provide extensions to the cable system to provide a new class of services such as home shopping, home banking, e-mail, web access, gaming, stock tickers, all of which were previously supplied by connections to the internet through ISPs and dial up, ISDN, DirecPC, etc.

Several prior art attempts to deliver interactive services over HFC have been implemented in field trials. Both used an out-of-band channel for transmission of software downloads and management and control data between the client set top decoders and the servers at the head end. The Time Warner Full Service Network (FSN) started in February 1993 to deliver VOD, sports on demand, news on demand as well as interactive video games, home shopping, long distance access, voice and video telephone and personal communication services and Web browsing as well as traditional analog CATV services. Eight media servers were connected to disk vaults via SCSI-2 interfaces. The disk vaults provided enough storage for about 500 movies. For the forward path, the media servers were connected to and ATM switch via a SONET OC3 connection. A total of 48 OC3 connections provided for 5,184 Mbps of usable payload bandwidth after SONET and ATM overhead were subtracted. The ATM switch was connected to a bank of 64-QAM modulators. 152 DS3 links provided 5,600 Mbps of payload capacity from the ATM switch to the neighborhoods after overhead. The QAM modulator outputs are tuned in the frequency range from 500 to 735 MHz with the forward digital channels spaced at 6 MHz. The 6 MHz analog CATV channels occupied the spectrum from 50 to 500 MHz. The combined RF signal from 50 to 735 MHz was used to modulate a laser which drove a single mode fiber which took the signal out to the neighborhood about 10 miles away. At the neighborhood, the optical signal was converted back to RF in the optical node and used to feed a coaxial cable network which passed about 500 subscribers. The RF signal fed the home communications terminal or digital set top converter (HCT) in each home. The HCT was a powerful RISC based multimedia computing engine with video and audio decompression and extensive graphics capability. The HCT also included an analog set top converter for the CATV analog signals. An ATM addressing scheme allowed data to be addressed to any HCT. The upstream path was a QPSK modulated signal transmitted by each HCT in the 900 to 1 GHz frequency band with carriers at 2.3 MHz spacing, each channel having a 1.152 Mbps data rate after ATM overhead. Each upstream channel was time division multiplexed so multiple HCTs could share the same channel with bandwidth awarded by the headend in downstream messages on a forward channel so that only one HCT was enabled to transmit during any given time slot. By default, each HCM had access toa 46 Kbps constant bit rate (CBR) ATM connection. The upstream RF is converted to optical signal at the optical node and separate optical fibers are used to carry the upstream and downstream. At the headend, the optical signal is converted back to RF and then fed to a bank of QPSK demodulators which convert the ATM cell stream to ATM format T1 link. The outputs of the demodulators is combined by an ATM demultiplexer which does traffic aggregation and conversion from DS1 to DS3 rates and outputs ATM format DS3 streams o the ATM switch which passes the data to the media servers. An ATM addressing scheme allows any HCT to send to any server.

The connection manager was a distributed set of processes which run on the media servers. In response to an application request for a connection with a given quality of service, the connection manager determines a route, allocates connection identifiers and reserves link bandwidth. The connection identifiers are passed to the media server and HCT via the out-of-band channel it is believed by the applicants. On demand services use the connection manager to establish a constant bit rate ATM connection for each media stream from a server to the HCT. This constant bit rate stream is required to guarantee quality of service of the connection so the cell loss rate is less than a predetermined figure of merit needed to transmit high quality MPEG compressed video streams. The use of a connection for each application request would quickly overload the system with excessive overhead it was found however for the distributed application environment, so connections were reserved for only on-demand services and all other communication sessions such as IP networking traffic were relegated to connectionless networks.

Each HCT was given three IP addresses at boot time: a fast IP address for a fixed 8 Mbps connection in each forward application channel; a slow IP address for a netword using a fixed 0.714 mbps connection in each forward application channel; and a control IP using a forward QPSK channel with a 1 Mbps capacity. The fast IP network was used for application downloads initiated by file transfer requests from the HCT. Application programs were compressed. The slow IP network was used for general communications between the client and server parts of a distributed application. The HCT could send and receive on this slow IP network while the application was executing.

The slow IP network supported the distributed computing model by carrying communications that allows a client application in an HCT to invoke a remote procedure call over the slow IP network to cause a process in the server at the head end to run. This simplified the development of distributed applications. The HCT had considerable resources and performed the lion's share of processing and were considered thick clients since the HCTs were responsible for the presentation layer functions without any help from the headend servers. Much less communication between server and client HCT is required by this model since the server was just mainly retrieving data objects such as a text string for sending to the HCT, and the thick client HCTs then would do all the processing to present it as an animated object overlay. This required much less communication that a thin client HCT where the server would send an animated overlay for display by the HCT client. Because of the thick clients, the servers could be designed to support many client instances without having to maintain a separate context for each one. Thus, thin clients were discouraged in this network because of the excessive demands on the network for communications on the slow IP network.

Interactive services provided by the Time Warner Full Service Network (hereafter FSN) included navigation, games, home shopping and video-on-demand. Navigation services included analog tuning, interactive program guide that allows customer to scroll through a grid of time vs channel, parental controls, subscriber preferences and configuration.

The FSN applications to implement interactive services required significant network resources in each area of interactive service. Software downloads to the HCT to load the application needed to implement whatever interactive service a user requested through the HCT remote control such as selecting a channel to view, responding to an on-screen dialog. All FSN applications require two-way communication with the head end with varying quality of service requirements. For example, navigation and home shopping use best efforts in most cases, but streaming video or audio was requested, guaranteed quality of service was required to implement it.

The control IP network was mapped onto a 1 mbps ATM connection on each forward control channel (out-of-band), and was used for general control signaling to all HCT in a neighborhood. Thus, significantly to the cost and complexity of the system, multiple out-of-band forward control channels were used for overhead management and control traffic on the control IP network.

It was found that the distributed applications using connectionless networks had a need for connectionless overhead signalling traffic because of the use of multiple short bursts, and it was found that the IP network protocol provided a useful way to do this signaling. The protocol stack for this prior art system is shown in FIG. 1. The connectionless communication protocols that support the distributed applications environment of the interactive services are on the left of the diagram, and the connection oriented protocols that support the on demand streaming video and audio services are on the right of the diagram. It was found in the FSN that interactive service require a different communication model than on-demand services because interactive services were bursty and best supported by an IP network whereas on-demand video and other streaming media required a continuous stream of data that was best provided by a connection oriented network such as that provided by ATM.

Although the FSN HCTs were expensive, highly capable machines with 100 MIPs capacity, the demands of being a thick client brought them to their knees so to speak. Real time composing of live video and graphics in software put a tremendous load on the CPU. At 60 fields per second, the CPU had just 16 milliseconds to render graphics before the field is displayed, and the field cannot be late. Even though audio and video decompression was done in hardware, a faster 140 MIPs version of the HCT was soon required to support FSN applications.

Another drawback of the FSN network was found to be massive waste of upstream bandwidth caused by the headend allocated TDMA scheme. This is because it used a fixed bit rate allocation to each HCT, and the allocation was wasted most of the time. As a result, the DAVIC out-of-band (OOB) protocol was developed to include a reservation protocol that allows many more HCTs to share a given out-of-band return channel. Sharing of the out-of-band return channel however required a separate media access control (MAC) protocol similar to that used by the shared media to regulate upstream transmissions by the HCTs. The MAC protocol most often used for the OOB return channel is similar to the Ethernet Collision Sense protocol. The out-of-band channels required at least separate tuner and software to implement the MAC protocol thereby further increasing the expense of each HCT.

A direct descendant of FSN was the Pegasus system which started in 1995. At that time, the major stumbling block to success was the cost of the interactive set top receiver/decoder which tuned to the carrier carrying the digital data and demodulated, decoded, decrypted, decompressed and encoded the decompressed data into a suitable television signal, hereafter referred to in all its different species as the set top box. The Pegasus Orlando deployment had only 4000 set top boxes, so the cost was manageable, but nationwide deployment interactive and on demand services was an entirely different story in terms of the cost of set top boxes (STB) so STB cost became the critical factor in the design of Pegasus. Pegasus adopted a Trojan Horse strategy in an attempt to reduce the STB cost. The idea was to include interactive feature support in the STB at a small incremental cost over the circuitry required for the broadcast processing, but these circuits and applications appear only when interactive services are developed and delivered by the cable operator.

The Pegsus network uses a real time, two-way network that linked the STBs to the headend to support interactive services. This two way network was based upon standard networking protocols and equipment but was designed for low service penetration. All the same interactive services were provided as FSN but at a much lower cost. Lowering the cost was enabled by:

(1) using data carousels wherever possible to reduce transactional and network traffic required to download interactive applications;

(2) the DAVIC OOB protocol definition was used to support sharing of the return oout-of-band channel by many more bursty traffic sources (this reduced the number of QPSK demodulators per distribution hub by a factor of 15 compared to FSN);

(3) the operating system and navigation software are always resident in the Pegasus STB thereby greatly reducing the network resources consumed by software download but increasing the cost of the STB; and

(4) the use of MPEG-2 transport to deliver both digital broadcast as well as interactive services.

Pegasus 2 was the first network to use MPEG-2 transport to deliver interactive multimedia over a switched network. MPEG-2 transport is more efficient than other transport protocols such as ATM and IP, and MPEG-2 transport includes support for synchronization, statistical multiplexing and conditional access functions. MPEG-2 transport provides an integrated transport solution for both broadcast and on-demand services and provide the advantages of low overhead and it is designed for one way services such as video-on-demand. Apparently, the out-of-band channel was used for upstream communications indicating the desired video program. Another advantage of MPEG-2 transport is the STB is capable of both broadcast and on demand services, and MPEG-2 supports data as well as video and audio encapsulation using the private data section mapping. Pegasus showed us that MPEG-2 was an ideal solution for integrated delivery of digital broadcast and on demand services. Compare this to FSN which used an ATM-to-the-home switchng network to provide both interactive and on-demand services including VOD but at a high cost for the thick client STB. The FSN used ATM both for its switching and transport protocol needs. ATM is very inefficient for unidirectional traffic. It was found to be wasteful of upstream bandwidth because of the asymmetric traffic pattern generated by on demand services and it was wasteful of capacity of ATM equipment which was designed for bidirectional operation and not the asymmetric traffic of VOD and other on demand services. ATM overhead is about 12% (mainly caused by the 5 byte ATM header in every cell). There was additional cost in the headend and every STB to provide ATM adaptation circuitry and software in FSN which made the system more expensive and difficult to justify for nationwide deployment with millions of STBs. This extra circuitry was necessary because digital broadcast technologies are all based on MPEG-2 transport protocol so every digital broadcast service in FSN had to be adapted to ATM at the headend or every STB had to support both ATM and MPEG-2 transport protocols.

The FSN delivered MPEG-2 streams over an ATM infrastructure. FIG. 4 shows the communication protocol stack used to do this. The bottom frequency division multiplexing layer (FDM) divided the broadband spectrum into a number of channels. NTSC channels carried analog broadcast, QAM channels carreid digital services such as digital broadcast and interactive and on demand services, and QPSK channels carried signalling and control traffic. For the QAM channels to carry MPEG audio and video, an adaptation layer was required to provide error-correction and framing functions. This layer packed ATM cells into a framing structure so the STB could recognize the individual cells in the QAM bit pipe. An AAL-5 adaptation layer provided the functionality to allow large blocks of MPEG data to be segmented into ATM cells for delivery through the ATM switching network. At the STB, AAL-5 was used to reassemble the MPEG packets for decoding into video and audio.

In FSN, TCP/IP data had IP data blocks segmented using ML-5 into ATM cells, and the IP data blocks were reassembled at the STB using AAL-5. The STB distinguished between audio, video and data by the Virtual Channel Identifier (VCI) carried in the header of every ATM cell. This allowed the STB (HFC) to simultaneously receive audio, video, and data streams over a QAM channel without confusion.

In the FSN, MPEG data delivery to the STB via ATM cells and infrastructure had to be managed to ensure that the customer saw a smooth, high quality video with correctly synchronized audio. To do this, the MPEG data was stored on a disk storage system and fetched in large blocks. The MPEG data was then segmented using ML-5 into ATM cells which were transmitted at a constant rate to ensure that the STB did not get overrun and drop cells causing video quality to suffer. The STB filtered ATM cells based on their VCI and selected only cells for the chosen video flow and reassembled the MPEG packets from the chosen ATM cells using AAL-5. An MPEG decoder then reconstructed the original video signal from the MPEG packets. Video signals are extremely time-sensitive, and delivery of the MPEG data had to be at exactly the same rate as the MPEG decoding. In analog video delivery, the horizontal and vertical synchronization pulses synchronized the TV display, but there is no such mechanism in ATM networks because they are switched and use multiple, asynchronous physical links to deliver the cells. This problem was solved in FSN by sending ATM timestamps from a master clock at the server. The server clock ensured that the disk reads and the ATM card writes happen at the correct time to ensure MPEG data is played out of the server and transmitted on the network at the correct rate. At the STB, timestamps from the server clock are received frequently. The STB has its own clock which is driven by an accurate voltage controlled crystal oscillator (VCXO). The timestamps were used to adjust the frequency of the VCXO to keep the STB clock synchronized with the server clock. An MPEG buffer holding MPEG data for the MPEG decoder in the STB had to be carefully managed to prevent overflow and underflow.

The Pegasus-2 system, in contrast to FSN, added incremental on demand services to an existing digital broadcast network that supported real-time, two-way signaling. Significant transport cost reductions were achieved by using MPEG-2 transport from server to STB and eliminating the ATM infrastructure of FSN. MPEG-2 transport is more efficient than IP or ATM transport and MPEG-2 transport includes support for synchronization, statistical multiplexing and conditional access functions.

However, use of MPEG-2 transport also caused problems peculiar to the use of MPEG-2 transport streams. MPEG-2 transport was not designed for the high speed data transport needed for the high speed data such as broadband internet access which was provided over and above streaming video and audio in on demand services. However, this problem was solved by mapping the high speed data into the private data sections of MPEG-2 transport streams. Another stroke of luck for Pegasus was that the DSM-CC data carousel specification included an efficient segmentation function for mapping large data carousel packets into MPEG-2 transport packets.

MPEG-2 was also not designed as a wide area network protocol since it does not include any connection managment protocols or any connectionless routing mechanisms. Therefore, adapting MPEG-2 to a switched network was challenging for the Pegasus designers. This problem was overcome in the Pegasus prior art by design of the complex QAM switching matrix to implement an MPEG-2 transport switch, as shown in FIG. 3. Each media service was coupled to a row of QAM modulators by an MPEG-2 native (no protocol translation needed) DVB asynchronous serial interface whcih could saturate up to 5 256-QAM channels. Each set top group shared a bank of on-demand channels which contained 6-8 QAM channels. If a media server failed, the customer would lose service but could reorder the service and be coupled through the QAM switching matrix to another media server.

The QAM switching matrix provided only limited switching because the dimensions of the switch matrix were determined by M, the number of on demand channels in the bank, multiplied by N, the number of QAM modulator per media server, multiplied by the number of streams in an on demand channel (6-8).

Another problem with the Pegasus MPEG-2 transport mechanism is that it assumes a constant delay network because it was designed for broadcast and not switching networks.

FIG. 2 is a diagram of the channel types in the Pegasus system. Note that the Pegasus 2 system uses out-of-band channels just like the FSN.

Digicable is another prior art system supplied by General Instrument for end-to-end satellite and cable system distribution networks. It too used an out-of-band data channel to deliver common system information associated with all in-band channels. Out-of-band traffic in these prior art systems included: Entitlement Management Messages (EMM) addressed to individual STBs and carrying conditional access secure authorization instructions for requested services; Service Information that supports the STB navigation application with information about the requested service; program guide information to display what is on the various channels at various times; an Emergency Alert System messages to cause the STB to display a text message, play an audio message or force tuning to an alert channel.

### MAJOR PROBLEMS WITH THE PRIOR ART

At least two major problems exist in the FSN and Pegasus prior art. Software download to the set top has several advantages, but it also has several significant disadvantages. A major advantage of software download to the STBs is that it simplifies the hardware and software of the STB because the STB does not need to have sufficient memory to store all the needed applications. Memory is expensive, so this advantage makes each STB less expensive to build. This is a significant advantage since millions of STBs need to be built for nationwide deployment of interactive and on demand services. Another major advantage of software download is that new applications for new services can be added at the head end and propagated to any STB over the HFC thereby making the STB future proof. Further, application bugs can be fixed and updated at will without rendering all the STBs obsolete.

A significant disadvantage is that software download increases greatly the amount of upstream network traffic from the STB to the server telling the server what application software to download each time the user presses a button to change the channel or invoke any other service. With thousands of STB and with an out-of-band channel carrying this upstream traffic with limited bandwidth, many problems are caused. Among them are contentions and delays for the available bandwidth and the complications and expense of a separate media access control protocol and separate tuner just for the OOB channel to carry management traffic.

Another significant disadvantage of software download is that it takes time to download the application software. Small applications can be downloaded over a high speed channel in a fraction of a second, but downloading a large application introduces delays and consumes large amounts of network capacity. Also, if a download server or channel is unavailable, the customer will see a loss of service. Making the navigator application resident on the STB reduces this problem but makes the STB more expensive.

Several mechanisms have been used in the prior art for software download. The first is a data carousel wherein software applications and data such as program guide data are continuously transmitted as a set of files over a QAM channel. The STB then just picks the necessary application and data files out of the stream. This causes delays in waiting for the right files and consumes network downstream bandwidth unnecessarily when the need by STBs for files is light. An MPEG-2 transport stream private data portion can also be used for application and data download by placing the application or data in a separate program elementary stream (PES). When the STB selects an MPEG-2 program, the STB activates a loader application which listens to the PES and recovers the data. As the application programs are received, the loader program places them in memory and launches them. Also, an out-of-band channel providing point-to-point service between the server and the STB can also be used, but this requires the STB to have a separate tuner and MAC protocol just for the OOB channel thereby making the STB more expensive. Further, the OOB downstream channel can easily become overwhelmed by the software download traffic if used to download applications for all the interactive and on demand services.

Another major problem with all the FSN, Pegasus and Digicable prior art systems was the use of out-of-band channels to communicate system information. As mentioned previously, use of an OOB for upstream and downstream management traffic requires the STB to have separate receiver and transmitter because the OOB channels are frequency division multiplexed on the HFC from the channels carrying digital and analog services. Use of an upstream OOB shared by multiple STBs also requires each STB to have a MAC protocol if the STB will transmit spontaneously without waiting for a poll from the head end. Accordingly, there is a need for a simple STB with a single tuner that can utilized the in-band management via the DOCSIS PID. There is also a need for a simple single tuner STB which has a full DOCSIS compatible cable modem which can interface to a personal computer or other devices which have a need to send and receive data to a headend or to servers coupled to the headend via full DOCSIS upstream and downstream channels over the same CATV system which is carrying digital video programming so as to act as a simple home gateway. A U.S. patent application on a home gateway filed by the assignee of this invention is hereby cited and is incorporated by reference herein. It is entitled HOME NETWORK FOR ORDERING AND DELIVERY OF VIDEO ON DEMAND, TELEPHONE AND OTHER DIGITAL SERVICES, and has Ser. No. 09/483,681 and was filed Jan. 14, 2000. Other home network US patent applications cited hereby are: A PROCESS CARRIED OUT BY A GATEWAY IN A HOME NETWORK TO RECEIVE VIDEO-ON-DEMAND AND OTHER REQUESTED PROGRAMS AND SERVICES, Ser. No. 09/602,303, filed Jun. 23, 2000; and HOME GATEWAY FOR VIDEO AND DATA DISTRIBUTION FROM VARIOUS TYPES OF HEADEND FACILITIES AND INCLUDING DIGITAL VIDEO RECORDING FUNCTIONS, Ser. No. 09/898,675, filed Jul. 03, 2001, both of which are cited hereby and incorporated by reference.

Some prior art cable systems have used in-band delivery of system messages as part of the 6 MHz channel, but the conventional wisdom is that in-band delivery has several significant problems. First, to guarantee delivery, the in-band management messages have to be simulcast on every 6 MHz channel since the STB tuner could be tuned to any channel and can only be tuned to one channel at a time. Simulcasting on every channel consumes a considerable amount of system bandwidth and requires message insertion equipment for every channel thereby making the head end more complex and expensive. Further, NTSC analog channels have very limited (about 9,600 bits per second) capacity to carry digital information in the vertical blanking interval. Further, in one way systems where there is no return path, system messages are broadcast as a circular queue which is repeatedly transmitted. In large systems, this causes considerable queuing delay because of the volume of system messages. Digital channels provide a considerable increase in data capacity, but system messages must be delivered regardless of whether the STB is tuned to an analog or a digital channel so it is impossible to take advantage of the increased payload of digital channels. This problem can only be solved by including in the STB separate tuners for the analog and digital channels, but this increases the cost of the STB.

Direct Broadcast Satellite (DBS) systems have no OOB channel, and every channel is digital and carries 6-12 subchannels of services. Management and control messages are simulcast in-band as a data carousel on each digital channel at a rate of several hundred kilobits per second thereby consuming an overhead of about 1%. This is because there is no real time upstream in a DBS system. Therefore, because a tuner may be tuned to any channel on the system and may need any particular application software or other piece of M&C data, all the M&C data must be transmitted on all channels continuously on a revolving data-carousel basis. There is a phone line connection to each DBS receiver, but it is only used for callback purposes to upload pay-per-view data and verify that the DBS receiver is still where the customer originally said it was and has not been moved to a neighbor's house. Because there is no real time upstream in a DBS system, the headend does not know to which channels various tuners in the system are tuned. That is why M&C data must be simulcast on every channel. However, DBS receivers are single tuner and M&C data is transmitted in-band so they probably represent the closest prior art. DBS receivers however still need a separate modem and software to send data upstream.

The need to simulcast M&C data on all channels in DBS systems is why cable system operators value the OOB highly. The OOB channel eliminates the need to simulcast management and control messages on every channel simultaneously and waste large amounts of bandwidth. However, an OOB channel requires a separate tuner in the STB which complicates it and renders it more expensive.

Early OOB channels were limited in-bandwidth, but with higher rate silicon chips now available, system messages only occupy 10% of OOB channel capacity. However, each STB still needs an OOB tuner and an upstream MAC protocol in addition to the tuners for the digital and analog forward channels so the STB is more expensive than it needs to be. The remaining 90% is ear marked for extended services like e-mail, extended program guides, network games, etc.

Upstream OOB channel options availble in the prior art are DVS-178, DVS-167 (developed by the Digital Audio Video Council or DAVIC) and DOCSIS cable modem. The DOCSIS cable modem standard was designed as an in-band mechanism for data transport, but if an additional tuner is added to the STB, with one of the tuners devoted to the DOCSIS channel, the DOCSIS data transport protocol can be made to perform all the functions of DVS-178, DVS-167 in the out-of-band channel. This still requires the use of at least two tuners (one of which is in the DOCSIS cable modem) in the STB and it requires all the circuitry and software of a DOCSIS cable modem to implement the DOCSIS protocol to send and receive management messages on the OOB.

OOB channels as they have evolved today, as with any data communications network, require protocols for address management, message routing, network management and the like. The OOB channel can use the TCP/IP protocol to avoid re-inventing the wheel. TCP/IP provides a connectionless service to each STB that allows messages to be sent to each STB individually without the overhead of establishing a connection which is very important because there may be thousands of STBs. TCP/IP capable routers and equipment are readily available and cheap, and provides the ability to aggregate return channel traffic to efficiently use the upstream bandwidth.

However, an OOB still requires a separate tuner in the STB and circuitry and software to implement these protocols thereby complicating the STB.

Sony is believed to have developed and deployed via Cable Vision an interactive video delivery system that uses DOCSIS for a bidirectional OOB channel with interactive and VOD services delivered on a different non DOCSIS MPEG-2 multiplex. This system still needs two tuners in each STB, one for the video and the other in the DOCSIS modem within the STB and still suffers from the disadvantages of having to use an out-of-band channel. The DOCSIS modem just replaces the QPSK OOB transceiver circuitry in the Pegasus STBs. Conditional access is believed to be carried out in a conventional manner.

The simulcast of data carousels of system management data, conditional access keys, application programs, program guide data, etc. even on an OOB channel is wasteful. Most of the consumed downstream OOB bandwidth is wasted because the STBs that are in operation at the time and tuned to the OOB channel do not need most of the information which is in the data carousel.

Sending of conditional access data in-band is not new as EMM messages have been sent in the prior art on the private data PID of an MPEG transport stream. A company called Canal+ from France and its competitors Nagravision and NDS provide encyrption services to the satellite direct broadcast systems and other systems. Canal+ is a provider of digital and interactive TV software solutions for set top boxes on cable, satellite and digital terrestial networks. The Canal+ open digital interactive TV system is marketed under the trademark Media Highway. This system allows consumers to turn their televisions into multimedia home entertainment centers by allowing consumers to connect digital devices such as DVD, DVHS and home computers to their set top boxes and allows fast internet access via satellite, cable, terrestial and modem networks as well as push technology that provides continuous broadcasting of data to subscribers such as stock exchange information. The Media Highway provides two types of interactivity: carousel and online. Carousel interactivity meant that data such as that comprising electronic program guide data is broadcast cyclically to customers which they can then interact with locally. Usually this is done when there is no return path. In this carousel type interactivity, conditional access keys are sent in-band ahead of time and stored in the set top boxes for use when needed. In other words, all working keys for all services to which a customer having that STB has subscribed and session keys for that set top box are sent to the set top box ahead of time and stored there. The encrypted data of the program is broadcast cyclically as a data carousel. When the user wants to view an encrypted program, the appropriate keys are read from storage and used to decrypt the video program or service data. The other form of interactivity is online. Online interactivity means there is some sort of return path which allows the STB to send messages upstream to a remote server requesting services for example or requesting download of the software application for an interactive network game for storage and execution on an STB. Software upgrades and patches for the STB can be downloaded and stored in STB flash memory and software applications can be downloaded into flash memory as resident applications or into RAM of the STB when needed.

The Media Highway system provides for security by providing a proprietary application program authentication system to authenticate software to be downloaded at the transmission level. The Media Highway system also provides a conditional access system which controls user access to individual programs through smart cards inserted into the STB (or other implementations of a secure processor). Downloaded application programs are authenticated so pirated applications that do not pass the authentication process cannot be executed. All this is implemented by building a Media Highway middleware virtual machine in each STB with a unique Device Layer Interface (DLI) which the manufacturer of the STB must build its STB to be compatible with. If the STB is built to port to the DLI, its card reader, modem, LED display, clock and loader software will work with the Media Highway virtual machine and allow the above noted features to be used. If the manufacturer uses application development tools supplied by Canal+ to develop software, it will be compatible with the virtual machine.

The Canal+ conditional access system is marketed under the trademark MediaGuard. Under this system, a subscription authorization system at the headend delivers access rights in the form of session keys in Entitlement Management Messages (EMMs) to the smart cards inserted in the STB of a customer who has ordered an encrypted service. There are two ciphering units. The first encrypts the EMM to be sent to an STB, presumably with the private user key of the STB which ordered the service. The other cipher unit is located at the digital broadcast center and encrypts the service keys in Entitlement Control Messages. The service keys are keys which are used to encrypt the payloads of the packets containing the data of the service. The ECMs are inserted in the broadcast MPEG transport streams of the MPEG multiplex. These ECMs are recovered and the encrypted service keys therein are decrypted using the session keys in the EMM message. The EMM are sent in the MPEG multiplex also, probably in MPEG packets having the private data PID. At the STB, the encrypted ECM and EMM messages are sent to the secure processor in the smart card and the private user key is used to decrypt the EMM message and recover the session key. The session key is then used to decrypt the ECM message and recover the control word or service key which is sent to the decryption engine to decrypt the payloads of the MPEG packets bearing the service data.

The ECMs and EMMs are believed to be sent to STBs in the MediaGuard prior art on a targeted basis if there is an upstream return path, and the ECMs are believed to be sent as a data carousel if there is no return path with targeted EMM messages sent in-band ahead of time to all STBs that have subscriptions to certain services for storage. This allows the STB to call the session key out of memory when the user orders a service to which he has subscribed and use the session key to recover the service key or control word. The ECMs are still believed to be sent as a data carousel even when there is a return path.

In this Canal+ prior art system, impulse pay per view requires the use of tokens in the smart card wallet and a callback procedure via some data path, usually a telephone line, to collect payment information from the smart card. This requires special communication servers to imlement the callback procedure and process the collected data. The callback does not happen in real time so the success of an event is not immediately known until the callbacks are made. In contrast, using the DOCSIS in-band M&C downstream channel and a coupled DOCSIS upstream channel to send and receive M&C and conditional access data does not require a special communication server to do the callback from the head end and allows immediate determination the success of an event based upon the number of subscribers.

The Canal+ advanced pay-per-view mode of operation is the same as the impulse pay-per-view operation but also includes a real-time, on-line PPV mode wherein one of the communication servers used for the callback receives direct upstream real time commands from the STB, a touch tone telephone, an interactive videotext service such as the Minitel or requires an OOB channel to send upstream data with the necessary circuitry and MAC protocol in the STB for the OOB channel.

Therefore, a need has arisen for methods and apparatus to solve all these problems including primarily reducing the cost of the set top decoder boxes needed to receive digital broadcasts, interactive and on demand services, allowing the use of application software download, simplifying and rendering more efficient the data carousel and conditional access functions in a way that they can be carried out with targeted transmissions in real time to specific STBs so as to not waste bandwidth.

### SUMMARY OF THE INVENTION

According to one significant teaching of the invention, the expense and complexity of the set top boxes in an interactive digital cable system can be reduced by eliminating the out-of-band channels of the prior art systems and allowing single tuner STBs. This is done by transmitting the management and control data (hereafter the M&C data) in-band in the same RF channel the encrypted service data is transmitted upon. This is done by encapsulating the M&C data in RPEG packets having the DOCSIS PID and putting these packets in an MPEG-2 transport stream used to deliver the compressed audio, video and data of the delivered services (digital broadcasts, interactive and on demand services hereafter referred to as the services). A pure DOCSIS upstream in the RF on the HFC is used for upstream M&C data. This eliminates the OOB tuner in prior art STBs and eliminates the upstream phone line modem and associated software in the DBS receivers. A single DOCSIS cable modem modified according to the teachings herein can tune the services and recover the MPEG packets thereof, and can tune and recover the MPEG packets containing the M&C downstream data including conditional access data, and send M&C upstream data in real time on a pure DOCSIS upstream channel in the RF spectrum of the HFC. In alternative embodiments, the tuner and QAM demodulator of the simple STB can be prior art tuner and QAM demodulators used to receive native MPEG encoded digital video broadcasts or video on demand. In some embodiments, a full DOCSIS compatible cable modem is included in the single tuner STB to give it home gateway functionality so that the STB can allow personal computers and other devices which need to send and receive DOCSIS digital data to a headend to do so through the DOCSIS cable modem in the STB thereby providing a low cost home gateway.

The simple STB is comprised of: at least one QAM tuner; at least one QAM demodulator; a transport stream demultiplexer; a conditional access decryption circuit; a decoder to decompress the compressed packets of requested video programs; an encoder to encode the decompressed data into a television signal; a remodulator to modulate the television signal onto an RF carrier having the appropriate frequency; an upstream DOCSIS compatible transmitter; a computer and associated memory to control the QAM tuner to tune the right frequency, to program the transport stream demultiplexer to extract packets having selected PIDs or other identifiers as to the type of data they contain and send them to the appropriate circuits, to send upstream management and control messages and receive downstream management and control packets on the DOCSIS PID and use the data appropriately and do the other things identified in the detailed description. In alternative embodiments, the conditional access circuit includes a removable smart card with a secure microprocessor and the decompression and encoding circuitry can be a removable module such that decompression and encoding circuits for other compression and encoding standards may be substituted. In other alternative embodiments, a full DOCSIS compatible cable modem with a USB, LAN or other bus interface to personal computers etc. is included in the STB to give it home gateway capabilities.

References to MPEG-2 or MPEG in this application or the appended claims are to be understood as referring to any data compression scheme suitable for sending video, audio and other data of interactive services, digital video broadcast, or video-on-demand services. Interactive services can be anything requiring upstream communication from the set top boxes to the head end including broadband internet access via a computer coupled to the set top box. Although the invention is currently to send the M&C data in-band over the DOCSIS PID on an MPEG transport stream so as to minimize overhead in interactive service delivery, if DOCSIS evolves into something other than IP over MPEG in the future years, whatever it evolves into will suffice to practice the invention as long as the M&C data can be sent in-band and segregated somehow from the on-demand and interactive services data.

This use of a DOCSIS inband M&C channel allows great simplification of the STBs by elimination of the transceiver circuitry in each STB that was devoted in the prior art to just sending and receiving OOB data on the out-of-band channel. It also eliminates the media access control protocol that was required in the prior art if the upstream OOB channel was shared. An STB which is compatible with the present invention only needs one tuner and circuitry from a DOCSIS modem which can demultiplex the MPEG packets in each transport stream and route them to the correct circuitry in the STB for use in management and control or to extract the video, audio and/or data of the services. In other words, the DOCSIS modem in the STB tunes the MPEG-2 multiplex, filters out and processes DOCSIS PID bearing MPEG-2 packets and filters out MPEG-2 packets having PIDS of the desired services and sends them to the proper STB circuitry for key extraction, decryption of service data, NTSC signal generation, loading of software, display of program guide data, etc. The DOCSIS modem circuitry in the STB is also used to transmit the conventional DOCSIS upstream to support the in-band DOCSIS M&C channel(s).

The prior art FSN assigned timeslots on the OOB channel wasted upstream OOB bandwidth. This lesson resulted in the DAVIC OOB reservation protocol. However, the DOCSIS protocol supports much higher data rates in both the forward and reverse channels, and with the advent of DOCSIS 2.0, even higher data rates are supported. Further, no separate MAC protocol to manage a shared upstream OOB is necessary with the invention because the DOCSIS protocol carried out on the DOCIS PID takes care of the MAC functions.

Normal DOCSIS media access control protocols are carried out with upstream and downstream DOCSIS messages. These include ranging requests, ranging response messages, MAP and UCD messages, etc. All are transmitted downstream on the DOCSIS PID of the MPEG-2 multiplex. Upstream DOCSIS messages such as ranging bursts which are transmitted during the ranging contention window identified in the MAP, bandwidth requests, and messages containing M&C data are transmitted by the modified DOCSIS cable modem in the STB during contention windows or assigned upstream minislots as controlled by the CMTS through MAP messages. The ranging contention window is a contiguous group of upstream minislots identified in a downstream MAP message. Upstream data bursts carrying upstream M&C data and other DOCSIS data are transmitted during the minislots assigned in MAP messages sent in response to upstream M&C bandwidth request messages transmitted on the upstream DOCSIS channel during bandwidth request contention windows assigned in MAP messages. Because the bandwidth on the upstream DOCSIS channel is scheduled and fully utilized, there is no waste of upstream OOB bandwidth as there was in the FSN prior art where specific upstream timeslots were reserved for particular STBs even if they had no upstream traffic.

The higher downstream and upstream data capacity of a DOCSIS M&C channel allows the operating system software and navigation software to be downloaded from the head end over the DOCSIS PID instead of being forced to keep it resident on the STB as was the case in the Pegasus prior art in some embodiments although the preferred embodiment keeps the navigation and operating system software resident on the STB for faster operation. The Pegasus prior art system was forced to keep the navigation and OS software resident to eliminate upstream bottlenecks caused by 4000 STBs constantly requesting software downloads. The Pegasus approach reduced the network resources that were consumed in downloading these applications constantly to the 4000 Pegasus STBs each time a button on the remote control was pushed. OOB software application downloads were discouraged on Pegasus, and MPEG-2 private data carousels were used for these purposes.

Transmission of the M&C data on the DOCSIS PID in an MPEG-2 transport stream also minimizes the overhead associated with managing interactive services and VOD. Since DOCSIS is essentially IP over MPEG, this brings the benefit of the well understood P protocols and addressibility to managing interactive services and all auxiliary devices such as personal computers connected to the STB. The IP layer functionality is used to add addressing capability to the downstream traffic so that application software downloads, program guide data, conditional access data, etc. can be requested in upstream messages from specific STBs and transmitted downstream to only the STB that requested it without using data carousels that waste bandwidth.

There are significant advantages to using the DOCSIS data transport protocol to implement a DOCSIS in-band management and control channel with a DOCSIS PID on an MPEG-2 transport stream. The MPEG-2 transport stream or mulitplex can be used to transmit all the in-band service delivery channels and replace all OOB management channels. This allows elimination of all STB circuitry formerly needed in the prior art systems such as Pegasus, FSN, Digicable and Canal+ to communicate on the OOB channel or a DSL link or POTS phone line. Further, all the overhead reduction efficiencies of use of MPEG-2 transport without overlaying it on the ATM transport mechanism are enjoyed by this invention. Using a DOCSIS channel with all its protocol messages to deliver M&C data on a DOCSIS PID inside the MPEG-2 transport stream greatly reduces the overhead of the transport mechanism used to deliver the services data. This is because the transport mechanism is a modified MPEG-2 transport stream and not an MPEG-2 transport stream segmented into ATM cells as in the FSN prior art. Recall that the MPEG over ATM transport protocol of the Time Warner FSN suffered from 12% overhead just to use the ATM transport protocol, mainly because of the 5 byte header in every ATM cell. Thus, the heavy overhead burden of trying to send MPEG frames over ATM infrastructure like the Time Warner Full Service Network is avoided in the invention described here.

The simplification of the set top decoder (STB) is highly significant because the costs of deploying millions of complex STBs nationwide are prohibitive to cable operators, and will slow penetration of the interactive and VOD services over HFC into the nationwide market.

The DOCSIS cable modem used in the STB has been modified to receive filter commands from the STB microprocessor, select the MPEG packets in the MPEG transport stream having the DOCSIS PID and recover the downstream M&C data that was formerly sent on the forward OOB channel in the prior art and send it to the proper circuitry in the STB. For example, EMM conditional access messages on the DOCSIS PID are extracted, recognized as EMM messages and sent to the STB microprocessor where only EMM messages addressed to the particular STB are kept and the encrypted session key therein is decrypted using the private user key of the STB. The DOCSIS cable modem is also modified to extract from the received MPEG-2 multiplex the MPEG packets having PIDs of the selected service(s) and supply those packets to a conditional access decryption and decompression circuitry. The decompressed data is then supplied to a processor for graphics rendering and NTSC, PAL or SECAM or other format signal generation. The DOCSIS modem is also modified to receive the upstream M&C data and transmit it on a conventional DOCSIS upstream channel.

In contrast to the Canal+ and DBS prior art, the preferred embodiment of the invention uses a targeted, non carousel approach to send only M&C data (including targeted conditional access EMM key data) that is requested via a real time, always on upstream DOCSIS channel to only the STBs that requested it. No separate proprietary communication protocol is needed for callbacks, provisioning, secure software downloads or other STB management from the head end since the DOCSIS always on upstream and downstream channels either eliminates the need for these functions or the DOCSIS protocol already has known mechanisms in place to carry these functions out. ECM messages are sent in the transport stream with PIDs of the associated service in some embodiments. Two way conditional access allows CMs that want encrypted programs to send and upstream message requesting download of encrypted session keys, any application software and anything else they need and telling the headend to which QAM channel they are tuned for downstream messages on the DOCSIS PID. The headend can then narrowcast the needed session keys, application softare and any other information needed by the CM only on the QAM channel the CM said it is listening to for downstream messages, thereby minimizing message overhead. Another innovation in two way conditional access and the use of MPEG is the upstream message requests immediate download of an I-frame for the requested program so decoding can begin immediately and not have to wait for the I-frame to arrive in the normal course in which it is transmitted.

In short, comparing the invention to the DBS, Canal+, FSN and Pegasus prior art, the invention is: reception of upstream messages on an always-on, conventional DOCSIS channel from the set top boxes; these upstream messages, among other things, define what M&C data the STB needs; and, transmission of only the needed M&C data to only the STBs that need it in-band via a DOCSIS channel on a DOCSIS PID within a downstream MPEG-2 multiplex which also delivers the digital services data. This is done by using IP packets or any other type of packet or cell that can be addressed to a particular STB or which can be multicast (hereafter just referred to as IP packets). These IP packets are encapsulated in MAC frames which are encapsulated in MPEG-2 packets which have the reserved DOCSIS PID. These MPEG packet are multiplexed into an MPEG transport stream mulitplex which carries the compressed video, audio and data of the delivered services. For shorthand, this summary of the idea of the invention will be referred to a thin DOCSIS or a bidirectional DOCSIS M&C channel elsewhere herein.

Application software download via the thin DOCSIS channel, in addition to simplifying the STB, also allows bugs to be fixed from the head end, upgrades to be loaded from the head end and new features to be added from the head end thereby rendering the STB future proof. The problems in the prior art with overwhelming the OOB forward channel with application download and overwhelming the OOB upstream channel bandwidth with too many simultaneous requests for application downloads is overcome by the fact that DOCSIS 2.0 upstream M&C channels allow synchronous code division multiplexed bursts. This greatly increases the DOCSIS upstream channel traffic capacity, and allows many STBs to simultaneously use the DOCSIS upstream using the DOCSIS upstream bandwidth assignment protocol. This protocol is contention based for upstream bandwidth requests but once a request is granted, no collisions will occur because the headend controls who can transmit and when.

Another advantage of using a DOCSIS M&C channel is in implementation of conditional access. Current conditional access requires each STB to have a smart card or other embedded security circuitry in each STB which adds cost to the STB. In conventional conditional access systems, a secure microprocessor (sometimes on a smart card) sends purchase information on the OOB channel and Entitlement Management Messages (EMM) messages containing encrypted session keys authorizing access are sent back on the OOB channel to the secure microprocessor in the case of HFC or on the private data PID in the case of Canal+ technology on a DBS system. This approach required the STB to have a separate receiver for the OOB channel or special software to extract the private data PID EMM messages, route them and decrypt them using the private user key of the STB. An encrypted MPEG-2 multiplex carrying the delivered services is routed in the STB to an MPEG-2 transport demultiplexer which separates the stream into separate streams based upon the PIDs and selects the video, audio and data packetized elementary streams (PES) for the selected service or program. Entitlement control messages (ECM) in the MPEG-2 transport streams of the prior art conditional access system were encrypted messages that carried the encryption keys. The transport demultiplexer selected the ECMs that apply to the desired, protected program and sent them to the secure microprocessor. The ECMs were decrypted by the secure microprocessor using the decrypted EMM session keys, and the resulting payload decryption keys called working keys were sent to the payload decryption engine. The payload decryption engine uses these working keys to decrypt the payload sections of the PES in the MPEG packets having the PIDs of the selected encrypted program.

A summary of the significant advantages of using a DOCSIS M&C channel are:(1) secure application software download from the head end to each STB as the application program is needed via the DOCSIS PID thereby simplifying the STB and reducing its memory requirements and rendering it bug proof, easily upgradeable, flexible and future proof; (2) use of the alway-on, conventional DOCSIS upstream channel by each STB to send upstream messages indicating the exact application program(s) and other M&C data it needs so only the necessary application software and M&C data is downloaded via the DOCSIS PID to only the STB that requested it thereby preventing the waste of bandwidth intrinsic to a data carousel; (3) simplification of the STB by elimination of a tuner and MAC protocol for an OOB channel and elimination of any circuitry needed to interface to a DSL or POTS phone line; (4) reduction in overhead in delivery of digital services; (5) elimination of wasted bandwidth on the upstream M&C channel; (6) upgrades, bug fixes and adding new features to STBs from head end without need to obsolete existing equipment; (7) simplification of the conditional access process and elimination of a callback server at the head end dedicated to conditional access; and (7) use of existing cable modem termination systems to manage STBs from the headend.

### BRIEF DESCRIPTION OF THE DRAWINGS

FIG. 1 is a diagram of the prior art protocol stack of the Time Warner Full Service Network showing MPEG compressed audio and video transmitted over an ATM infrastructure.

FIG. 2 is a diagram of the prior art Pegasus 2 channel types showing use of an OOB.

FIG. 3 is a diagram of the prior art Pegasus 2 QAM switching matrix which was used to overcome the fact that MPEG-2 was not designed to work in packet switched networks.

FIG. 4 is another diagram of the prior art Time Warner Full Service Network communication protocol stack showing TDMA and QPSK OOB control channel and QAM modulated channels carrying ATM cells carrying MPEG packets for delivery of data of interactive and on demand services.

FIG. 5 is a block diagram of just the digital services headend downstream-only apparatus to transmit digital video broadcast programs on HFC systems along with Video-on-demand and Interactive services using a DOCSIS in-band channel to transmit management and control data (M&C data) that was transmitted out-of-band inthe prior art interactive and VOD service delivery systems over HFC.

FIG. 6 is a more detailed diagram of the DOCSIS communication protocol stack on the RF interface to the HFC that comprise blocks 20, 21 and 30 in FIG. 5, showing how additional functionality to manage STBs from a CMTS at the head end can be implemented.

FIG. 7 is a more detailed block diagram showing the protocol stacks for the upstream and downstream at both the CMTS and CM ends showing how the OOB or management and control data and the interactive services and video on demad data are merged into a combined MPEG-2 transport stream and sent to the physical media dependent layer and transmitted over the HFC.

FIG. 8 is a block diagram of a simple set top box with a single tuner for receiving interactive and VOD data and other services along with a DOCSIS in-band management and control channel to manage the STB and the delivered services.

FIG. 9 represents an alternative embodiment of a single tuner STB where the NTSC/PAL/SECAM encoder 156 is a multimedia graphics processor which genererates an analog television signal of the proper format and overlays graphics on the displayed images to display program guide data, navigation information, and whatever other graphics information is needed.

FIG. 10 represents an alternative embodiment of a single tuner STB with TIVO type digital video recording capability.

FIG. 11 is a block diagram of another embodiment for a single tuner STB which can receive JVT compressed data or MPEG compressed data.

FIG. 12 is a diagram showing how EMM and ECM messages are extracted from the MPEG multiplex.

FIG. 13 is a flow diagram of the process of receiving upstream requests for management and control data and responding by sending the requested management and control data downstream on the DOCSIS PID.

FIGS. 14A through 14C are a flowchart of the process carried out at the headend to send targeted EMM messages to only the STBs that have ordered services via the DOCSIS PID.

FIGS. 15A through 15C are a flowchart of the process carried out in the STB to recover ECM and EMM messages and decrypt payload data of a requested service.

FIG. 16 is a diagram of a headend architecture using IP encapsulation and a router to route MPEG transport streams to different HFC systems.

FIG. 17, comprised of FIGS. 17A through 17B, is a flowchart of the process carried out by a simple single tuner STB to receive encyrpted, digital broadcast video.

FIG. 18, comprised of FIGS. 18A through 18C, is a flowchart of the process carried out by a simple single tuner STB to receive an encrypted, digital video-on-demand program.

FIG. 19 is a diagram of the connections of a digital television viewing system which uses a digital tuner/decoder which has no remote control and which does not have to be placed within line of sight of the viewer to receive infrared commands like most digital set top boxes.

FIG. 20 is a more detailed block diagram of the tuner/decoder 120 that does not require its own remote and which provides digital video tuning capability.

FIG. 21 is a diagram of one embodiment of a lookup table that maps local oscillator frequency to several factors needed to control the invention.

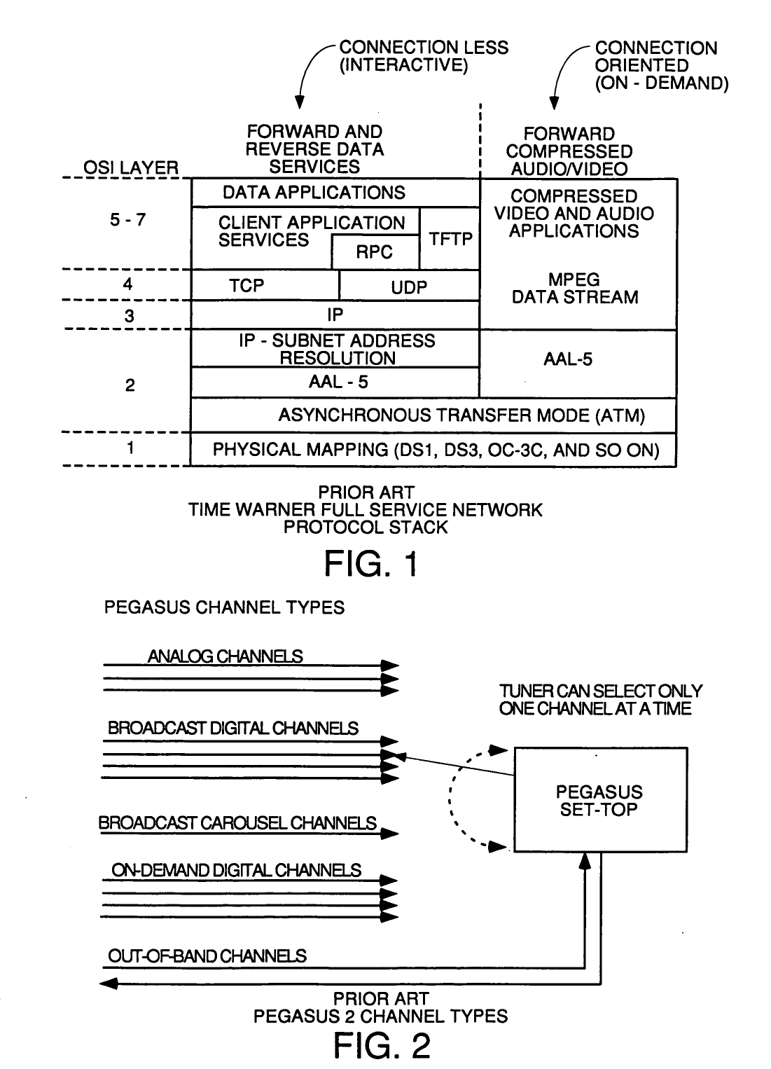

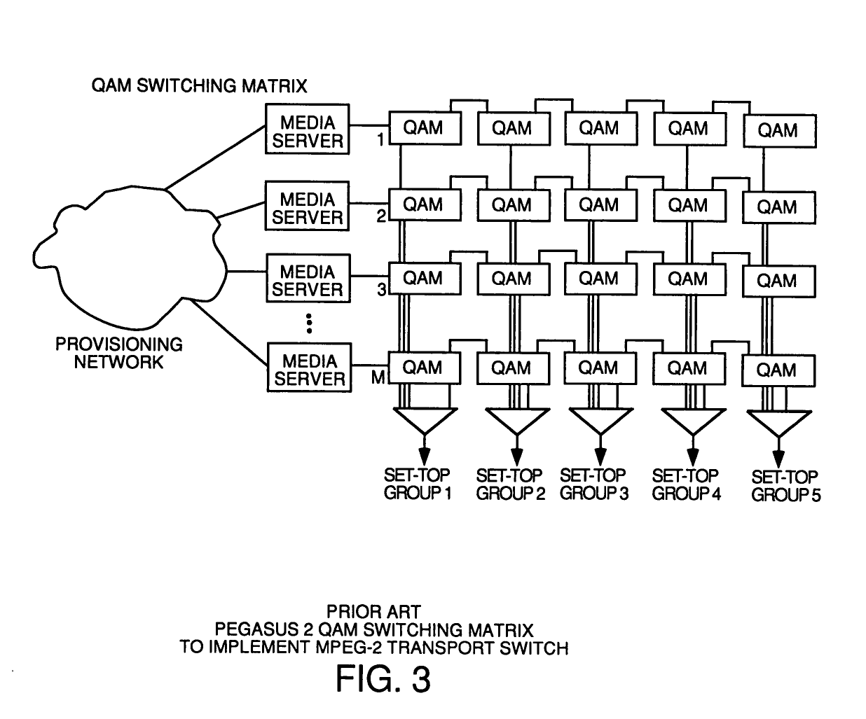

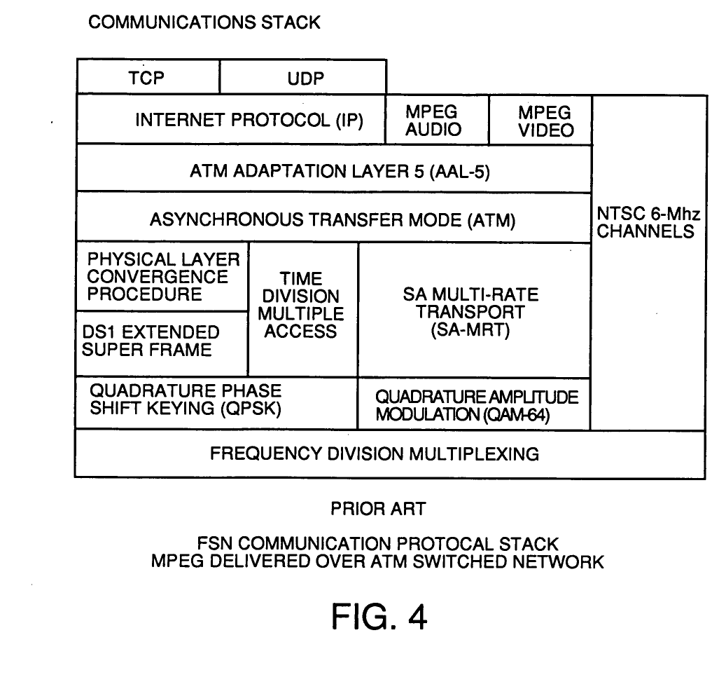

### DETAILED DESCRIPTION OF THE PREFERRED AND ALTERNATIVE EMBODIMENTS

To understand the invention, some background on the DOCSIS data over cable technology and MPEG transport streams is useful. The publication Orzessek & Sommer, “ATM & MPEG-2: Integrating Digital Video Into Broadband Networks”, ISBN 0-13-243700-7 (Prentice Hall, 1998) is hereby incorporated by reference for its teachings of the details of MPEG.

DOCSIS is a series of specifications developed by Cable Labs, which is a consortium of cable system operators defining standards for transmitting data over HFC systems from a headend to a plurality of cable modems. DOCSIS is a set of standards that define the requirements of, inter alia, a physical media dependent layer, a transmission convergence layer and a media access control layer (protocols for messaging to accomplish access control to the media and management of the cable modems) in order to send data, video and audio digitally in compressed form bidirectionally over hybrid fiber coaxial cable CATV systems between a headend and a plurality of cable modems or set top boxes that can receive DOCSIS channels.

There are three versions of the DOCSIS specification, all of which are incorporated by reference herein and all of which are cited hereby as prior art: DOCSIS 1.0, 1.1 and 2.0. The differences are in the allowed burst modulation types, symbol rates, etc. For example, in DOCSIS 2.0, synchronous code division multiplexed bursts are allowed while in DOCSIS 1.0 and 1.1, they are not.

DOCSIS is essentially delivery of Internet Protocol datagrams encapsulated in MPEG packets, so it fits perfectly within an MPEG-2 transport stream. In other words, the MPEG packets that carry DOCSIS data can be inserted into an MPEG-2 transport stream carrying the compressed video and audio and supplemental data of interactive and on demand services or digital broadcasts, each of which has its own Program Identifier(s) or PID(s). This can be done without affecting the MPEG-2 transport stream. This is because the DOCSIS MPEG packets all have a Program Identifier or PID which identifies them as DOCSIS packets. This allows the cable modem or STB at the receiving end to separate out the DOCSIS MPEG packets from the MPEG packets in the same transport stream having the PIDs of the interactive or on demand services or the digital broadcast programs. The various streams of MPEG packets for each type of service can be routed to the appropriate circuitry in the cable modem or STB for further processing.

DOCSIS was originally designed to allow transmission of IP data packets transparently from the head end (having a server coupled to the internet or any other source of IP packets) to hundreds or thousands of cable modems over an HFC system. This would allow users to connect to the internet through their CATV systems instead of through slow dial up connections to their ISPs using phone lines. The Internet Protocol (IP) is a protocol used in the packet switched internet and other networks for connectionless delivery of datagrams. Connectionless means that no dedicated line or circuit is used to deliver an entire message or datagram, and messages are broken into packets where each is treated independently.

However, the IP packets transmitted over the DOCSIS channel can come from anywhere and can be used to encapsulate requested application software applications downloads, requested program guide data, data carousels, network management and control data, SNMP management data to allow the headend to manage the STBs, messages to implement the DOCSIS ranging and network management included in the DOCSIS media access control protocol, etc.

DOCSIS Cable Modem Termination Systems (CMTS) receive IP packets via the TCP/IP protocol and encapsulate them into MPEG packets having a header PID set to 0x1FFE to identify the MPEG packet as DOCSIS data. The MPEG packets are then broken down into ATM protocol data units (APDUs) in some embodiments, as defined in the IEEE 802.14 specification. However, in other embodiments, the MPEG packets are not broken down into APDUs and are broken directlyinto Reed Solomon coding blocks. These APDUs are broken into Reed Solomon (RS) coding blocks for forward error correction encoding with error detection and correction bits for each block. The RS blocks are then interleaved and broken down into symbols which are interleaved and may or may not be Trellis encoded into constellation points for transmission on the HFC.

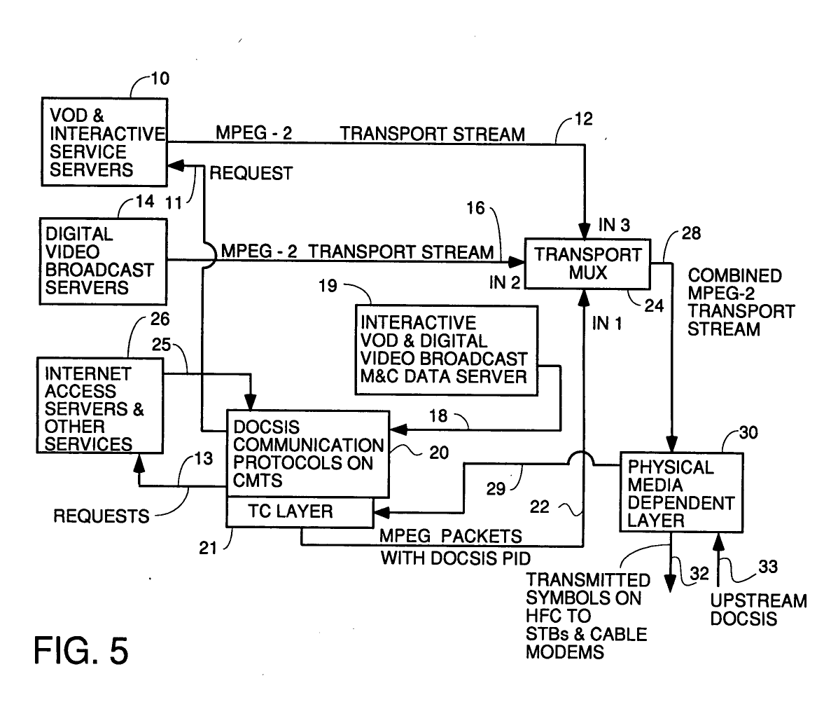

FIG. 5 is a block diagram of just the digital services headend downstream-only apparatus to transmit digital video broadcast programs on HFC systems along with Video-on-demand and Interactive services using a DOCSIS in-band channel to transmit management and control data (M&C data) that was transmitted out-of-band in the prior art interactive and VOD service delivery systems over HFC. The analog NTSC transmission circuitry and the upstream DOCSIS channel and MPEG-2 transport stream reception circuitry is not shown in FIG. 5 so as to highlight the basic idea of the invention without undue complexity although at least an upstream DOCSIS channel carrying upstream management and control data is required to implement interactive and VOD services. One or more servers 10 receive requests for interactive services via line 11 from a Cable Modem Termination System 20 (CMTS). The CMTS 20 is, in the preferred embodiment, a server executing industry standard DOCSIS communication protocol processes to process upstream DOCSIS communications on a pure DOCSIS upstream channel 33 on the HFC. Set top boxes receive commands from users for interactive services and video-on-demand transmissions and requests for other services delivered via IP packets over the internet. In some STBs, especially those with LAN connections to personal computer running web browsers and e-mail clients, users can request e-mail, surf the web via their PC or a wireless keyboard coupled to the STB by an infrared or radio frequency connection and request downloads and web pages. Those requests as well as other conventional DOCSIS messages, such as ranging bursts, upstream bandwidth requests, etc., are converted to management and control packets (M&C upstream data) and encapsulated by a DOCSIS compatible cable modem (CM) transmitter in the STB into IP packets addressed to the appropriate server at the head end or on the internet. The IP packets are encapsulated by the STB CM transmitter into MAC frames addressed to MAC addresses in the servers and the MAC frames are encapsulated into MPEG packets which are broken down into forward error corrected (FEC) symbols which are transmitted by the STB DOCSIS cable modem transmitter on upstream DOCSIS channel 33.

At the head end, a physical media dependent layer 30 recovers the upstream MPEG packets from the DOCSIS upstream and sends them via data path 29 to a transmission convergence sublayer process 21. There, the MAC frames are recovered from the MPEG packets and routed to the other DOCSIS layers which recover the IP packets and do other conventional DOCSIS processing for ranging, upstream bandwidth requests, etc. The IP packets are then routed to the appropriate servers such that IP packets bearing requests for interactive services get routed to server 10 and IP packets bearing requests for internet access or other services delivered by IP packets get routed to server 26 via data path 13.

Server(s) 10 respond to said requests by outputting requested VOD and/or interactive services requested by the customer on line 12 as an MPEG transport stream. One or more servers 14 output regularly scheduled or near video-on-demand digital video broadcast programs on line 16 as another MPEG-2 transport stream. Line 18 carries management and control data retrieved or generated by a managment and control data server 19 which may or may not be the same as servers 10, 14 or 26. The M&C data on line 18 is data that was formerly sent on a downstream OOB channel in the prior art. The M&C data is supplied to a set of DOCSIS communication protocol processes 20 which encapsulates it into IP packets which are then encapsulated in MAC frames addressed to particular STBs or multicast. The MAC frames are encapsulated into MPEG packts having the DOCSIS PID in transmission convergence layer 21, and sent to a transport multiplexer 24 via data path 22. Other data such as is supplied by server 26 providing other services such as internet access may also be supplied to DOCSIS communication protocols 20. There, the data of said other services, if not already encapsulated in IP packets, is encapsulated in IP packets addressed to the IP address of the process which requested the data. These IP packets are encapsulated in MAC frames addressed to the STB having or connected to the device and process which requested the other service data. These MAC frames are then encapsulated in MPEG packets having the DOCSIS PID in the preferred embodiment, but in alternative embodiments, the CMTS 20 may be programmed only to put management and control data on the DOCSIS PID and to put high speed of other services in MPEG packets having the private data PID. For example, not shown but possible is a video server which outputs video-over-IP IP packets. These also would be supplied to DOCSIS communication protocols 20 and encapsulated into MAC frames which are encapsulated in MPEG packets having the DOCSIS PID or the private data PID.

MPEG packets, as the term is used herein means fixed length 188 byte packets that comprise an MPEG-2 transport stream. Each has a 4-byte header which includes a PID field and a payload section. DOCSIS MAC frames can be put into the payload section, and when that is true, the PID field has a predetermined value indicating the payload section contains DOCSIS data. The MPEG packets on line 22 have a DOCSIS PID.

The management and control data on line 18 can include requested application software for download to the STBs, requested program guide data, conditional access key data such as EMM messages, event provisioning data, emergency alert service data, and messages to manage and control the interactive and VOD services, and targeted advertising, etc. Upstream management and control data on DOCSIS channel 33 can include: requests for interactive and/or VOD service, conventional DOCSIS messages, management and control messages pertaining to the interactive services, requests for specific application software downloads, requests for specified program guide data, purchase requests for pay-per-view events, gaming upstream data, requests for specific conditional access key data, agent data from agent programs in STBs that monitor viewer habits for use by advertisers in transmitting targeted advertising data to specific STBs, etc.

The transport multiplexer 24 combines the MPEG packets on line 22 with the MPEG transport streams on lines 12 and 16 to create an MPEG multiplex. The transport multiplexer 24 also adjusts the data in the tables of each transport stream and the multiplex itself to generate a combined MPEG-2 multiplex comprised of several MPEG-2 transport streams on line 28. The combined MPEG-2 multiplex has MPEG packets from lines 12, 16 and 22 interleaved thereon along with a Program Association Table (PAT). The PAT table is transmitted in MPEG packets having PID 0 and serves to define which MPEG-2 transport streams are in the multiplex. Each MPEG-2 transport stream has MPEG packets in it with a program map PID. These packets with the program MAP PID can be selected at the receiving end and a program map table or PMT can be extracted from the payload portions of these packets. The PMT table contains data that identifies the PIDs of the packets which contain the data of each program, service or other flow along with timing and conditional access data MPEG packets that are part of the program or service and which are contained in the MPEG-2 transport stream from which the PMT was extracted. The transport multiplexer 24 writes data into the Program Association Table to identify the transport streams on lines 12 and 16. However, the data on line 22 is in MPEG packets having the DOCSIS PID so no entry in the PAT table is necessary. This is because the DOCSIS PID is a reserved PID and has no entry in either the PMT or PAT. The data written into the Program Association Table of each MPEG-2 multiplex identifies which interactive services, digital video broadcasts, video-on-demand, or internet access services are in each transport stream of the MPEG multiplex.

At the receiving end, when a particular program or flow is desired, the MPEG packets having any of the PIDs listed in the PMT for the program or flow can be extracted from the stream and their payload data sent to conditional access circuitry for decryption and to MPEG video decoders for decompression. In the STB, M&C data or internet access data on the DOCSIS PID and who MAC frames are addressed to the STB is extracted and routed to the appropriate circuitry in the STB or in computers or other customer premises equipment coupled to the STB which needs the data.

The transport multiplexer 24 creates a single transport stream containing a collection of programs out of several transport streams in a manner which is conventional in the systems layer processing for the MPEG-2 systems layer processing. An MPEG-2 systems layer provides provides the functionality to extract a single program out of a single transport stream containing a collection of programs, or extract a subset of programs out of a single transport stream containing a collection of programs, or create a single transport stream containing a collection of programs out of several transport streams. The former functions are performed by the transport stream demultiplexers in each STB. The conventional functions of any MPEG-2 systems layer is to combine MPEG encoded video, audio, private data, time sync information and service and control information into a single MPEG-2 transport stream. The time sync information is timestamps that are used to synchronize the video, audio and data portions of a program. The private data can be any user defined data including M&C data normally sent on an OOB channel or any other data.

The MPEG-2 transport stream packets on line 28 are supplied to a physical media dependent layer (PMD) 30. The PMD layer encodes the MPEG packets into forward error correction protected symbols for transmission in accordance with the specifications of ITU-TJ.83-B, which is hereby incorporated by reference. Generally, the MPEG packets are broken into Reed Solomon blocks and encoded with error detection and correction bits. These blocks are then interleaved, and the interleaved stream is broken into segments usually comprised of 3 bits each and Trellis encoded to add a fourth redundant bit. These four bits then are divided into two bits that define the real component and two bits that define the imaginary components of a symbol for quadrature amplitude modulation and transmission on the HFC 32.

Every MPEG packet has a 4 byte header and a payload section which can contain any type of data. The header of every MPEG packet contains a program identifier or PID that defines to which service the data in the payload section belongs. For example, the packets containing compressed video data for a movie will have a particular PID, and the packets containing the audio data of the soundtrack of the movie will have a different PID. The combined packets along with some other MPEG-2 transport stream data structures will comprise one MPEG-2 transport stream for the program. Every MPEG-2 transport stream has MPEG packets therein having a program map PID in the headers thereof. The data in these packets define the aforementioned program map table (PMT) which defines which PIDs are part of each program in the MPEG-2 transport stream (hereafter just transport stream). The data in this PMT table is used at the STB to filter out just the packets from the proper transport stream that contain the video and audio (and possibly supplementary data such as displayed graphics, etc.) of the desired program.

To implement conditional access, packets with the PIDs of the desired program can be demultiplexed in the STB and private conditional access data on the DOCSIS PID is demultiplexed from the transport stream and supplied to conditional access circuitry to verify the user has authorization to view the program and to provide the necessary key to descramble it. If access is authorized, the MPEG packets of the selected program are descrambled by the conditional access circuitry in the STB. The descrambled MPEG packets are then supplied to MPEG decoder circuitry for decompression and creation of analog NTSC television signals from the data therein.

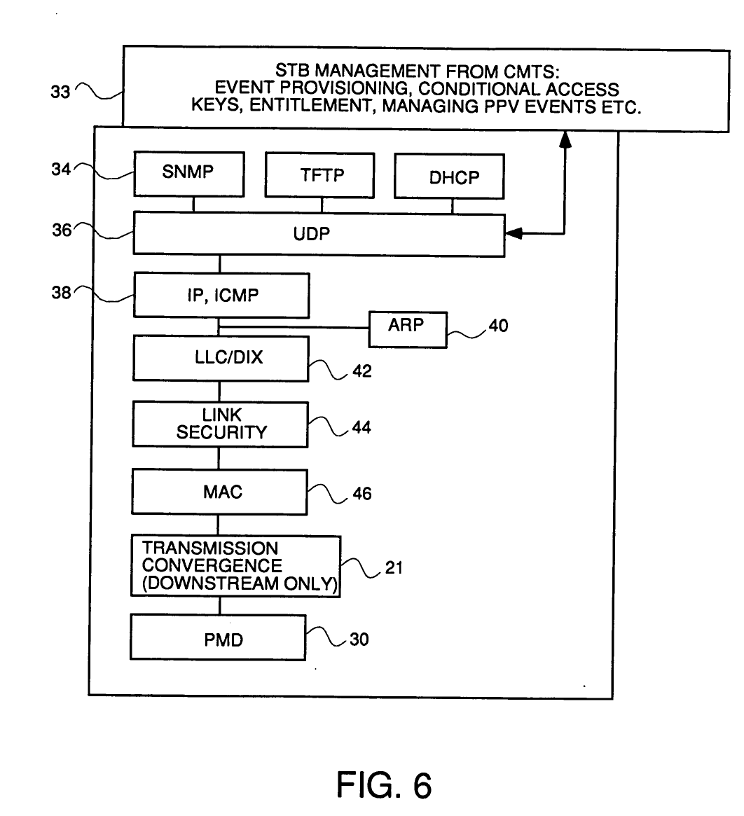

FIG. 6 is a more detailed diagram of the DOCSIS communication protocol stack on the RF interface to the HFC that comprise blocks 20, 21 and 30 in FIG. 5. DOCSIS requires these protocols (except for the highest layer protocol 33) to be used to allow Internet Protocol (IP) packets to be transmitted transparently between the headend and the cable modems. The DOCSIS system is therefore transparent as a transport mechanism to the IP packet source and any customer premise equipment coupled to a cable modem (CM) or STB at the customer premises end or coupled to the Cable Modem Termination System (CMTS) at the head end.

Both CM and CMTS act as IP hosts which must support IP over DIX link-layer framing and may support IP over SNAP framing. The CMTS may act as a transparent bridge or may employ network layer forwarding such as routing and IP switching. Certain management functions also ride on the IP such as spectrum management functions and downloading of software. SNMP block 34 represents a network management protocol which allows the head end to gather network management data from the STBs and to send network management data and commands to the STBs to control certain SNMP aspects of their operation remotely from the headend.

UDP layer 36 assembles datagrams, and IP layer 38 adds IP header information including source and destination addresses. This allows specific IP packets to be addressed to specific STBs and specific ports within those STBs. The IP layer then encapsulates the datagrams in the payload portion of IP packets.

Address Resolution Protocol layer 40 resolves IP addresses and maps them to physical addresses. IP networks today are well understood and include all the hooks and tools needed to manage devices coupled to the network so transmission of the M&C data in-band on the DOCSIS PID takes advantage of this fact to prevent the need to re-invent the wheel to manage interactive services via an in-band M&C channel.

Link layer control/DIX layer (LLC) 42 adds header information specified by IEEE 802.2 that identifes the contents of the packet as an IP datagram which is needed when multiplexing multiple protocols (IP and MPEG) on a single virtual circuit. This layer also provides a reliability function for the IP layer to insure all IP packets get to the destination.

The link security layer 44 does conventional DOCSIS functions such as encryption of IP packets.

The MAC layer 46 carries out the part of the DOCSIS protocol which governs access to the physical media independent of the physical characteristics of the medium but taking into account the topological aspects of the subnetworks in order to exchange data between nodes. MAC procedures include framing, ranging, error control and acquiring the right to use the shared medium. The MAC layer uses the services of the physical layer 30 to provide services to the LLC layer 42.

The Transmission Convergence layer provides an interface between the data link layer and the PMD layer 30 to take DOCSIS MAC frames containing M&C data formerly sent over an OOB channel and encapsulate this data into MPEG-2 packets of transport streams having the DOCSIS PID in the header. Other types of data such as digital video data or any otherdigital service data can also be encapsulated into MPEG packets in this layer and sent as private data.

The PMD or physical media dependent layer 30 takes the MPEG packets, breaks them up into symbols and does forward error correction functions and transmits the symbols, as previously described.

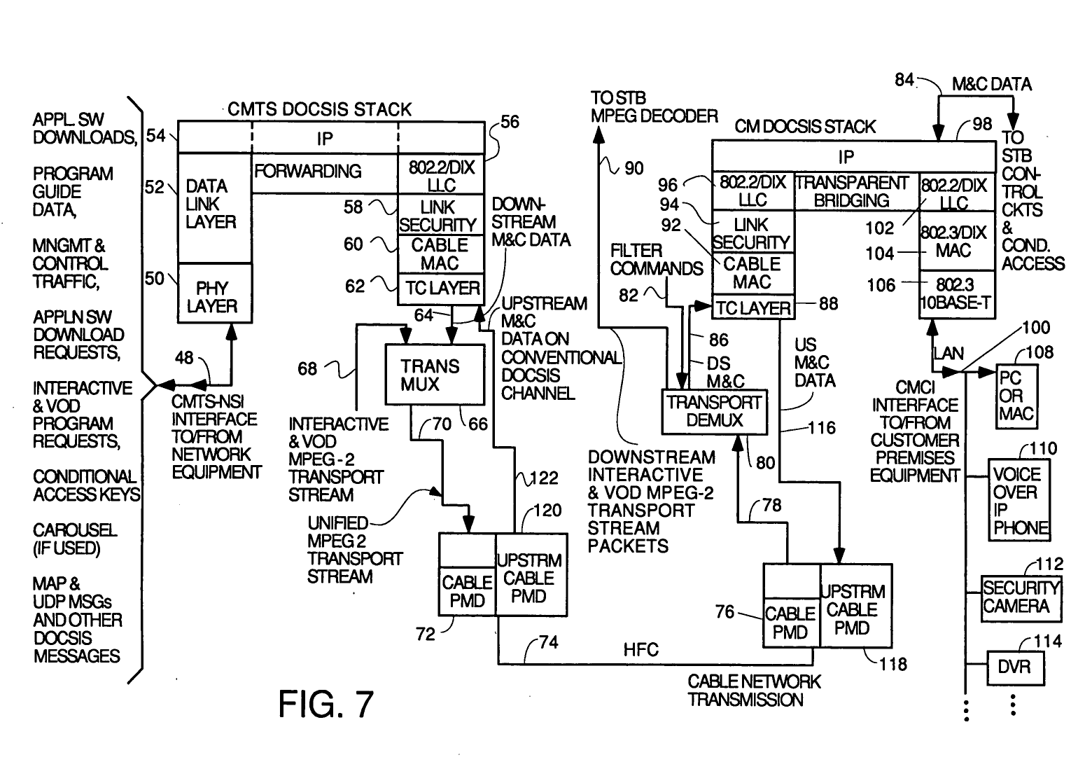

FIG. 7 is a more detailed block diagram showing the protocol stacks for the upstream and downstream M&C in-band channel and services delivery at both the CMTS and CM ends. The protocol stack on the left is at the CMTS, while the protocol stack on the right is at the CM. This diagram shows how the M&C data and the interactive services and video-on-demand data are merged into a combined MPEG-2 transport stream or multiplex (more than one transport stream) and sent to the physical media dependent (PMD) layer and transmitted over the HFC. The bidirectional stream of M&C data is the stream of data on line 48. Line 48 carries both upstream and downstream M&C data, and is coupled to a server(s) at the head end which generates the downstream M&C data and uses upstream M&C data. The M&C data on line 48 can include requested application software downloads addressed to specific STBs, requested program guide data addressed to specific STBs, requests for specified program guide data from STBs, requests for specific application software from STBs, requests for conditional access keys from STBs, conditional access keys addressed to specific STBs, pay-per-view event purchase information from STBs, event provisioning data, software upgrades and bug fixes to specific STBs, etc.

Phy layer 50 interfaces the DOCSIS protocol services with these servers using whatever physical interface and media the servers use to transfer data via data path 48.

Data link layer 52 performs services to allow transmission of the raw data coming from the PHY layer over a data path to the CMs which appears to the servers coupled to line 48 to be free of transmission errors. It does this by breaking the data into frames, transmitting the frames sequentiallyand processing acknowledgement frames coming back from the CMs on the DOCSIS upstream. The data link layer 52 provides services to create and recognize frame boundaries such as by attaching special bit patterns to the beginning and/or end of each frame. This layer also provides services to handle lost or damaged frames and flow control issues.

IP layer 54 encapsulate the M&C data frames received from the data link layer into IP packets, and provides IP addressing information in the headers to address downstream M&C data to specific STBs. The IP packets are then forwarded to the 802.2/DIX/LLC layer 56.

LLC Layer 56 assembles the data link layer frames for transmission. Link security layer 58 provides security services such as encryption.

The MAC layer implements the DOCSIS MAC layer protocols such as sending timestamps in synchronization and UCD messages, sending ranging request messages, obtaining time, frequency, phase and power offsets from the receiver hardware circuitry that makes these measurements on the preambles of ranging bursts, sending ranging response messages that include time, phase, frequency and power offset adjustments to STB cable modems that have transmitted ranging bursts, receiving bandwidth request messages during contention intervals, sending MAP messages allocating the DOCSIS upstream minislots among the STB cable modems that have requested bandwidth, sending UCD messages which define the channel characteristics of one or more logical channels in the DOCSIS upstream, etc. The MAP messages contain information elements that define initial station maintenance intervals which are contention regions when STB cable modems can send their ranging requests. The MAP messages also define request contention areas during which STBs which need upstream bandwidth can send upstream messages requesting grants. The MAP messages also include information elements that define grants for specific STBs in terms of the SIDs assigned to the STB cable modem. These grants are transmit opportunities during which the STB can transmit upstream M&C data or other messages using its cable modem. The MAC layer 60 generates downstream MAC frames and receives upstream MAC frames and processes them. The DOCSIS MAC protocols are well understood and no further discussion of them is needed here.

The downstream MAC frames are output to a transmission convergence layer 62 which encapsulates the MAC frames in MPEG-2 packets.

The MPEG-2 packets with M&C data are output on line 64 to a transport stream multiplexer 66. MPEG-2 packets in a transport stream containing compressed video, audio and other data for video-on-demand, interactive services, broadband internet access, voice-over-IP arrive on line 68 from the servers which provide these services. The transport stream multiplexer combines all these MPEG-2 packets into an MPEG multiplex comprised of several transport streams and generates the MPEG-2 packets containing the PAT and PMT tables. The combined multiplex is output on line 70 to a physical media dependent layer 72. Generally, the PMD layer 72 does forward error correction processing on the data on line 70. Depending upon the characteristics of the DOCSIS PID downstream channel and the particular PMD layer characteristics, that processing can vary and some characteristics of the forward error correction processing such as interleaving depth, Reed Solomon block size, Trellis encoding on or off can vary from one embodiment to the next or be programmable. In the case of a DOCSIS 2.0 downstream, the PMD layer 72 breaks the MPEG multiplex into Reed Solomon coding blocks of programmable block size, encodes them with error correction data, interleaves them if interleaving is turned on, and scrambles them is scrambling is turned on, breaks the stream of bits into symbols and Trellis encodes them if Trellis encoding is turned on, and QAM modulates them into RF signals on HFC 74.

At the STB, a DOCSIS compatible cable modem tuner tunes and demodulates the MPEG multiplex and provides the recovered bit stream for signal processing to the PMD layer 76. The PMD layer 76 recovers the MPEG-2 packet stream of the multiplex by doing the reverse processing to that performed by PMD layer 72.

The recovered MPEG-2 packet stream is output on line 78 to a transport demultiplexer 80. Demultiplexer 80 receives filter commands on line 82 from a programmed microprocessor (not shown) in the STB. The microprocessor in the STB executes a navigation program (which is resident on the STB in the preferred embodiment) which receives user inputs regarding which channels the user wishes to tune, what pay per view events the user want to order, what program guide data the user wants to see, what interactive services the user want to participate in, what video-on-demand movies the user wishes to view, etc. This data is converted into upstream M&C message data on line 84 and filter commands on line 82.

The filter commands tell the transport demultiplexer 80 which MPEG-2 packets to extract from the MPEG-2 multiplex by PID. The microprocessor derives these PIDs from examination of the PMT table. To obtain these filter instructions, the transport stream demultiplexer 80 first filters out packets with PID 0. These packets contain the MPEG-2 program association table that defines which transport streams are in the multiplex. Next, the transport demultiplexer selects the transport stream which carries the requested services and extracts the packets containing the program map PID. These packets are processed to obtain the program map table (PMT) which defines which PIDs are associated with each delivered service. The packets with the PID(s) of the requested service(s), are extracted from the MPEG multiplex and supplied on line 90 to the conditional access circuitry (not shown) for decryption and thence to the MPEG video and audio decoder for generation of NTSC signals.

MPEG-2 packets with the DOCSIS PID are extracted and supplied on line 86 to the transmission convergence layer 88. There, the MAC frames encapsulated in the MPEG-2 packets are recovered. The MAC frames are passed to MAC protocol process 92 where the MAC frames are processed and any downstream messages from the CMTS are recovered and acted upon in conventional DOCSIS fashion and passes the data recovered from the MAC frames to the link security layer 94.

Link security layer 94 decrypts data received from the MAC layer and passes the decrypted data to LLC layer 96. The LLC layer dissembles the frames assembled by data link layer 52 on the CMTS side to recover IP packets, and passes the IP packets to the IP layer 98. The IP layer routes the IP packets by resolving their IP addresses to physical addresses and sending the M&C data on line 84 to the appropriate STB control circuits (not shown) such as the conditional access circuits, the microprocessor, etc. More about which types of M&C data are sent to the various STB circuits will be said in connection with description of the simplified STB. The M&C data includes the PMT table data which gets routed to the STB microprocessor. The microprocessor compares the data it has retained about the interactive services, video-on-demand and other services which the user has ordered to the PID data in the PMT table to determine which PIDs the MPEG-2 packets containing the data of each ordered service will contain. These PIDs are used to generate the filter commands on line 82 to the transport demultiplexer 80 so it can extract the MPEG packets containing the ordered services.

Upstream M&C data (such as requests for services, download of particular application programs or particular program guide data or requests for decryption keys for particular services) is sent from the STB control circuits via data path 84 to the IP layer 98 and encapsulated in IP packets addressed to the server at the headend handling the M&C data. The IP packets then pass down through layers 96, 94, 92, 88 and are passed as MPEG-2 packets on line 116 to an upstream cable physical media dependent layer 118 for forward error correction and transmission upstream on HFC as a conventional DOCSIS QAM modulated RF signal.

At the headend, an upstream cable physical media dependent layer 120 receives and demodulates the QAM signal and recovers the MPEG packets therein and passes them on line 122 to the transmission convergence layer 62. The TC layer 62 recovers the MAC frames in the MPEG packets on line 122 and passes the MAC frames to MAC protocol layer 60 where the MAC frames are processed. For example, upstream ranging bursts have measurements made for timing offset, phase and frequency offset and power offset. The results for each STB's cable modem are put into a downstream MAC message called a ranging response message. This message is sent to the STB and used by the DOCSIS modem transmitter circuitry therein to make adjustments to get into synchronization with the DOCSIS upstream. Upstream M&C data is passed by the MAC layer 60 through the link security layer 58 and the LLC layer 56 to the IP layer 54, all of which do conventional DOCSIS processing on the data. The IP layer 54 routes the upstream M&C data down through data link layer 52 and PHY layer 50 for transmission on data path 48 to the server which is handling upstream M&C data.

Returning to consideration of the STB, any downstream IP packets containing data for typical DOCSIS services such as broadband internet access, voice-over-IP, etc. that need to be routed to a personal computer or other device coupled to the STB are routed down to a local area network interface 100. This is done by the IP layer 98 passing these IP packets to an LLC layer protocol 102 which does conventional DOCSIS processing and passes the resulting frames to MAC layer protocol 104 which generates MAC frames and carries out the required protocols to access the local area network 100. The resulting MAC frames are delivered to a LAN physical layer interface 106, which in the illustrated embodiment, is an 802.3 10Base-T Ethernet interface. There the MAC frames are encapsulated in Ethernet frames and the MAC addresses are resolved to physical addresses on the LAN and sent to the appropriate device coupled to the LAN such as PC 108, voice-over-IP phone 110, security camera 112, digital video recorder (for video-over-IP services) 114, etc. Upstream data from these devices, if any, takes the reverse path up through the layer 106, 104 and 102 protocols and is addressed by the IP layer 98 to whatever server at the headend is handling the particular service to which the upstream data belongs. From there, the upstream service data takes the same path and has the same processing as the upstream M&C data until it gets to the PHY layer protocol 50 at the headend. There it is routed to whatever server at the head end is handling the particular service to which each packet pertains.

### SIMPLE SET TOP BOX WITH SINGLE TUNER FOR USE WITH DOCSIS IN-BAND M&C CHANNEL

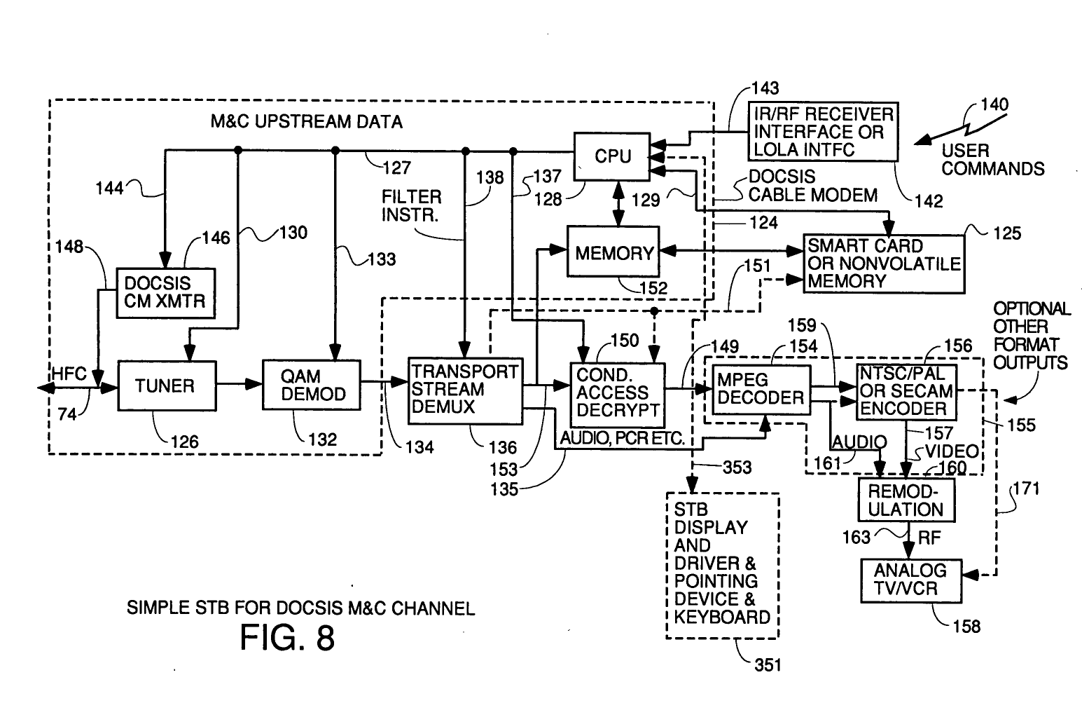

Referring to FIG. 8, there is shown a block diagram of a simple set top decoder (hereafter sometimes referred to as a set top box) with a single tuner for receiving interactive and VOD data and other services along with a DOCSIS in-band management and control channel to manage the STB and the delivered services. This type of simple, less expensive single tuner set top decoder is made possible by the thin DOCSIS technology described above where management and control data can be sent with the program data of the MPEG transport stream in MPEG packets having the DOCSIS PID. This type of set top box make it possible to receive digital television programs sent on the hybrid fiber coaxial cable of cable TV systems which formerly only sent analog television signals, each on a separate frequency division multiplexed 6 MHz bandwidth channel.

The use of single 6 MHz wide channels to send single television programs downstream on a CATV system is wasteful because the same 6 MHz bandwidth channel could be used to send approximately ten digital channels of video, audio and auxiliary data on separate PIDs in an MPEG transport stream. Thus, there is a movement to recover the bandwidth in the frequency range on CATV cable systems used to normally send analog television signals downstream.

Cable operators want to have more channel capacity so as to be able to offer more services over the same cable plant they already operate. But to recover the analog TV signal bandwidth, they must replace all the existing set top boxes which tune and provide conditional access to the analog TV signals with digital set top boxes. It is therefore desirable to be able to provide digital set top boxes which are as simple and inexpensive as possible because typical cable systems have thousands of analog set top boxes which must be replaced with digital set top boxes. Further, there is a need to provide digital set top boxes which either have the capability to receive all types of compression schemes and digital high definition television signals or which are flexible enough to be quickly and easily modified to different compression schemes or high definition resolution standards.

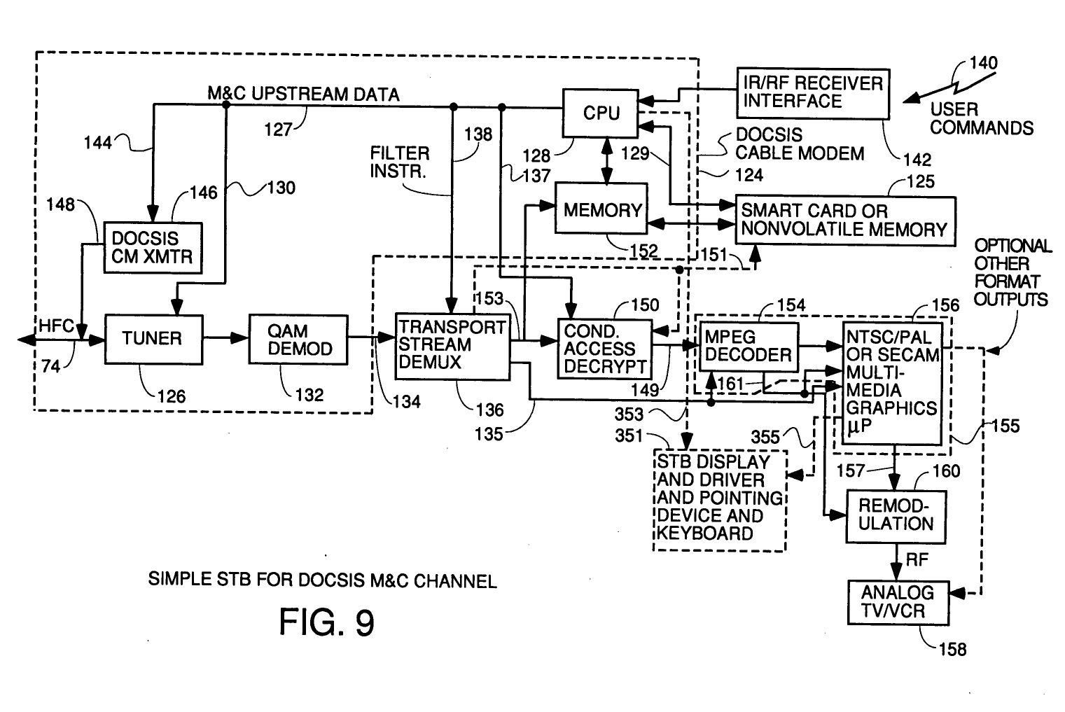

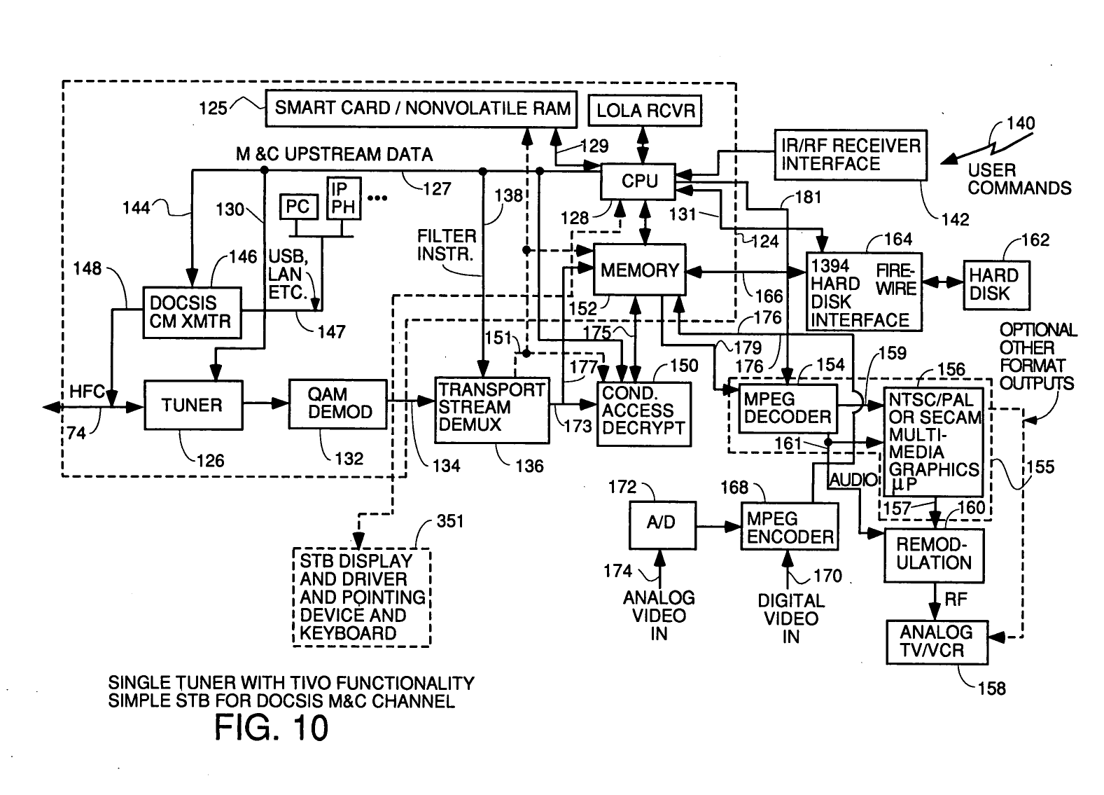

FIG. 8 represents a simple form of digital set top box which can receive digital downstream MPEG transport streams containing video, audio, PCR timing, auxiliary and management control data on different PIDs, extract the desired data, decrypte and decompress it and convert it to an NTSC, PAL of SECAM signal with accompanying audio which can be played on a conventional television set or recorded on a VCR. Standard, non high definition TV video and audio data compressed with MPEG compression is assumed and no additional capabilities are provided in the particular embodiment shown in FIG. 8. A DOCSIS upstream transmitter to transmit management and control commands such as requests for various services on a DOCSIS upstream is provided by the set top box of FIG. 8. The circuitry inside dashed box 124 in FIGS. 8 and 9, in some embodiments, is essentially identical to that of a DOCSIS compatible cable modem with the microprocessor 128 programmed to perform the additional functions described herein to receive and process orders for video broadcast and VOD programs.

In FIG. 8, HFC 74 is coupled to any conventional QAM channel tuner 126. Tuner 126 can be the same DOCSIS QAM tuner as is used in any conventional DOCSIS cable modem. The tuner 126 is controlled by the control means 128 to tune and receive the MPEG multiplex radio frequency carrier and do other processing identified below so as to output digital samples of the received signal after passband filtering and down conversion to an intermediate frequency. In some embodiments, the frequency can be fixed and the tuner need not be frequency nimble. In the preferred embodiment, the tuner is frequency nimble and tunes to whatever frequency the control means commands via data path 130 (which can be a separate data path or a shared bus 127). In some cases, the frequency to be tuned will be determined by the head end which receives an upstream request for a video-on-demand program from an STB and then tells the STB by way of a downstream message delivered on the MPEG multiplex in MPEG packets having the DOCSIS PID to tune to a particular DOCSIS downstream channel on which the requested program will be transmitted. This message is routed to the control means as are all MPEG packets having the DOCSIS PID.

The control circuit 128 is a programmed microprocessor in the preferred embodiment. However, it could be an ASIC, field programmable gate array, state machine or other such control circuitry which can perform the functions described herein.

In the preferred embodiment, the control means must be able to do at least the following functions:

receive user commands including commands to view digital video broadcast channel lineups or video-on-demand menus;

receive and display channel lineup data and/or video-on-demand menus, and navigate on on-screen menus, channel lineup tables etc. in response to user commands, and receive user selection commands such as requests to view particular video broadcast channels or view particular video-on-demand selections;

send management and control data on a DOCSIS upstream including requests for video on demand programs, reports of channel selections for video broadcasts, requests for conditional access keys for selected programs, requests to download software applications needed to provide various services, and indicating to which QAM channel the STB is tuned;

receive downstream messages on the DOCSIS PID in an MPEG transport stream and recover the data therein;

receive requested software applications transmitted in MPEG packets having the DOCSIS PID and recover and install them;

search the channel lineup table using data regarding a user selection of a broadcast channel to find a corresponding mapping entry for the selected video broadcast and gather data regarding which QAM channel the requested digital video broadcast will be on and what will be the PIDs of its video, audio, PCR timing, supplemental data, ECM message and, in some embodiments, the EMM message carrying the session key for the selected channel or program;

receive and recover the data from downstream messages on the DOCSIS PID in response to upstream VOD requests, said downstream messages indicating the QAM channel on which said VOD request will be sent, the transport stream on which said VOD request will be sent and information from which the PIDS of the component parts of said requested VOD program can be obtained directly or indirectly;

perform all necessary functions to send tuning commands and any other data needed to cause said tuner to tune and receive the appropriate QAM channel containing the requested program;

send appropriate configuration data to said QAM demodulator so that it can demodulate, deinterleave and error correct the received data of an MPEG multiplex or transport stream sent on a QAM channel;

determine the PIDs of the component parts of the requested video program including at least the video, audio, and PCR timing, and the ECM message data or attribute if said ECM message is sent as part of the video program;

receive EMM messages containing encrypted session keys and addressed or encrypted so that only said STB which sent said upstream request for a video program can decrypt them using a private user key of said STB, and either decrypt said session key using said private user key or send the EMM messages to key store means for decryption so as to obtain a decrypted session key;

send the decrypted session key to appropriate circuitry for decryption of a working key in said ECM message or recover said working key in said control circuit using said decrypted session key and send said working key to said conditional access means; and

generate and send to said transport stream demultiplexer appropriate filter commands to cause MPEG packets having PID 0 and the DOCSIS PID to be selected from said MPEG multiplex and sent to said control circuit and to cause MPEG packets having the video PID to be extracted and sent to said conditional access means for decryption and to cause MPEG packets having the audio PID, PCR PID and supplemental data PID to be extracted and sent to the appropriate circuits for processing to decode said audio data and synchronize it with decoded video data, and to extract MPEG packets having a PID indicating they carry an EMM message and sent them to the appropriate circuit for decryption of the session key.

In the preferred VOD embodiment, the following functions are performed to recover the PIDs of the component parts of the VOD program:

construct a PAT table from said MPEG packets having PID 0 which are extracted by said transport stream demultiplexer and stored in said memory for processing by said control circuit when a video-on-demand program has been selected;

use the PAT table to determine the transport streams that are in any MPEG multiplex output from said quadrature amplitude demodulator and the programs that are in each transport stream;

process the PAT table to determine the PID of packets encoding a PMT table for particular requested video-on-demand program carried on a particular MPEG transport stream;

send filter commands to the transport stream demultiplexer telling it to filter out MPEG packets having the PID of the PMT table and use the PMT table to determine the PIDs of the component parts of the requested VOD program.

In one embodiment, the control circuit is a microprocessor programmed to find the PIDs of the component parts of the requested VOD program by performing the following steps:

construct the PMT table from the extracted packets with the PID of the PMT table received from the transport stream demultiplexer;

determine from data in said PMT table which PIDs MPEG packets encoding various parts of said requested VOD program will have;

generate and send to said transport stream demultiplexer filter commands suitable to cause said transport stream demultiplexer to filter out MPEG packets bearing data of said requested video-on-demand program and send them to the appropriate circuitry.

This control circuitry 128 is referred to in the claims as a control circuit and it can be any type circuitry which can perform the above listed functions and/or any other functions identified elsewhere herein required to control the digital set top decoder to function in the manner described in any of the embodiments described herein. It is the control circuit which sends tuning commands to tuner 126 via data path 130.

The tuner receives the multiplex signal and filters out unwanted RF signals outside the bandwidth of the MPEG multiplex signal. Typically, the tuner will have an gain control (GC) amplifier which has its gain controlled by the control circuit 128. The GC amplifier will drive a bandpass filter with a broad passband which filters out RF signals outside the band that the downstream MPEG multiplex is in. The bandpass filter feeds the filtered MPEG multiplex RF signal to a mixer which mixes it with a frequency nimble local oscillator signal which has its frequency controlled by microprocessor 128 so as to mix the signal down to an intermediate frequency (IF) signal. The IF signal is then filtered in a narrow passband filter having a passband bandwidth which is set to equal the bandwidth of the IF signal. Finally, an analog-to-digital converter samples the signal at a rate sufficiently fast to satisfy the Nyquist criteria so as to output a stream of samples. In some embodiments, this stream of samples is processed by known narrow band excision circuitry to remove samples which may be corrupted by narrow band interference.

The filtered samples are output to a QAM channel demodulator 132 which functions to recover the packets that contain the video, audio, PCR timing and other data of the requested program and management and control data. Typically these packets are MPEG-2 but later MPEG standards or other compression standards are included within the genus of the invention. The packets are recovered from the received constellation points. Any conventional QAM demodulator circuitry which can recover the packets of a transport stream or MPEG multiplex from the received constellation points will suffice. An the QAM demodulation section of a DOCSIS compatible cable modem can be used.

In some embodiments, the QAM demodulator will include a programmable despreader that can be turned on or off depending upon the downstream channel UCD message parameter that indicates whether spectrum spreading is on or off. However, in the preferred embodiment, spread spectrum downstream bursts are not allowed on the downstream DOCSIS channel, so the QAM demodulator just includes the circuitry needed to demodulate a non spread spectrum digitized QAM signal. Typically, this circuitry includes the circuitry needed to undo the forward error correction processing done by the downstream PMD layer at the headend. Typically, this would include a sample buffer, a downstream symbol clock recovery circuit which synchronizes a local oscillator symbol clock to the recovered downstream symbol clock, an equalizer filter, a programmable Viterbi decoder to detect the data bits in each received constellation point, circuitry to reassemble the Reed Solomon (RS) blocks, deinterleave them and error correct them using the error detection and correction bits in each block, and a Transmission Control layer interface to reassemble the MPEG-2 packets from the decoded RS blocks.

The MPEG-2 packets of the MPEG multiplex are output on line 134 to transport stream demultiplexer 136. This demultiplexer receives filter instructions on data path 138 from the control circuit 128 (hereafter sometimes referred to as the microprocessor) that indicate the PIDs of the program elementary stream(s) (PES) that carry the compressed data of the digital video broadcast or video-on-demand program the user has ordered. The microprocessor 128 knows what broadcasts or VOD programs the user has ordered by virtue of monitoring the navigation commands the user has entered via the remote control and infrared or RF commands 140 received by IR/RF receiver interface 142.

Any circuitry to receive user commands can be used including touch screens, or any other pointing devices or a LOLA interface. The LOLA interface allows the STB to be controlled with the TV's own remote thereby eliminating the need for a separate remote for the STB. The LOLA interface deduces the broadcast channel the user wishes to view by picking up radiated signals from the TV's local oscillator. The circuitry and software of the LOLA interface is taught in U.S. patent application Ser. No. 10/295,184, filed Nov. 16, 2002, which is hereby incorporated by reference.

The user commands to view a broadcast channel or order a VOD program are sent to the microprocessor 128 via line 143. In the case of a VOD program, the user commands are converted to upstream M&C request data on data path 144 which are sent upstream by DOCSIS transmitter 146. These user commands request transmission of the requested VOD program to the STB and, in some embodiments, also request download of the appropriate application program software needed. In some embodiments, the upstream request will also request transmission downstream of the appropriate encrypted session key for the VOD program in an EMM message. In alternative embodiments, DOCSIS transmitter 146 can be a full bidirectional DOCSIS compatible cable modem with a USB, USB II, SCSI, SCS III, or any other type bus and/or any type of local area network output 147 for coupling the set top box to one or more personal computers, IP telephony or any other device that needs to send and/or receive digital data to and from a headend using separate full DOCSIS upstream and downstream channels.

Another function of the microprocessor 128 is to program the transport stream demultiplexer 136 to extract the MPEG packets of the program the user requested. This is done by generating filter commands on data path 138.

In the preferred embodiment, data paths 144, 130, 138 and 137 are all part of a single bidirectional data bus and address bus 127 in the preferred embodiment, but they can be separate data paths in alternative embodiments. The microprocessor individually addresses CM transmitter 146, tuner 126, transport demultiplexer 136 and conditional access decryption circuit (CA) 150 at different times and delivers appropriate data and/or instructions for operations of each of these circuits to received the requested programs or services. The upstream M&C data delivered on data path 144 is transmitted upstream on the conventional DOCSIS upstream 148 by a DOCSIS cable modem transmitter 146.

How the appropriate filter commands are generated depends upon whether the user has requested a VOD program or a broadcast channel. If the user has requested to view a broadcast channel, the microprocessor 128 just searches a program guide or channel lineup table for the channel requested and looks up the the frequency of the QAM channel on which the M multiplex carrying the requested program is being transmitted, the particular transport stream in the multiplex containing the requested program, and the PIDs of the video, audio, PCR timing and any supplementary data in the channel lineup table. The lookup table contains the frequency of the QAM channel upon which the requested video program is to be transmitted upon or is being transmitted upon. The channel lineup table is sent to every STB in MPEG packets having the DOCSIS PID. The PIDs obtained from the channel lineup table for the requested program are then sent to the transport stream demultiplexer along with the ID of the particular transport stream on which the requested program is being transmitted. The frequency of the QAM channel found in the channel lineup table is sent to the tuner 126. The DOCSIS downstream data contained in the M packets having the DOCSIS PID also contains information describing the DOCSIS downstream channel characteristics of each DOCSIS downstream being carried on an MPEG multiplex. This data is used by the microprocessor to generate proper control commands for the QAM demodulator 132.

The transport stream demultiplexer 136 responds to the filter commands received on data path 138 by extracting the encrypted video data MPEG-2 packets containing the ordered program and sending them to conditional access circuit 150. The M packets containing the PIDs of the audio data of the program, PCR timing and any supplementary data are extracted and sent to the MPEG decoder 154 via data path 135. Although not separately shown, the MPEG decoder 154 in the embodiments of FIGS. 8 and 9 has its own frame buffer(s) to store video and audio MPEG frames to be decoded and frame buffer(s) to hold decoded video and audio data in the preferred embodiment. In alternative embodiments, the memory 152 can be used for these functions, as shown in the embodiment of FIG. 10.

When the ordered program is a VOD selection, the demultiplexer 136 also extracts MPEG packets with PID 0 containing the PAT table and stores them in memory 152 for use by microprocessor 128 in determining which transport streams are in the received MPEG-2 multiplex and which programs are in the transport streams. For every program in a transport stream, the PAT table contains an entry with a program number and a corresponding PID value. The PID value identifies the packets that contain the Program Map Table (PMT) table. The microprocessor 128 processes the packets containing the PAT table to reconstruct the PAT table to determine the PID of the PMT table for the transport stream containing the MPEG-2 packets carrying the data of the requested program. The microprocessor then sends filter commands to the transport stream demultiplexer 136 requesting it to extract the MPEG-2 packets containing the PMT table and load them in memory 152. Once this is done, the microprocessor constructs the PMT table from the MPEG packets having the PMT table PID, compares the data the PMT table has stored therein regarding the requested VOD program to the PIDs in the PMT table. The microprocessor then determines which PIDs the requested program will be on. Suitable filter commands are then generated and sent to transport stream demultiplexer 136 to cause it to extract the MPEG packets having the PIDs of the ordered VOD program with instructions to route the encrypted video data packets to the conditional access decryption circuit 150 and the audio, PCR timing and supplementary data packets to the MPEG decoder.

In embodiments where a conditional access table (CAT) is used, it will be transported in packets having PID 1. These packets will be extracted by the transport stream demultiplexer in some embodiments and sent to microprocessor 128 for extraction of data therein. The CAT table contains information about encryption of the video or audio of programs and contains the PIDs of packets containing control information for conditional access systems such as the PID of the EMM message if the EMM message is not sent on the DOCSISPID.

The STB of FIG. 8 can use any conditional access circuit 150 including the prior art method of conditional access described in the “Open Cable Architecture” book incorporated by reference herein. Alternatively, the STB can use the DOCSIS key exchange protocol, or it can use the the less-bandwidth-intensive, ask-and-receive conditional access method described later herein. In this ask-and-receive protocol, the prior art data carousel is eliminated and only the keys needed by a particular STB for a particular service are requested and are sent in-band on the DOCSIS PID as an EMM message. The ECM messages are sent in-band also but as an attribute of the requested program with the PIDs listed in the PMT table, but in alternative embodiments, the ECM messages can be sent on the DOCSIS PID on an ask and receive basis.

The difference of the ask-and-receive protocol over the prior art is there is no data carousel on an OOB channel which requires a separate tuner. In the prior art, the data carousel sent on the OOB channel contains all the EMMs and ECMs for all services. In the ask-and-receive protocol used in some embodiments herein, only the session keys that are needed for VOD programs which have been ordered are sent, and they are not sent on an OOB channel but are sent on the DOCSIS PID. More details about the ask-and-receive protocol are given below under the Conditional Access Protocol heading. Smart card or other nonvolatile memory key store 125 stores a private user key of this STB. This private key is also known to the head end and is used to encrypt the session key for each requested VOD program with the encrypted session key being transmitted downstream in an EMM message. In embodiments where the key store 125 is a removable smart card, it has a secure microprocessor therein which uses the private user key to decrypt a session key for each requested program. This encrypted session key is contained in an EMM message in MPEG packets having the DOCSIS PID and stored by the transport stream demultiplexer in memory 152 for use by the microprocessor 128 or the smart card or conditional access circuit 150 (depending on the embodiment) to decrypte the session key using the private user key. The decrypted session key is then stored in memory 152 where control circuit 128 accesses it and sends it to conditional access circuit 150 via data path 137. If key store 125 is a simple nonvolatile memory, control circuit 128 accesses it by data path 129 to read the private user key and uses that key to decrypt the session key for each requested VOD program or requested broadcast channel, and then sends the decrypted session key to conditional access circuit 150 for recovery of the working key.

The filter commands generated by the microprocessor 128 cause the transport stream demultiplexer 136 to filter out MPEG-2 packets which contain the decryption keys in Entitlement Management Messages (EMM) and Entitlement Control Messages (ECM) which are needed to decrypt the payload data of any packets of encrypted services such as pay-per-view events, VOD, etc.

If the prior art method of conditional access is used in an alternative embodiment, conditional access circuit 150 is a secure microprocessor and a payload decryption engine, both mounted in a smart card so that they can be removed and replaced in case of a breach in security. The removable card will have an edge connector or a series of conductive contact pads on the outer surface thereof which make contact with brush conductors when the card is seated in the STB so as to make contact with the other circuitry in the STB.

In other embodiments, the conditional access circuit is a permanent circuit in the STB, and the smart card 125 is a removable card with a secure microprocessor and nonvolatile memory storing the private user key. The secure microprocessor is programmed to use the private user key to decrypt the session key in EMM message bearing MPEG packets extracted by the transport stream demultiplexer and sent to the secure microprocessor on data path 151. The decrypted session key is then sent back to the conditional access circuit via data path 151.

In some embodiments where the ECM message is sent on the DOCSIS PID, the filter commands cause EMM messages to be filtered out from the DOCSIS PID in the MPEG-2 multiplex, and sent to the secure microprocessor 150 which decrypts them to recover a session key. The filter commands also cause ECM messages to be filtered out from the DOCSIS PID in the MPEG-2 multiplex and sent to the secure microprocessor 150 for decryption using the session key to recover a working key. In other embodiments, the ECM message is transported on its own PID as an attribute of the program and is extracted by the transport stream multiplexer and sent to the smart card 125 for decryption using the decrypted session key. The working key is then sent to the conditional access circuit 150 for decryption of the data of the requested program. The encrypted payload sections are decrypted in the conditional access circuit using the working key, and the resulting MPEG packets containing decrypted video data are sent to an MPEG decoder 154 for decompression, storage and synchronization with the audio data.

The MPEG decoder 154 is conventional. Decrypted MPEG video (or audio) packets will be sent to it on data path 149 from the conditional access circuit. Where the requested program has only encrypted video, the MPEG audio packets and PCR timing data will be sent to the MPEG decoder on data path 135. The MPEG decoder uses the PCR timing data to synchronize its internal clock to the clock that was used when the data was compressed at its source. In each of the video and audio data streams there are timestamps which control when to decode each of the video and audio data (DTS) and when to present (PTS) each of the video and audio data. The decoded video and audio data is stored in separate video and audio frame buffers in the MPEG decoder and read out at presentation time. The DTS and PTS timestamps are compared to the synchronized local clock to determine when to decode and present each of the video and audio data. The video data is presented on line 159. The audio data is presented on line 161 which can be coupled to the encoder 156 or a mixer in remodulator 160 in some embodiments.

The decompressed video data is sent in YUV or RGB format (either digital or analog) to an NTSC/PAL/SECAM encoder 156 to generate a television signal (in either digital or analog format) suitable for the country in which the system is operated and the type of television/VCR 158 to which the STB is coupled. The video television signal is supplied on line 157 to a remodulation circuit 160 to modulate the television signal onto an analog RF carrier. The audio signal on line 161 (either digital or analog format) is also supplied to the remodulation circuit. The RF carrier modulated with a TV signal on line 163 contains both audio and video information.

If a separate remote is used to control the STB, the RF carrier has the frequency of channel 3 or channel 4. If the LOLA interface is used, the RF carrier has the frequency of whatever channel the user picked with the TV remote control.

In some embodiments, the encoder 156 outputs composite video and audio signals on an RCA jack interface or component output signals also on an RCA jack interface or S-Video signals at an S-Video jack or an AC-3 signal, or all or some subset of the above other format outputs on dashed line 171. In these embodiments, the audio signal on line 161 is coupled to the encoder 156, as represented by the dashed segment of line 161 coupled to encoder 156.

The microprocessor 128 executes a resident navigation program and operating system stored in memory 152 to respond to user commands. In some embodiments, the navigation program can be downloaded from the head end, but this tends to create too much downstream traffic, so the preferred embodiment is for the navigation program to be resident at all times in the STB. The microprocessor generates upstream requests to download just the application software needed to do any processing for which the application program is not resident on the STB.

In some embodiment, the microprocessor is programmed to request via the DOSCIS upstream downloading of only the conditional access key(s) needed to decrypt the packets containing the data of the ordered VOD or video broadcast program(s). In some embodiments, the microprocessor 128 is programmed to request immediate download of an MPEG I-frame for the requested program such that decoding of the requested program data can begin immediately upon receipt of the MPEG I-frame and does not have to wait for the MPEG I-frame for the program to come in the natural order of the MOM transport stream. In this embodiment, filter instructions are generated to cause the MPEG packets containing the I-frame to be routed to the MPEG decoder. The I frame can be sent on the DOCSIS PID or it can sent “native”, i.e. on the QAM channel upon which the video program is delivered. Insome embodiments, the microprocessor makes upstream requests to download only the session keys needed for requested broadcast channels when the user requests tuning to the broadcast channel. In the preferred embodiment, session keys for broadcast channels to which the STB is subscribed are downloaded periodically and not upon every request by the user to change the channel.

In some embodiments, if the user has requested program guide data, the microprocessor 128 is programmed to generate an upstream M&C request to request only the desired program guide data and not the entire program guide. In some embodiments, the microprocessor may also generate upstream requests to also download program guide data for neighboring channels to the channel for which a user request was received so that the user can see what other programs and services are available on neighboring channels at around the current time or some user specified time. The microprocessor 128 also executes a loader process which is resident in memory 152 which functions to receive MPEG packets carrying application software to execute services the user ordered, assemble the packets into a computer program, load the computer program in memory 152 and launch it in time to process the incoming MPEG-2 packets of the service. The head end is responsible for sending the application software for an ordered service on the DOCSIS PID sufficient far ahead of the time the service data itself is sent downstream to give the loader time to load and launch the application software for the service.

Memory 152 stores programs for execution by microprocessor 128 which implement the DOCSIS protocols such as those shown in FIG. 7 on the cable modem side. The downstream PMD layer functionality is implemented in DOCSIS transmitter circuitry 146. Memory 152 also stores programs to control the STB such as implement the user interface, navigate, implement an operating system, receiver user commands and generate upstream requests for services, keys and application program downloads, as well as a loader program described below.

In some embodiments, the microprocessor 128 is programmed to execute an agent program that keeps a running tally of the programs and services the user views or uses and either sends this data as upstream M&C data periodically or waits for the headend to request it. This allows the head end circuitry to generate and send downstream to the appropriate STBs targeted advertising messages selected according to the viewer's tastes and preferences.

FIG. 9 represents an alternative embodiment of a single tuner STB where the NTSC/PAL/SECAM encoder 156 is a multimedia graphics processor which genererates an analog television signal of the proper format and overlays graphics on the displayed images to display program guide data, navigation information, and whatever other graphics information is needed. Such graphics processors are currently used in STBs of DBS and cable systems. All other circuits and alternative embodiments are the same as FIG. 8.

FIG. 10 represents an alternative embodiment of a single tuner STB with TIVO type digital video recording capability. The circuits with like reference numbers as circuits in FIGS. 8 and 9 are the same type circuits and the various alternative embodiments mentioned for FIGS. 8 and 9 are within the set of alternative embodiments for FIG. 10.

In this main embodiment symbolized by FIG. 10, memory 152 stores, in addition to the programs described above for the control circuitry of FIGS. 8 and 9, a digital video recording program like that used for prior art TIVO® digital video recorders including TIVO digital video recorders as incorporated in set top boxes for direct broadcast satellite and made by Phillips Electronics of Knoxville, Tennessee under Model Number DSR6000R01 for use in DirecTV® direct broadcast satellite systems, the details of which are hereby incorporated by reference. Microprocessor 128 executes this TIVO control program to control a hard disk 162 or other bulk storage medium for storing digital data using a hard disk controller IEEE 1394 interface or other high bandwidth bulk storage controller 164.

There are some minor differences described herein between the TIVO control program in the STB of FIG. 10 and the TIVO control program in prior art stand alone TIVO recorders that connect to CATV systems or TIVO recorders that are incorporated into direct broadcast satellite systems. The only difference is the path by which the program guide data arrives and the fact that video-on-demand is available in the embodiment of FIG. 10 as opposed to the near-video-on-demand that is found in direct broadcast satellite (DBS) systems which have no upstream.

In the TIVO programs in DBS systems, there is no upstream via the satellite dish but there is an upstream via the phone lines and there are no video servers which can feed a VOD program as an MPEG transport stream on the uplink to the satellite everytime a user asks to view that program. Instead, in the prior art TIVO/DBS systems such as the Phillips Electronics DSR6000R01, when the user presses the channel guide button, the channel guide for a selected group of channels adjacent the channel currently being watched is displayed. A group of channels starting at 101 is devoted to pay-per-view movies and events. When the user wishes to view a movie or event, she moves the cursor to highlight the program on the lineup of programs being displayed at various times on a channel and presses the record button. This does not causes an upstream message to be sent since VOD is not being implemented and this a difference over the embodiment of FIG. 10. Instead, in the prior art DBS systems with TIVO, the inventors believe that a charge record for the movie or event to be viewed is stored in memory. These charge records are collected later on a periodic basis by a call from the headend to the phone number registered with the headend that the set top box modem is supposed to be connected to. The data on charges is then collected in a monthly or otherwise periodic phone call and billed to the customer's registered credit card. If the receiver is not still connected to that phone number, or the credit card account is closed or does not validate the charge, the capabilities of the STB will be reduced and PPV or NVOD movies cannot be ordered.

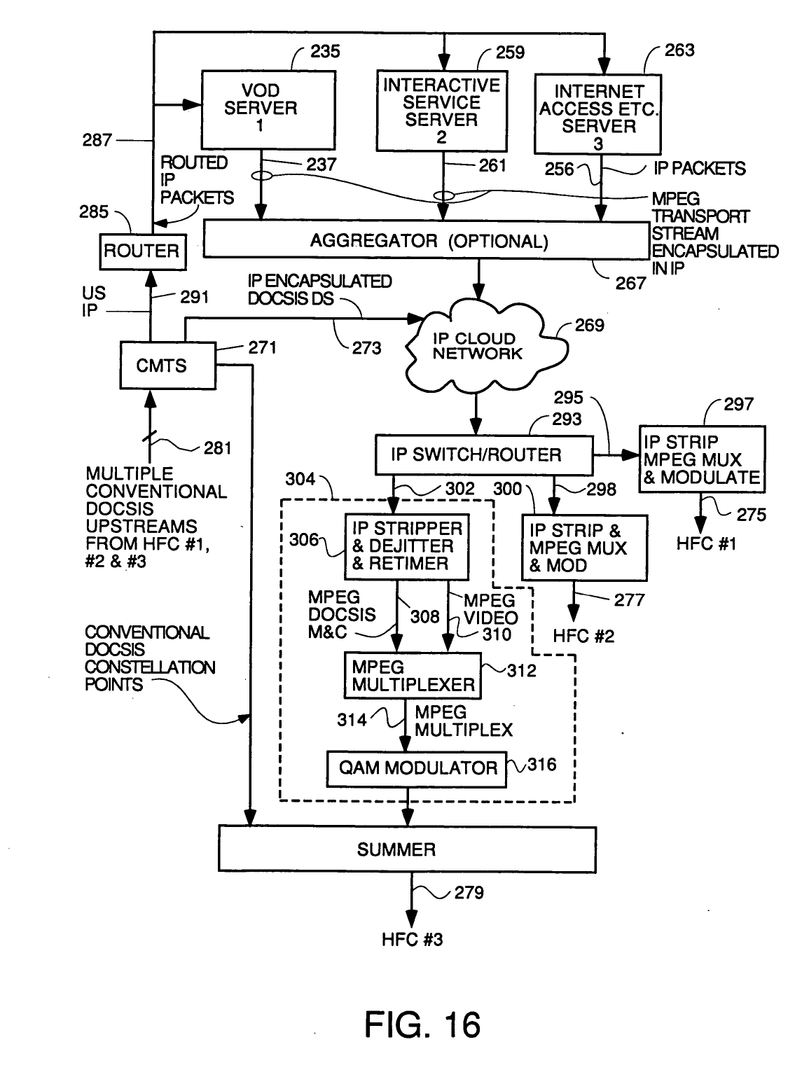

The programs the user requests are not sent as soon as the user requests in this DBS prior art. Instead, they are started on regularly scheduled broadcast times, and the TIVO recorder captures them. This avoids the need for an upstream on the satellite data path. But true video on demand is not present as the user may have to wait for quite some time before the next showing of the video program occurs. Because the programs are regularly scheduled in the DBS NVOD system, there is no need for an upstream request message and a downstream message in response telling the STB which QAM channel the program will be on and which MPEG transport stream and the PID of the PMT table of the program. All that information is downloaded on a regular basis in the DBS prior art with the channel lineup table and can be looked up at will by the DBS prior art STB. But this functionality is already part of the control program for the control circuit 128 in the embodiment of FIG. 16 so it is only necessary to modify the TIVO control program to get the MPEG packets to be stored on the hard disk 162 from memory 152. In the embodiment of FIG. 10, the microprocessor 128 is programmed to do all the VOD functions described above to: receive a request to view a particular VOD program listed on the VOD menu; send an upstream request for that program; receive downstream message(s) indicating the QAM channel and transport stream that will be used and the PID of the PMT table; and obtain the encrypted session key for the program either from the DOCSIS PID packets sent in the ask-and-receive protocol or from the DOCSIS PID packets of a data carousel. The TIVO control program need not do any of this. It only needs to be modified to receive a command to record a particular broadcast or VOD program and then retrieve a message from the process that processed the VOD request via data path 131 as to where in memory 152 the MPEG packets of the requested program will be stored. These packets are then sent to the hard disk 162 for storage through hard disk controller 164.

The data paths differ slightly for the embodiment of FIG. 10 from the embodiments of FIGS. 8 and 9. In the embodiment of FIG. 10 the memory 152 is used as a frame buffer for transfer of video and audio data to either the hard disk 162 or the MPEG decoder 154. When either a video broadcast or a VOD program is to be recorded on hard disk 162, control circuit 128 programs transport stream demultiplexer 136 to extract MPEG packets with the appropriate PIDs as described elsewhere herein. MPEG packets with these PIDs are extracted and the session key and working key decryption is as described elsewhere herein for the various embodiments. MPEG packets of the program itself (video, audio, PCR, supplementary data, secondary language, etc.) are, in the preferred embodiment, sent on data path 173 to CA ciruit 150 for decryption using the working key. The decrypted MPEG video and audio packets are then sent via data path 175 to memory 152 for storeage and control circuit 128, via its operating system, notes where the data is stored in memory 152 and sends a message via data path 131 to hard disk controller 164 telling it to record the data and giving it the starting address where the data is stored in memory (and number of bytes, block length, ending address, etc.) The hard disk controller (which preferably has a IEEE 1394 Fire Wire interface 166) then accesses the data via data path 166 and stores it on hard disk 162.

In an alternative embodiment, TS demultiplexer 136 can be programmed to extract the MPEG packets of the requested program and send them via data path 177 directly to memory 152 for storage prior to decryption. The packets will them be read back into memory 152 on playback and read by CA circuit 150 via data path 175 for decryption and then stored back in memory 152 for reading by MPEG decoder 154 via data path 179.

On playback of a recorded program, the TIVO functionality is used as originally designed and MPEG packets are read from hard disk 162 and stored by hard disk controller 164 in memory 152. The operating system of control circuit 128 takes note of where the packets are stored and sends a message to MPEG decoder via data path 181 that packets in memory 152 are ready to be decoded and where they are. The MPEG decoder then fetches them, decodes and resynchronizes the video and audio as described elsewhere herein and outputs the decoded video data to NTSC/PAL/SECAM encoder and multimedia graphics processor 156 for conversion to a video signal on line 157. Audio data is sent on path 161 to remodulation circuit 160 which operates as previously described.

The embodiment of FIG. 10 allows users to perform the following functions to provide personal video recorder capability to the user:

1) enter requests to get season passes to record certain shows every time they occur with options regarding how long to keep them, whether to only record first runs and ignore re-runs, whether to extend the start times and finish times by specified amounts, etc.;

2) search program guide data for shows by title or other criteria to record or view; browse the program guide and select programs to record manually;

4) view highlights of featured channels like Discovery®, HBO®, Starz®, etc.;

5) manually enter times and channels to record;

6) automatically learn the user's preferences or let the user teach the digital video recorder her preferences through thumbs up and thumbs down button pushes and automatically record shows the user may find interesting;

7) playback recorded programs using normal and multispeed fast forward and fast reverse or slow motion or stop action freeze frame;

8) pause live TV;

9) record live TV as it is watched and allow rewind and fast forward at multiple speeds and re-play at multiple speeds including slow motion and freeze frame;

10) cancel season passes or re-arrange their priority;

11) display supplementary data including plot summary, actors, ratings, whether first run or repeat, channel and time, when the movie or program will show again, if any, etc.

12) all the other functions of TIVO and other known digital video recorders.

Other features include showcases previews of coming attractions, viewer magazines, etc. These functions and the other functions of TIVO and other known personal video recorder systems are the functions of control software which controls said microprocessor to cause it to control the STB circuitry so as to implement these functions. Such a control program is referred to in the claims as controlling the microprocessor to provide personal video recorder capabilities.

In some embodiments, data is recorded by the microprocessor 128 by performing the following steps: generating upstream M&C messages requesting program guide data or a VOD menu or just VOD menu data and receiving program guide data on a periodic update basis; receiving a user command to record a broadcast program or VOD program or receiving an automatically generated request to record a certain program via season pass function or a TIVO preferences selection function; converting that request into upstream M&C message requesting download of the VOD program and its conditional access key(s) or, at the designated time of the broadcast to be recorded, generating M&C upstream messages requesting download of the conditional access keys and generating filter commands to the transport demultiplexer instructing it to extract the MPEG-2 packets of the requested VOD program or digital video broadcast to be recorded; decrypting the session key in smart card 125 or in control circuit 128 and sending it to CA circuit 150; decrypting any encrypted MPEG packets of said requested program and sending them to memory 152; receiving those MPEG-2 packets in memory and transferring them through hard disk interface 164 to hard disk 162 where they are stored (in embodiments where the MPEG packets are not encyrpted before storage on the hard disk, the encrypted packets are stored on the hard disk along with the MPEG-2 packets sent on the DOCSIS PID containing the conditional access key(s) for the program). Program guide auxiliary data containing, for example, the title, rating, actors and a plot summary along with channel and time and date recorded information may also be stored with the program data on the hard disk.

Programs are played back by the digital video recorder by the microprocessor 128 performing the following steps in some embodiments:

1) receiving a request from a user to display a list of programs recorded on hard disk 162;

2) receiving a user request to play a specified program;

3) sending a command to the hard disk interface 164 requesting fetch of the MPEG-2 packets of the program;

4) retrieving the packet data from the hard disk 162 and storing them in memory 152 via data path 166;

5) retrieving the MPEG-2 packets containing the conditional access key(s) and storing them in memory 152;

6) sending the packets containing conditional access key(s) to conditional access decryption circuit 150 for decryption and recovery of a working key;

7) sending the MPEG-2 packets of the program to the conditional access circuit 150 for decryption;

8) sending the decrypted data to MPEG decoder 154 directly (if the MPEG decoder has internal frame buffer memory) or through memory 152 for decompression; and

9) sending the decompressed data for video, audio and any associated graphics to encoder 156 for generation of analog or digital television signals of any type for display.

Special effects such as multispeed forward or reverse, pause, slow motion, etc. are all implemented in the same way these functions are implemented in a TIVO or similar digital video recorder. Other functions such as deleting or changing the save until date or changing the quality of the recording are done in the same way they are done in TIVO or other prior art digital video recorders.***

The embodiment of FIG. 10 also has a video recording feature which allows analog or digital video from any source to be recorded and played back on the STB digital video recorder. Digital video in from any source arrives on line 170 and is compressed and encapsulated in MPEG-2 packets in MPEG encoder 168. These packets are loaded into memory 152 by the microprocessor 128 which executes an interrupt service routine when it receives an interrupt that a packet is ready or which polls the MPEG encoder periodically to upload any packets it has prepared into memory via data path 176. Analog video arriving on line 174 is digitized in analog-to-digital converter 172 and loaded into MPEG encoder 168 for compression and encapsulation into MPEG-2 packets. These packets are also loaded into memory 152 by the same mechanism. The microprocessor 128 then sends suitable commands to the hard disk interface 164 to cause the MPEG-2 packets containing external video to be recorded on the hard disk. Playback is by the same mechanism previously described.

Dashed line 155 in FIG. 8, 9,10 and 11 means that in an alternative embodiment, the MPEG decoder 154 and the NTSC/PAL/SECAM encoder 156 are removable as a module and can be replaced with another module bearing circuitry which can decode different compression standards and encode the output of the decoder into a TV signal of a different format such as High Definition Television. There are several different compression and encoding standards, and circuitry for any combination of them can be included on a module that is plugged in to take the place of MPEG decoder 154 and encoder 156. In another alternative embodiment, separate lines of circuitry for each combination of decoding standard and encoding standard are present and an input multiplexer guides the compressed data to the appropriate line and an output multiplexer guides the output signals to the remodulation circuit 160.

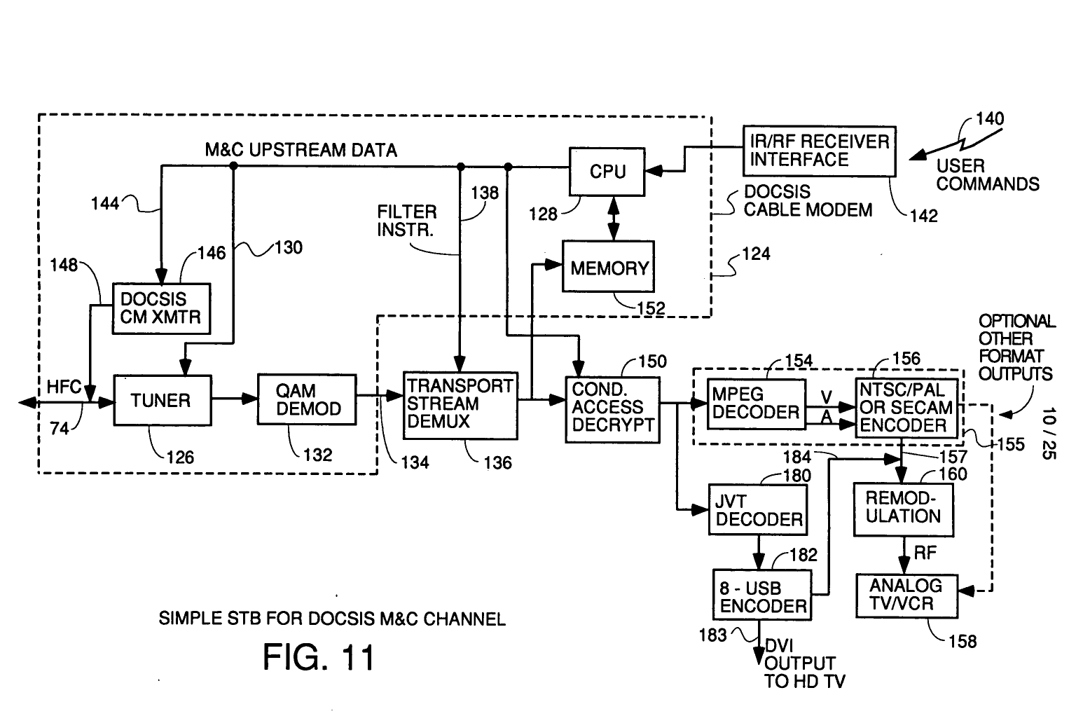

FIG. 11 is a block diagram of another embodiment for a single tuner STB which can receive JVT compressed data or MPEG compressed data. The JVT compression standard is used to compress high definition television signals. Incoming JVT packets are extracted by transport demultiplexer 136 using some packet identifier that links the packets to a requested program. The extracted packets are sent to the conditional access decryption circuit 150. Decryption occurs there in any of the ways done in the prior art or described herein. The decrypted packets are then sent to JVT decoder 180 where they are decompressed. The resulting data is then sent to an 8-VSB encoder 182 which generates an analog non interlaced scan high definition television signal which is output on line 184 to the remodulation circuit 160. In some embodiment, the encoder 182 generates an encrypted digital format output that can be coupled directly to the input of a high definition television, as symbolized by line 183. The encoder 182 may also generate component output signals and other format output signals suitable for high definition television as was the case for encoder 156. This embodiment may have alternative embodiments also such as removability of MPEG decoder 154 and encoder 156 and insertion of JVT decoder 180 and 8-VSB encoder 182 as a module. Other alternative embodiment include the addition to the embodiment of FIG. 11 of any combination of the components that distinguish the embodiments of FIGS. 9, 10, 11, 12 or 19.

### CONDITIONAL ACCESS PROTOCOL

Various conditional access mechanisms which can be used by the conditional access circuits 150 will be summarized. The program elementary stream of a service in an MPEG-2 multiplex is scrambled using control words also called service keys which are randomly generated and periodically modified. The control words are encrypted using session keys and sent over ECM messages to the STBs via the DOCSIS PID in some embodiments but using the PID of the service they pertain in most embodiments. The session key used to encrypt the service keys for a service is encrypted at the headend using the private user key of an STB that requested the service. The private user key is never sent over the DOCSIS PID. The encrypted session key is sent as an EMM addressed to the STB that requested the service via the DOCSIS PID on an as-needed, targeted basis in the preferred embodiment. The STB uses its private user key, which can be hardwired in the STB circuitry or stored on a smart card, to decrypt the session key. The session key is then used to decrypt the control word, and the control word is used to decrypt the MPEG packets containing the service data.

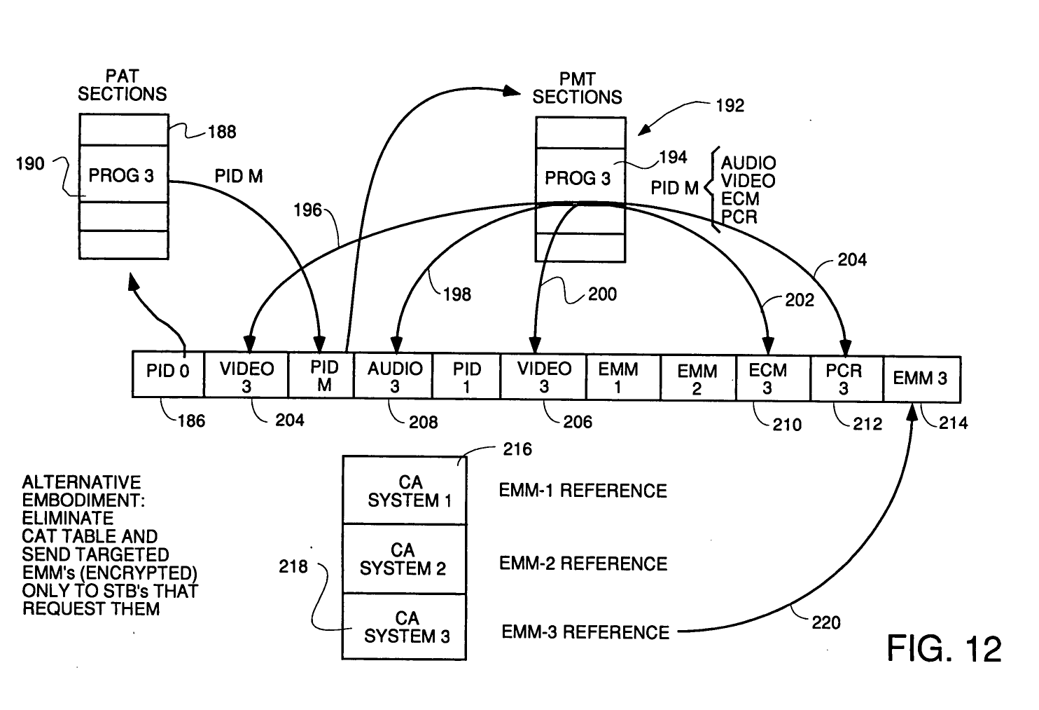

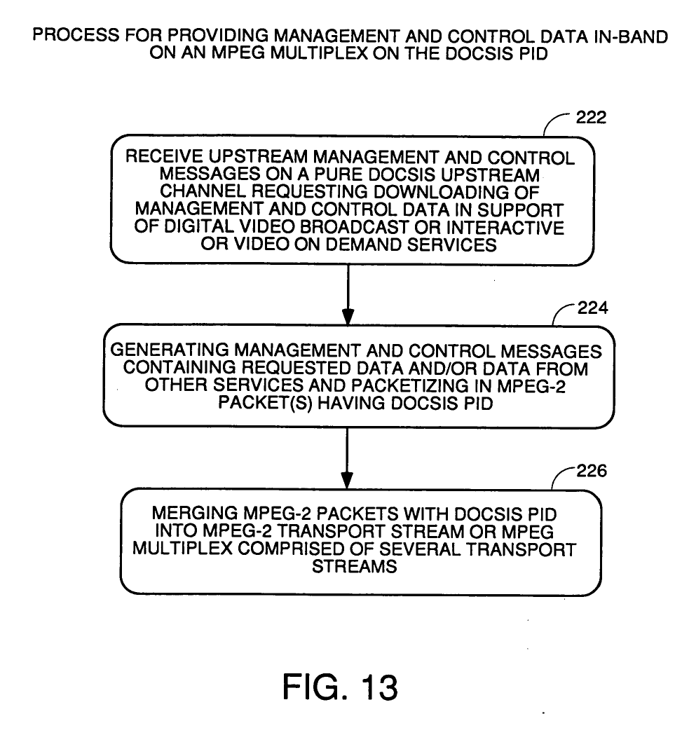

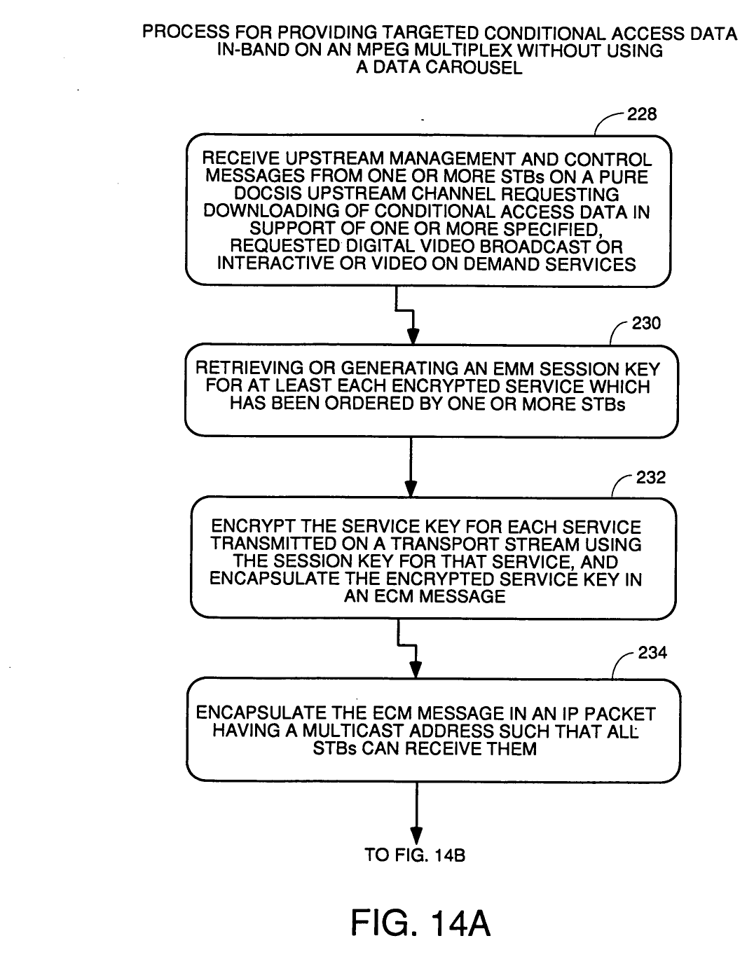

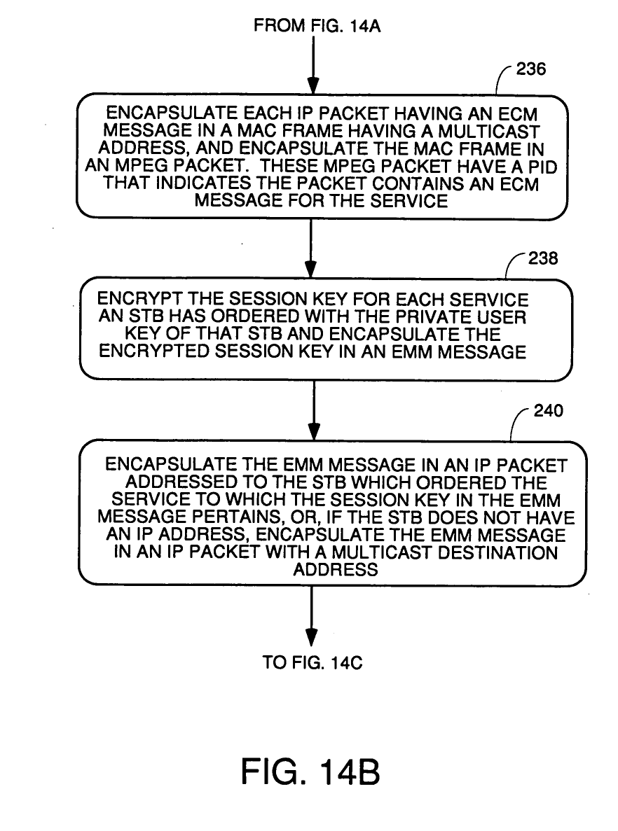

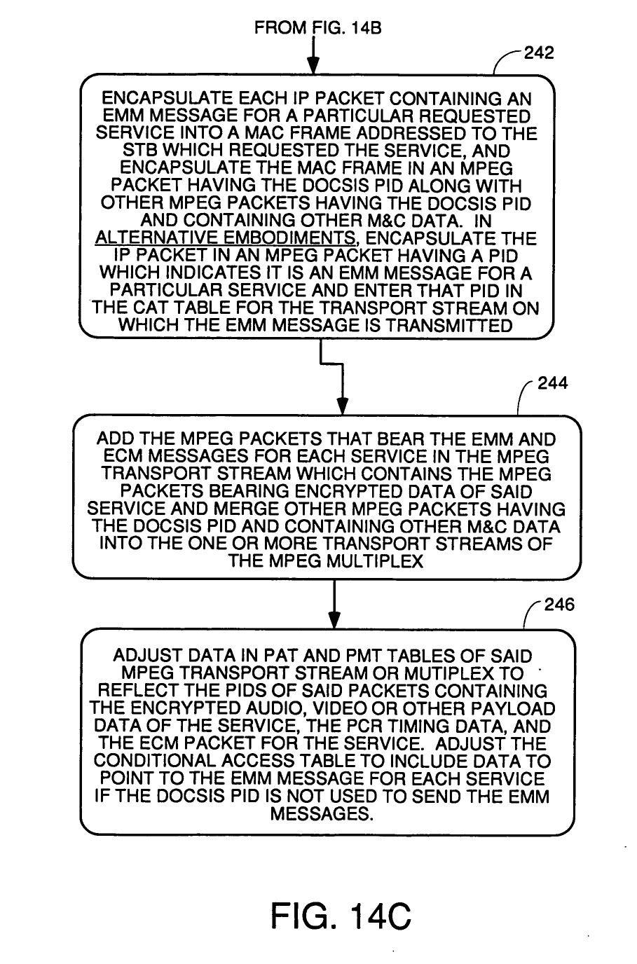

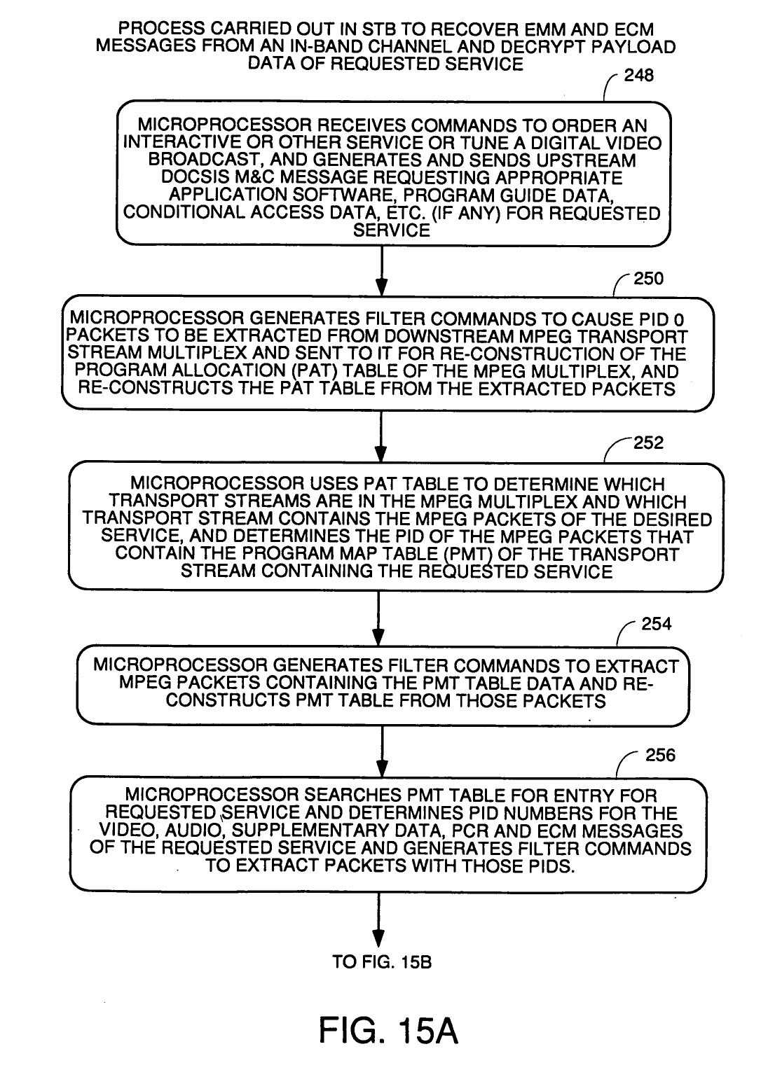

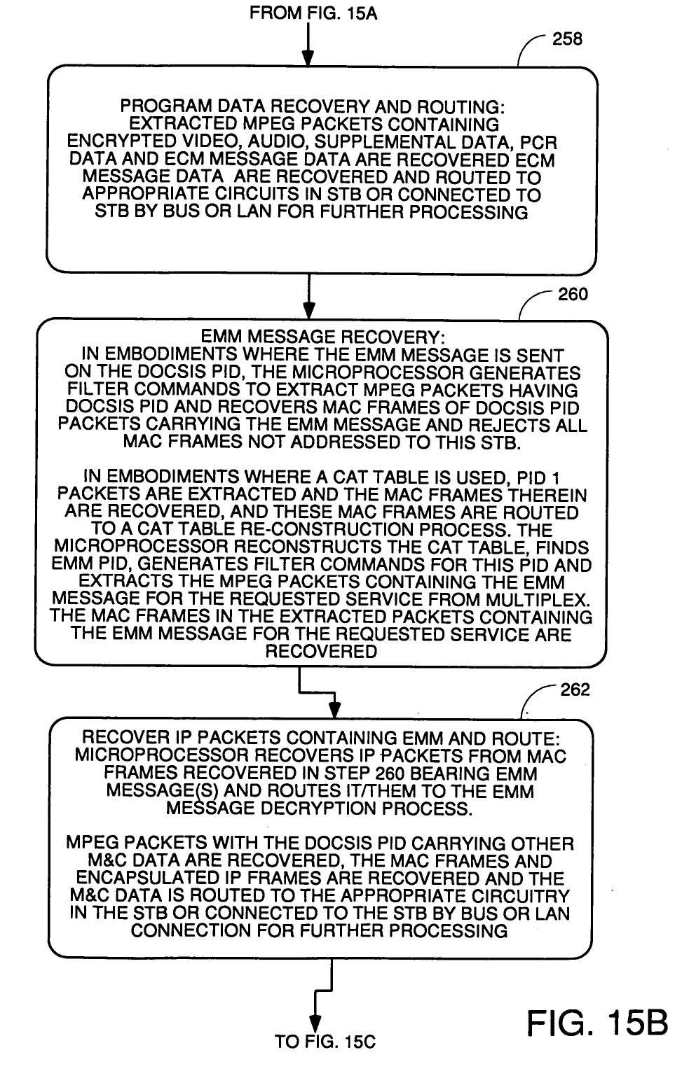

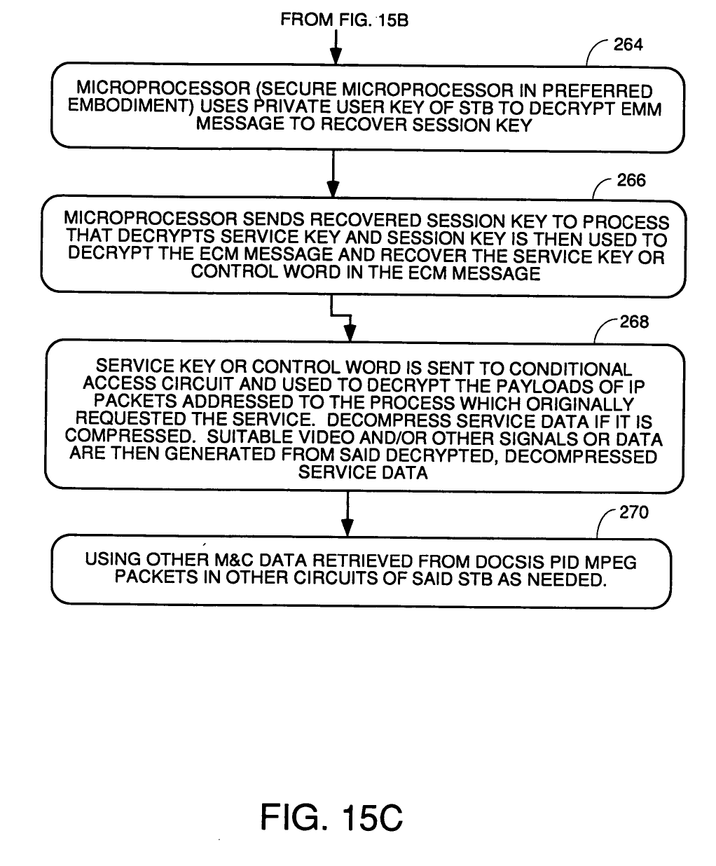

FIG. 12 is a diagram showing how the PID information for a service a user has ordered and the EMMs and ECM messages containing encrypted conditional access keys needed to decrypt the service are found in an MPEG-2 multiplex. FIGS. 14A-14C are a flow diagram showing how the generalized process of FIG. 13 is applied to sending of targeted conditional access data in-band to only the STBs that requested the conditional access data for a particular service. The process of FIGS. 14A through 14C is carried out at the DOCSIS CMTS. The process of FIGS. 15A-15C is carried out in the STB to recover the EMM and ECM messages from the MPEG multiplex when the STB receives a user command to order a certain service or view a specified program. The processes of FIGS. 12, 14, 15 and 16 will be discussed simultaneously and the differences between the processes of FIGS. 14 and 16 will be discussed.

As an overview of the preferred embodiment represented by FIGS. 16A-16C, the ECM service keys will be changed frequently for best security, and will be multicast to all STBs in-band as a data carousel in the MPEG multiplex that contains the MPEG packets bearing the data of the service. The way this works is as follows. The service keys or working keys for each service that can be ordered are encrypted with a session key of each STB and the plurality of encrypted working keys are sent as a data carousel, encapsulated in ECM messages which are encapsulated in multicast IP packets which are encapsulated in multicast MAC frames which are encapsulated in MPEG packets having the PID of the service to which each particular service key pertains. The MPEG packets containing the service key for a particular service have the PIDs for the ECM keys of the corresponding service in some embodiment or the DOCSIS PID or private data PID of the MPEG transport stream on which they are sent. The session keys are generated periodically for each STB or on a per request basis. The session key of each STB is encrypted with the private user key of that STB. In this preferred embodiment, when an STB wants to use a service, it consults the PAT table 188 and the PMT table 192 in FIG. 12 to determine the PID of the ECM messages containing the service keys for the service to be used. The STB then generates filter commands to extract MPEG packets with the ECM message PIDs from the transport stream.

Step 228 in the flowchart of FIGS. 14A through 14C represents the process of the CMTS receiving on the pure DOCSIS upstream from one or more STBs M&C data packets requesting one or more programs and/or services requested by a user and requesting downstream transmission of conditional access keys for these services and any other M&C data needed such as program guide data, application software to run the service, etc.

Step 230 represents the process of generating or retrieving a session key for each encrypted service or at least the encrypted service(s) ordered by one or more STBs. Each encrypted service has a session key which often contains information regarding which STBs have access rights to decrypt that particular service. The session keys are not unique to each STB but are unique to a particular service and may be changed periodically.

The service key(s) or working key(s) (also known as control words) which are used to encrypt the payload data of each service available on the system are transmitted as an attribute of the encrypted video or other data of every service transmitted on any particular transport stream. The control word of each service is encrypted using the session key of the service.

Step 232 represents the process carried out at the head end of encrypting each control word for a service ordered by an STB using the session key for that service, and putting the encrypted service key in an ECM message.

In step 234, the encrypted control word ECM messages are encyrpted in IP packets having multicast addresses such that all STBs can receive these IP packets.

In step 236, the IP or similar packet generated in step 234 is encapsulated in a MAC frame having a multicast address so that all STBs will receive it. The MAC frame is encapsulated in an MPEG packet. The MAC frames bearing IP packets with ECM messages pertaining to a particular service will be encapsulated in MPEG packets having a PID which indicates the MPEG packet contains the ECM message of a particular service. These MPEG packets will be sent in-band in the transport stream containing the MPEG packets carrying the data of the service to which each ECM message pertains.

In step 238, the session key for each service an STB has ordered is encrypted at the head end with the private user key of the STB which requested the service. The encrypted session key is then encapsulated in an EMM message. The private user key of the STB is known to both the CMTS and the STB, but is never transmitted over the link for security reasons. The user key is stored in nonvolatile memory in the STB, usually in a smart card which is inserted in the STB and which contains a secure microprocessor which does the decryption of the session key and uses it to recover the control word for an ordered service.

In step 240, the EMM message is encapsulated in an IP packet addressed to the IP address of the STB that requested particular service to which the session key in the EMM message pertains. If the STB does not have an IP address, the IP packet will have a multicast destination address.

In step 242, each IP packet containing an EMM message for a requested service is encapsulated into a MAC frame addressed to the MAC address of the STB which requested the service. The MAC frame is then encapsulated in an MPEG packet having the DOCSIS PID. Since the STB knows it requested the conditional access data for a particular service, it will know to which service the EMM message received on the DOCSIS PID pertains. The EMM message also contains data indicating to which service the session key encrypted in the EMM message pertains, so if the STB ordered multiple services and receives multiple EMM messages, it will know to which service each EMM message pertains. In an alternative embodiment, the MPEG packet containing the EMM message is given a PID associated with the particular service requested, and that PID is then entered in the CAT table for the transport stream. In such an embodiment, the PID of the MPEG packet itself containing the EMM message indicates to which service the encrypted session key in the EMM messages pertains. An EMM message having a PID indicated in the CAT table is indicated at 214 in FIG. 12.

In step 244, the MPEG packets bearing the EMM and ECM messages pertaining to a particular service are merged into the one or more MPEG transport streams of the MPEG multiplex carrying the service to which the EMM and ECM messages pertain. Other MPEG packets having the DOCSIS PID and containing other M&C data are also merged into the MPEG transport stream(s).

In step 246, the data in the PAT and PMT tables is adjusted to allow the STBs to find the PIDs for the encrypted video, audio, supplementary data, PCR timing data and the ECM conditional access key data for each requested service. The EMM messages and other M&C data MPEG packets will have the reserved DOCSIS PID so no entry in the PAT or PMT tables is made for them. But in embodiments where the EMM message is sent on a PID that indicates it is an EMM message for a particular service and only other M&C data is sent on the DOCSIS PID, step 246 makes an entry in the CAT table to allow the STBs to find the pertinent EMM message for each service.

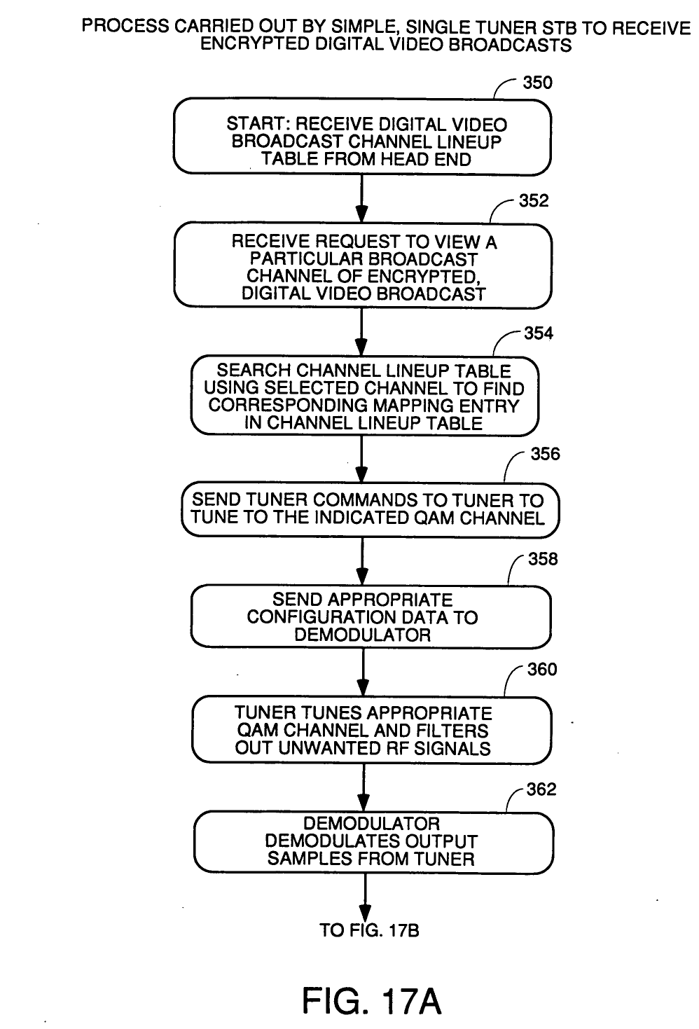

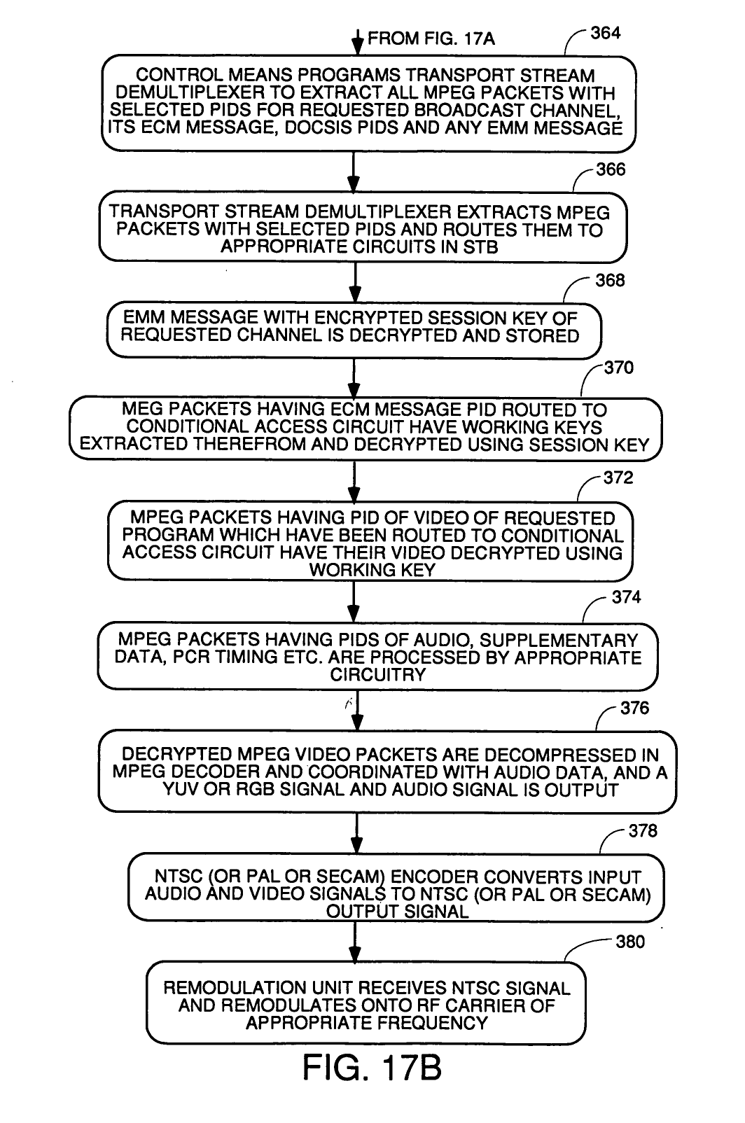

We now turn to the process which happens in an STB to recover the data packets and conditional access data for a requested, encrypted video-on-demand service, as shown in the flowcharts of FIGS. 15A through 15C and the diagram of FIG. 12. The process to receive encrypted digital video broadcast services is given in the flowchart of FIGS. 17A through 17?. Step 248 represents the process in the STB microprocessor of receiving a request from a user to order a service. This can take the form of a request to tune to and display a particular digital video-on-demand program made using a remote control which is specific to the STB or using the remote control of the television by receiving the radio frequency emissions of the local oscillator of the television and deducing the channel the user wishes to view from the received frequency. The circuitry and software to deduce the channel from the local oscillator RFI is taught in U.S. patent application Ser. No. 10/295,184, filed Nov. 16, 2002, which is hereby incorporated by reference. The microprocessor then generates and sends on the pure DOCSIS upstream an M&C message requesting download of the appropriate application software, program guide data and conditional access keys (if any) and other M&C data needed at the STB to provide the requested VOD program to the user.

In order to receive the data of the requested service and decrypt it if it is encrypted, the STB must extract the appropriate packets from the MPEG multiplex. In an MPEG multiplex, MPEG-2 packets having PID 0, of which packet 186 in FIG. 12 is typical, contain the data which defines the program allocation table 188 (PAT). The PAT table defines which transport streams are in the multiplex and which programs/services are on each transport stream. Step 250 represent the process of the microprocessor 128 in the STB generating the appropriate filter commands to cause the MPEG transport stream demultiplexer 136 in each STB to extracts these PID 0 packets and sends them to microprocessor 128 via memory 152. In some alternative embodiments, this happens automatically, and the microprocessor does not have to generate filter commands to cause the PID 0 packets to be extracted.

Step 250 also represents the process of the microprocessor processing these PID 0 packets to recover the PAT table 188. Step 252 is using the PAT table data to determine which transport streams are in the multiplex and which transport stream contains the packets of the requested service. A transport stream is comprised of an assemblage of program elementary streams (PES). For example, the video of a program will be one PES and the audio of the same program will be another PES. The PAT table contains data that allows mapping from the desired program or service to the PIDs of the MPEG-2 packets which contain the program map table (PMT) data which defines the PIDs of the packets which contain the various video, audio, ECM and PCR (timing) data for the desired program or service. Step 252 also represents the process of reading the PAT to determine the PID number of the packets in the transport stream carrying the requested service which carry the program map table data (PMT).

In the example shown, the user has ordered program 3 which has data in block 190 in the PAT table. The data in block 190 identifies PID M as the MPEG packets containing the data that define the program map (PMT) table 192 for the transport stream which contains program 3. Step 254 represents the process wherein the STB generates filter instructions on line 138 in FIG. 8-11 which tell the MPEG transport stream demultiplexer to extract packets that contain the PMT table. These packets are extracted and sent to microprocessor 128 which extracts the data that defines the PMT table from these packets and re-constructs the PMT table, as represented by step 254.

The microprocessor then searches the PMT table for an entry for the requested service (program 3), as represented by step 256. This entry gives the PIDs for all the packets of the individual PES of program 3 in block 194. Arrows 196, 198, 200, 202 and 204 represent the PID pointers in PMT table block 194 that identify the PIDs of the video, audio, ECM and PCR packets in the transport stream, that taken together, comprise the collection of PES for program 3. The video packets 204 and 206 contain compressed, encrypted video data of the program. The audio packets 208 contain the compressed, and possibly encrypted audio of program 3. The PCR packets 212 contain timestamp data that is used to synchronize the audio and video of program 3. The ECM packets 210 carry the control words or service key encrypted with the session key. The control words are needed to decrypt the payload sections of the video (and possibly audio) packets.

In some embodiments, the EMM messages are sent on the DOCSIS PID or as private data. In alternative embodiments, the EMM messages are sent in-band as part of the transport stream, and a conditional access table (CAT) 216 is included in the MPEG-2 multiplex to point to the EMM messages. The data of the CAT table is contained within MPEG packets having PID 1 (not shown). PID 1 is a reserved MPEG PID. This table lists, for each program or service, the PID number of the packet(s) that contain the EMM message(s). In the preferred embodiment, the EMM message with encrypted session key is sent on demand only to the STBs that requested them via MPEG packets bearing the DOCSIS PID, and no CAT table is used.

In the example of FIG. 12, a CAT table is used, and CAT table block 218 contains the reference to the PID of the packet 214 that contains the EMM message with an encrypted session key for program 3.

Step 256 represents the process of generating the appropriate filter commands. In other words, in step 256, the microprocessor 128 uses the information in PMT block 194 (and data in the CAT table in some embodiments) to generate filter commands to cause the TS demultiplexer 136 to filter out all the packets of the requested service, including the conditional access data, from the transport stream.

Step 258 represents the process of recovering the service data from the MPEG packets extracted in step 256. Specifically, the MPEG packets containing the encrypted video, audio, supplemental data, PCR data and ECM message data are recovered. There are DOCSIS, i.e., media access control frames (MAC frames) that contain management and control data transmitted on the DOCSIS PID, but there are no DOCSIS frames in the PES of the requested programs. The MAC addresses in the MAC frames recovered from the MPEG packets containing the DOCSIS PID are used to discard MAC frames of M&C data not directed to this STB, but in step 258, we are only concerned with recovering the MPEG packets containing PIDs of the requested program. Step 258 also represents the process of recovering the IP packets (or other packet or cell type—hereafter all referred to as an IP packet) encapsulated in the MAC frames, and using the addresses in the IP packets to route the data contained in the IP packet payloads (other packets that are addressable can also be used) to the appropriate circuitry in the STB for further processing. The encrypted ECM messages are routed to a process which will decrypt the ECM messages using the session key to recover the service key and send the service key to the conditional access decryption engine. The encrypted video packets (and possibly audio packets) are routed to the conditional access decryption engine for decryption using the service key to decrypt the video payloads.

Step 260 represents the process of recovering the EMM message for the requested service. In some embodiments, this is done by generating the appropriate filter commands to to extract the MPEG packets having the DOCSIS PID. The MAC frames in the extracted DOCSIS PID MPEG packets are recovered, and all MAC frames not addressed to this STB are rejected. In embodiments using a CAT table, this is done by generating filter commands to extract MPEG packets having PID 1. The MAC frames therein are recovered, and the IP packets therein are routed to a CAT table reconstruction process where the CAT table is reconstructed. The CAT table is searched using the requested service identifier and the PIDs of the MPEG packets containing the EMM messages is found. The microprocessor then generates filter commands to extract these MPEG packets containing the EMM message. The MAC frames in these packets are recovered.

Step 262 represents the process of recovering the IP packets from the MAC frames recovered in step 260 which bear the EMM message. The IP port addresses in these IP packets are used to route the EMM messages. The IP packets bearing the EMM message are addressed to the port of the EMM message decryption process. Step 262 also represents the process of recovering MPEG packets having the DOCSIS PID which carry other M&C data. The MAC frames therein are recovered, and the encapsulated IP frames are recovered. The M&C data in these IP packets is then routed to the processes identified in the port identifiers of the IP packets for further processing.

In step 264, the encrypted EMM messages containing the session key is decrypted using the private user key of the STB. Typically, a secure microprocessor on a smart card will be used to use the private user key of the STB to decrypt the EMM message to recover the session key and then use the session key to decrypt the ECM message to recover the service key or control word(s). In alternative embodiments, the general purpose microprocessor 128 can be used to do these functions.

In step 266, the microprocessor sends the recovered session key to another process which decrypts the service key or control word in the ECM message using the session key.

In step 268, the control word or service key is sent to the conditional access decryption engine 150 (which has also received the encrypted video packet data (and/or any other encrypted data of the service). There, the service key is used to decrypt the payloads of the video or other encrypted data packets of the program or service.

In step 270, the other management and control data sent to the STB on MPEG packets containing the DOCSIS PID is used in other circuits of the STB to control functions of the STB, display program guide data, load application software, manage the STB, etc.

The EMMs containing the sessions keys to decrypt the ECMs are put into multiple EMM messages, each encrypted by the secret user key of one STB. Each STB receives all the EMMs in some embodiments, and decrypts the one encrypted with its private user key using the private user key of the STB. In other embodiments, the EMMs are sent only to the STB whose private user key was used to encrypt it.

Preferred Conditional Access Method

In the preferred embodiment, the ECMs with service keys are changed frequently and sent as part of the MPEG-2 transport stream as an attribute of the encrypted video. The EMMs with the session keys howevever are sent only once or, in some embodiments, periodically or upon demand from a STB. The session keys encode the subscription information of the STB. Thus, if an STB has a subscription to a basic package of video channels plus a few premium channels such as HBO or Showtime, the session keys for each encrypted service to which the STB has a subscription are sent to the STB periodically and not every time the STB receives a user request for a video program. In the preferred embodiment, each session key to be sent to an STB is encrypted with the private user key of the STB and sent downstream in an MPEG multiplex via the DOCSIS PID. In this preferred embodiment of the invention, the EMM messages are sent in-band on the DOCSIS PID only once or periodically or on an as-needed basis to the STBs that requested them, and the CAT table is eliminated.

The conditional access circuits in FIGS. 8-11 can implement any one of these alternative embodiments. The user key used to decrypt the EMM messages can be maintained by the microprocessor 128 in FIGS. 8-11 or it can be kept in the conditional access circuit with the filter instructions controlling the transport stream demultiplexer to extract ECM and EMM messages as well as the packets containing the desired program or service from the transport stream and send all these packets to the conditional access circuit.

Referring to FIG. 13, there is shown a flow diagram of the general process of receiving upstream requests for management and control data and responding by sending the requested management and control data downstream on the DOCSIS PID. Step 222 represents the process of receiving one or more upstream requests on a pure DOCSIS channel requesting that one or more items of management and control data in support of a digital broadcast, interactive service or video-on-demand request be sent downstream to a specific STB. Those items can be application software, program guide data, etc. Step 224 represents the process of generating or fetching the requested management and control data and addressing it to the STB that requested the data and packetizing the requested management and control data and any other management and control data to be broadcast to all STB into one or more MPEG-2 packets having a DOCSIS PID. Typically, the fetched or generated data will be encapsulated in an IP packet or other packet type which can be addressed to the STB that requested the data and then the IP packet will be encapsulated into a MAC frame and the MAC frame encapsulated into MPEG-2 packets. Step 226 represents the process of merging the MPEG-2 packets bearing the management and control data and having the DOCSIS PID with the MPEG-2 packets of one or more MPEG transport streams carrying the digital video broadcasts, interactive services or video-on-demand data to form a single MPEG-2 transport stream or multiplex of transport streams.

### DOCSIS M&C CHANNEL BANDWIDTH CONSIDERATIONS AND LOAD BALANCING

When the number of users on a downstream reaches a high level, there is the possibility that the M&C downstream channel will become overloaded. Any conventional load balancing scheme to shift traffic from a downstream onto another downstream implemented as an MPEG-2 transport stream with a M&C channel on the DOCSIS PID will suffice to implement the load balancing aspects of the invention. To alleviate congesion on the DOCSIS PID, programs or services that are generating M&C traffic are shifted to another MPEG transport stream in the same multiplex or another multiplex on a different downstream channel frequency (referred to in the claims as “another MPEG multiplex stream). In such a case, any M&C messages pertaining to the shifted programs and already in the downstream queue of the downstream from which they came will be lost. These M&C messages and any other M&C messages pertaining to the programs or services shifted to the other MPEG transport stream will be re-transmitted or, in the case of new M&C messages, transmitted in MPEG packets having the DOCSIS PID included in the other MPEG transport stream. This relieves congesion on the DOCSIS PID in the original transport stream. In the case of lost M&C messages, the upper IP reliability layers will have to deal with retransmitting these M&C messages on the new DOCSIS PID downstream. The head end will also have to send messages to the STBs that requested the shifted services or which are tuned to the digital broadcasts that have been shifted telling the STBs to which new downstream to tune to obtain the requested services or broadcasts.

This shifting of programs or services for load balancing can be triggered in any of a number of different ways. The CMTS knows which STBs have ordered services. The CMTS, in one embodiment, can simply make assumptions based upon the number and type of services being delivered on an MPEG transport stream that the M&C data on the DOCSIS PID of that transport stream is too high when a predetermined threshold of programs and services has been ordered. This trigger point can be based also on the types of services ordered and can be lower when services having larger amounts of M&C traffic such as software downloads and program guide data have been ordered. A look up table having different threshold numbers for starting load balancing shifts for different numbers of various types of programs or services could be used so that a lower number of programs or services with high M&C traffic would cause load shifting that for other programs or services having lower amounts of M&C traffic.

Another way of monitoring the load on the DOCSIS PID is to have the STBs start a hardware or software timer when they make an upstream request and stop the timer when the request is honored and the service is delivered. The elapsed time is stored and sent in an upstream message to the CMTS spontaneously or when the CMTS polls the STB for that type of data. The CMTS assumes the load on the DOCSIS M&C downstream channel is too high when the elapsed times exceed some predetermined threshold.

### HEAD END IP SWITCHING/ROUTING

One of the disadvantages of using the MPEG transport protocol to deliver interactive services and video-on-demand or other digital service data targeted to specific STBs is that MPEG is not as a wide area network protocol for a switched environment since it does not include any connection management or any connectionless routing mechanisms. This problem is solved by the headend architecture of FIG. 16. A video-on-demand server 235 outputs an MPEG transport stream of VOD movies in MPEG packets encapsulated in IP packets on line 237. An interactive services server 259 outputs on line 261 an MPEG transport stream of interactive service data in MPEG packets encapsulated in IP packets. These IP packets are addressed to the devices or processes in the STBs or connected to the STBs by buses or LANs that ordered the services. One or more servers represented by block 263 on the internet and/or at the headend provide services such as email or web pages etc. in IP packets on line 265. These IP packets are concentrated in an optional aggregator 267 at the head end and supplied to an IP switched network 269 (the IP cloud) at the head end which includes routers and switches which route IP packets to their various destinations. In alternative embodiments, the aggregator 267 is eliminated, and the IP cloud 269 is any collection of routers and switches located anywhere, and the servers 235, 259 and 263 supply their IP packets directly to switches or routers in the IP cloud network 269. A CMTS 271 supplies downstream DOCSIS MPEG packets encapsulated in IP packets on line 273 (DOCSIS data packets) to the IP cloud 269. These downstream DOCSIS data packets include M&C data. These DOCSIS data packets are addressed to various devices and processes in or attached to the various STBs in three HFC systems the downstream media of each being represented by lines 275, 277 and 279, respectively.

The upstream media of each of these three HFC systems is represented collectively by line 281 coupled to the CMTS 271. Upstream IP packets from the various devices coupled to the three HFC systems arrive as DOCSIS data symbols on the three upstreams represented by line 281. The CMTS does conventional DOCSIS upstream processing to recover the MPEG packets encoded in said symbols and to recover MAC frames encapsulated in the MPEG packets. The CMTS also does conventional processing to recover IP packets encapsulated in the MAC frames. These IP packets are sent via line 291 to a router 285. The upstream IP packets are then routed over various data pathways, represented collectively by line 287, to the various servers to which they are addressed, including servers 235, 259 and 263.

The IP packets from servers 235, 259 and 263 which are addressed to devices on one of the three HFC networks are routed by the IP cloud router(s) to an IP switch/router 293 (which may be considered part of the IP switched network or cloud 269) which has output data paths coupled indirectly to each of the three HFC systems. There, IP packets addressed to devices and processes on HFC #1 are output on line 295 to circuitry to be described below and represented by block 297 for further processing and transmission downstream on HFC #1. The IP packets addressed to devices and processes on HFC #2 are routed on line 298 to circuitry represented by block 300 for processing and transmission downstream on HFC #2. The IP packets addressed to devices and processes on HFC #3 are routed on line 302 to circuitry represented by block 304 for processing and transmission downstream on HFC #2. The circuitry inside block 304 is the same type of circuitry as is included within blocks 300 and 297. This circuitry includes an IP stripper and dejitter and re-timing circuit 306. This circuit 306 strips off the IP headers and removes any jitter caused by encapsulating the MPEG transport stream packets in IP packets. This circuit also retimes the MPEG transport stream by adjusting the timestamps to account for different delays caused by the IP packetization process of video versus audio data MPEG packets so that the video and audio of a program will remain in synchronization.

The IP stripper has an output 308 for MPEG packets having the DOCSIS PID (which can skip the dejitter and retiming processes) and an output 310 at which MPEG packets of the VOD, interactive and other services are output. An MPEG multiplexer 312 assembles the MPEG packets on lines 308 and 310 into an MPEG multiplex on line 314. A quadrature amplitude modulator 316 breaks the MPEG packets in the multiplex into symbols and quadrature amplitude modulates two radio frequency carries having the same frequency but 90 degrees out of phase using some of the bits of each symbol to amplitude modulate one RF carrier and the other bits of each symbol to amplitude modulate the other carrier. In some embodiments, carrierless modulation using Hilbert transforms is used as is well known in the art.

The structure of FIG. 16 solves the problem found in the Pegasus prior art of the MPEG transport mechanisms not being well suited for use in switched wide are networks by basically encapsulating the MPEG packets in IP packets with the proper addresses, routing the IP addresses and then stripping off the IP headers and transmitting the original MPEG packets on the HFC systems.

Referring to FIG. 17, comprised of FIGS. 17A through 17?, there is shown a flowchart of the process in a simple, single tuner STB such as that shown in FIGS. 8 through 11 to receive encrypted, digital broadcast video. FIGS. 9 through 11 all can have displays, pointing devices, keyboards, smart cards with secure microprocessors or nonvolatile memory, and appropriate drivers like those shown in FIG. 8 as alternative embodiments, but these circuits are not shown on FIGS. 9-11 as alternative embodiments to avoid excessive clutter.

The process starts at step 350 with the STB receiving a channel lineup table via data in MPEG packets sent downstream from the head end on the DOCSIS PID. The channel lineup table includes data which identifies on which QAM frequency channel (a 6 MHz bandwidth radio frequency channel which is frequency division multiplexed from all other QAM channels) each broadcast channel is (a broadcast channel is like HBO, Discovery, CNN, etc.). The channel lineup table also contains data regarding which programs are on each channel in certain broadcast timeslots and identifies the MPEG transport stream on which each channel is transmitted. The channel lineup table also lists the PIDs of the video, audio, PCR timing and ECM message for each channel and maps the channel selected by the user such as 279 to a particular broadcast channel such as Discovery. The channel lineup table is a consolidation of the PMT tables of every transport stream plus mapping information to QAM channel, transport stream and channel number.

In step 352, the STB receives a request to view a particular encrypted digital video broadcast channel. This request takes the form of a channel number and can be received in any way such as by a remote infrared or RF transmitter for the STB or the TV remote, as described above in connection with FIG. 15. In most embodiments, the STB will have a display and a driver therefore to show the channel to which it is tuned, as represented by dashed box 351. In some alternative embodiments, the STB will have a computer display as well as a pointing device and keyboard and suitable drivers, also represented by dashed box 351 and line 353 coupling these circuits to the control circuit 128 in FIG. 8. Line 353 represents either a wired or wireless connection. The pointing device can be a mouse, touchscreen, light pen, trackball, etc. The keyboard can be integrated into the display, displayed on the display itself or be a separate unit with its own wired or wireless connection to the CPU 128. The display can be used to display menus of broadcast channels or video-on-demand selections, and the user can point and click to select a channel. In some embodiments, the user can view and interact with web pages and send and receive email on the display 351 using the pointing device and/or keyboard.

In step 354, the control circuit 128 searches the channel lineup table for the mapping entry that corresponds to the channel number selected by the user. In step 356, the control circuit sends the appropriate command(s) and data to the tuner 126 to cause it to tune in the QAM channel indicated in the mapping entry found in step 354. Step 358 represents sending appropriate configuration data to demodulator 132 in embodiments where configuration of the demodulator is done by the control circuit. This configuration data is sent on line 133 and sets up the demodulator to receive the particular type of modulation (QAM 64, QAM 256) listed for the channel in the channel lineup table. The configuration data also set the demodulator for proper deinterleaving (interleaving depth, interleaving block size, etc.) and proper Reed-Solomon decoding (block size, T value etc.) in embodiments where the forward error correction aspects of the packets transmitted in the transport stream are variable.

Step 360 represents the process of the tuner tuning to and receiving the QAM RF broadcast channel designated in the channel lineup table as carrying the requested program in one of its MPEG transport streams. Unwanted RF signals on adjacent QAM channels are filtered out. The tuner can be any DOCSIS compatible cable modem tuner. In the preferred embodiment, the tuner 126 performs gain control, down converts the received signal to an IF frequency, filters it again with a narrow passband filter and digitizes the analog signal.

Step 362 represents the demodulation process carried out by demodulator 132 to extract the packets of data encoded in the QAM constellation points, deinterleave this data, and error correct the data by doing Reed-Solomon or other suitable error detection and correction (depending upon the forward error correction scheme used for the downstream at the headend transmitter). The output on line 134 is baseband packets, typically of an MPEGmultiplex.

Step 364 represents the process of the control circuit programming the transport stream demultiplexer 136 to extract MPEG packets having selected PIDs. Step 366 represents the process of the TS demultiplexer extracting MPEG packets having the specified PIDs and routing them to the appropriate circuitry. MPEG packets having the DOCSIS PID are extracted and routed to control circuit 128 for extraction of management and control data such as EMM messages containing session keys, application software, program guide data, etc.

The EMM messages are sent only to the STBs that need them, and they can be sent on the DOCSIS PID or on an EMM PID which is listed in the channel lineup table or on the private data PID of the MPEG transport stream. The EMM message contains data regarding which STB it is addressed to and the broadcast channel to which it pertains. The TS demultiplexer 136 routes the EMM message either to the conditional access circuit via path 153 or to control circuit 128 via memory 152 or to smart card 125 via path 151, depending upon the embodiment as to where the session key will be decrypted. The preferred embodiment is to use a secure microprocessor in smart card 125 to decrypt the session key.

The session key for each broadcast channel to which the STB is subscribed is not sent upon every request to tune to that broadcast channel. Instead, the appropriately encrypted sessions keys for each STB are sent periodically to each STB. There, they are decrypted either in the smart card 125 using the STB private user key or decrypted by the control circuit 128 using the private user key stored in the nonvolatile memory 125. In some embodiments, they are decrypted in the conditional access circuit 150 by accessing the private user key stored in nonvolatile memory 125 via data path 151 (dashed because it is an alterntive embodiment).

Encrypted sessions keys for all broadcast channels to which an STB has a subscription are sent to specific STBs periodically in the preferred embodiment. In alternative embodiments, even though the STB has been requested to tune a broadcast channel, the control circuit 128 sends the request upstream to the headend via DOCSIS transmitter 146 and data path 144 to aid in market research and/or Nielsen type surveys of viewer habits.

The headend then sends down the needed EMM message with an encrypted session key for the requested channel. This avoids the wasted bandwidth of an EMM message data carousel in the preferred embodiment.

The EMM messages are sent only to the STBs that need them by sending them on the DOCSIS PID of an MPEG transport stream. This is done by encapsulating them in DOCSIS frames that have the MAC address of the particular STB which is supposed to receive them. All MPEG packets having the DOCSIS PID are routed to the control circuit 128 that recovers each DOCSIS frame and determines if it is addressed to this STB. All other STBs reject the DOCSIS frames not addressed to them as having the wrong MAC address. The control circuit 128 recovers the EMM message and either decrypts the session key itself or send the EMM message to the smart card 125 or conditional access circuit 150 for decryption using the private user key of the STB.

In alternative embodiments, the encrypted session keys for all available channels can be sent in the MPEG transport stream on the private data PID or using an EMM PID which is listed in the channel lineup table in the form of a data carousel which is in-band in the MPEG transport stream which carries the encrypted data itself so only one tuner is needed. The session keys for each channel to which an STB has a subscription are encrypted with only that STB's private user key and broadcast as EMM messages in an MPEG transport stream on a QAM channel to which all STBs listen between times when they are tuned to some other QAM channel. The session keys for the next STB are then encrypted with that STB's private user key and broadcast to all STBs on the EMM PID or private data PID in the data carousel. Only the STB with the private user key with which a particular EMM message was encrypted can decrypt it. The process is repeated for all STBs to complete the data carousel. When all STBs have been sent their session keys, the process can start again or wait for some period and then start again with a fresh set of data as to which session keys each STB is entitled.

All STBs receive all these EMM messages, but only the STB with the private user key with which a particular EMM message has been encrypted can successfully decrypt that EMM message. In this way, even though an in-band data carousel is used, the EMM messages are delivered to only the STBs that need them.

In all these embodiments, the session keys are decrypted somewhere in the STB and stored in nonvolatile memory 125 so they can be called up when needed, as represented by step 368.

In some embodiments, the decrypted session key are sent to conditional access circuit 150 or kept in the control circuit 128, depending upon which circuit will use the session key to decrypt the service key in the ECM message.

In the preferred embodiment, all MPEG packets having the PID of the ECM message for the requested broadcast channel are extracted by the TS demultiplexer 136 and routed to the conditional access circuit 150 which has previously received the decrypted session key for the requested broadcast channel from the control circuit 128. In the conditional access circuit 150, the ECM message is decrypted using the decrypted session key for the requested broadcast channel to derive a decrypted working key or service key with which the video of the requested broadcast channel is encrypted, as represented by step 370.

MPEG packets having the PIDs of the encrypted video of the requested broadcast channel are extracted by the TS demultiplexer 136 and routed to the conditional access circuit 150. There, they are decrypted using the decrypted service key or working key and output as an MPEG packet stream to MPEG decoder 154, as symbolized by step 372. The MPEG packets containing audio, PCR timing data and any supplementary data etc. of the requested program are routed to appropriate circuitry in the MPEG decoder 154 via path 135. There is a Dolby™ decoder for the audio or some other audio processing circuitry and known circuitry to use the PCT timing data to synchronize the video with audio. If there is supplementary data such as for interactive service messages, there is other circuitry to utilize that data such as the multimedia graphics microprocessor 156 in FIG. 9 to which the supplementary data is sent and where it is processed to overlay message or menu data on the displayed picture on the TV 158. In alternative embodiments, the graphics sent as supplementary data of a program can be displayed by graphics processor 156 on the STB display 351 via data path 355 as well as data sent on the DOCSIS PID to control circuit 128 via data path 353. The dashed circuitry box 351 and all dashed data paths in FIGS. 8, 9, 10 and 11 indicate alternative embodiments.

The decrypted video MPEG packets are output on data path 149 and decompressed in MPEG decoder 154, as symbolized by step 376. The output video and audio signals can be in digital format, and NTSC (or PAL or SECAM) encoder can also be digital circuitry with the the remodulation circuit 160 being the first circuit that converts input digital data on line 157 to an analog radio frequency carrier on the appropriate channel frequency and bearing an NTSC, PAL or SECAM video signal for display on TV 158 or recording on VCR 158.

The MPEG decoder 154collects all the MPEG-2 packets having the same PID and constructs/reassembles access units contained in the packets. At this point, the audio and video data is not yet decoded nor is it presented to the user. The time when the access units should actually be decoded and presented to the user is controlled by decode (DTS) and presentation (PTS) timestamps in the transport stream. The MPEG decoder has an internal clock to determine when the exact decode and presentation time has arrived. This clock has to be accurately synchronized with the clock that was used when the decode and presentation timestamps were created. For MPEG-2 transport streams, this clock is called the program clock and can be used for one or more programs in the transport streams. To ensure that the program clock in the decoder is kept synchronized with the clock used to encode and multiplex the program, a PCR timestamp is periodically transmitted. The PMT table for each program defines in which transport packets the PCT timestamps for this program are found by specifying the PID values of these transport packets. The system time clock in the decoder is initialized by the first PCR and kept updated thereafter by subsequent PCRs.

The MPEG decoder outputs the decompressed video data as YUV or RGB format signals in digital or analog format to an NTSC (or PAL or SECAM) encoder 156. The YUV or RGB signal defines the intensity of the color of each pixel. The MPEG decoder also outputs the audio signal of the program in either analog or digital format depending upon the embodiment.

The NTSC encoder 156 takes the video and audio signals output by the MPEG decoder 154 and converts these signals into an NTSC, PAL, SECAM or other video signal on line 157, as symbolized by step 378. The signal on line 157 can also be analog or digital depending upon the embodiment.

Remodulation circuit 160 receives the NTSC, PAL or SECAM video signal on line 157 and modulates it onto an RF carrier on channel 3 or 4 if the STB is controlled by its own remote control. If the STB is controlled by the remote control of TV 158, then the remodulator modulates the video signal on line 157 onto an RF carrier having a frequency which corresponds to the broadcast channel selected by the user in the initial request. Step 380 represents the process of generating the RF output carrier carrying the NTSC, PAL or SECAM signal on line 157.

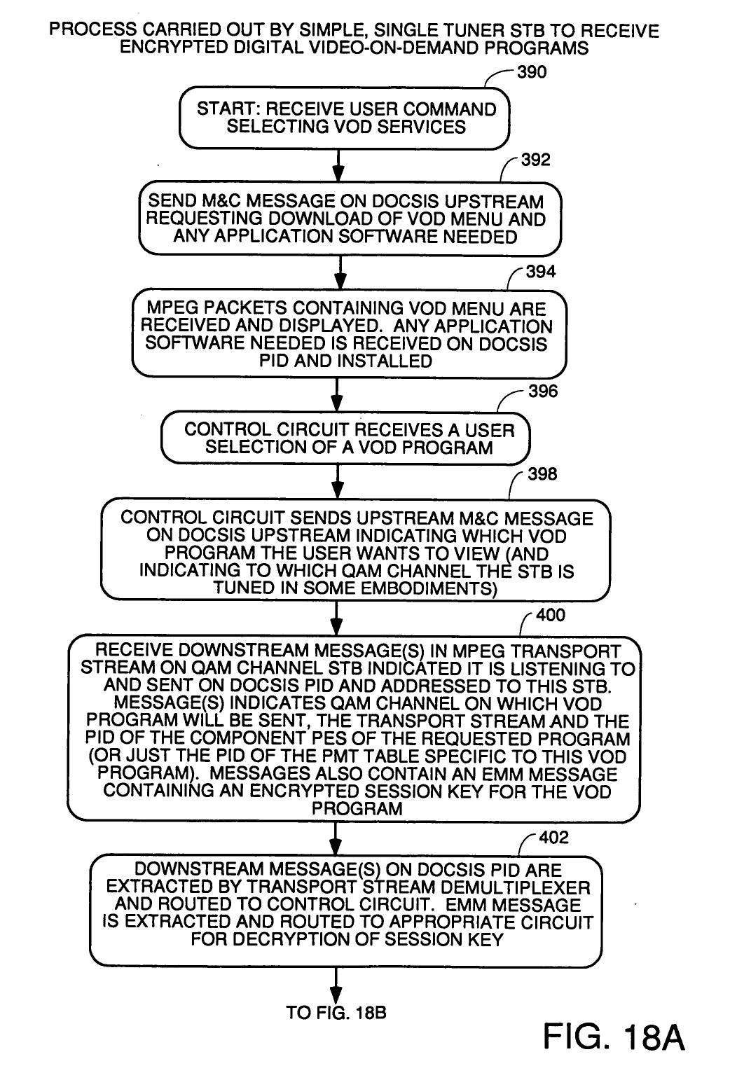

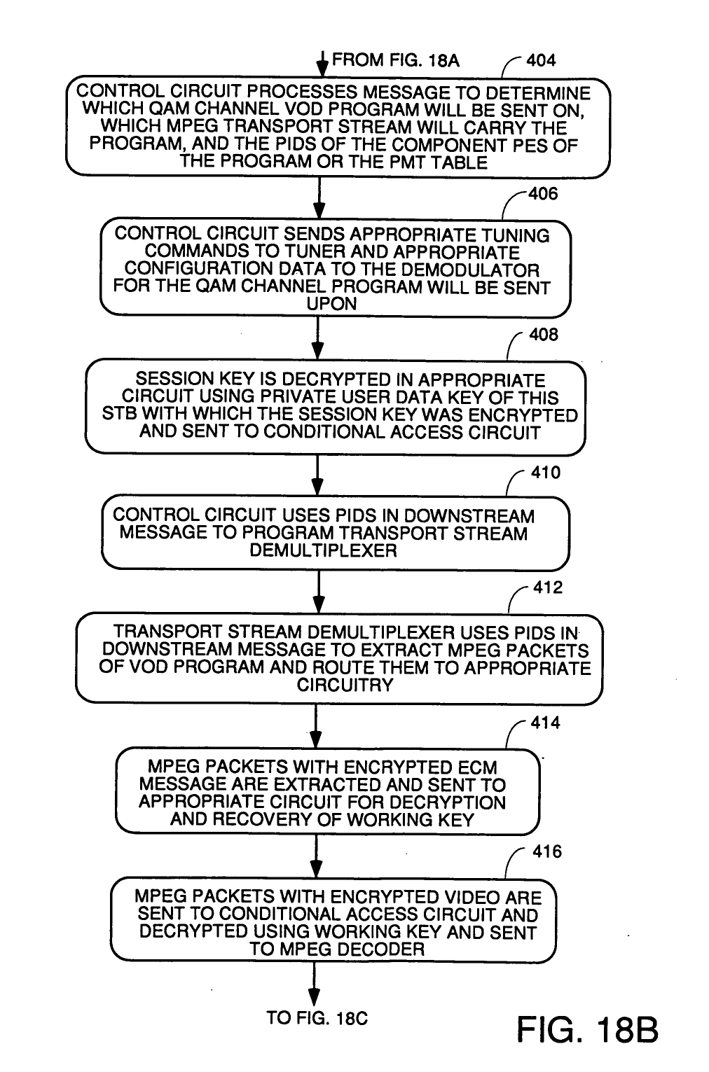

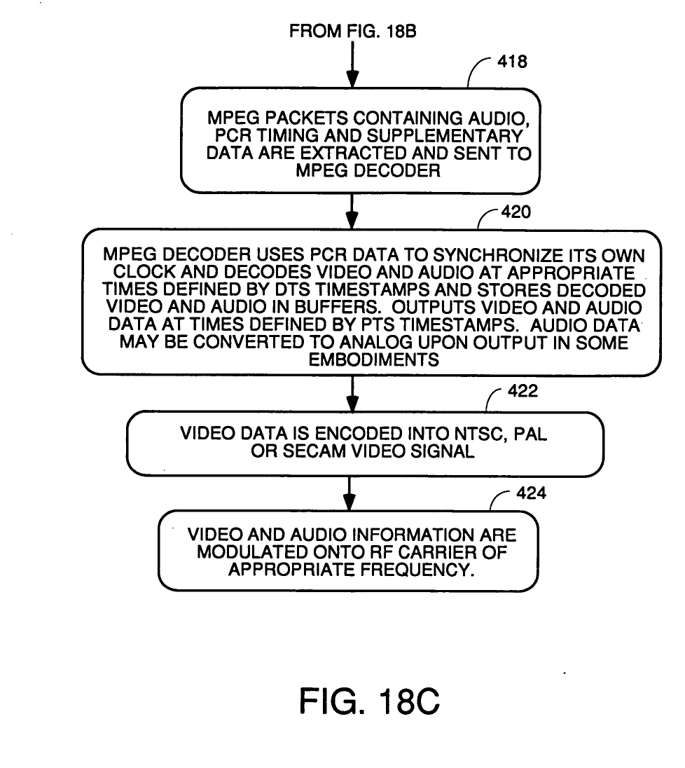

Referring to FIG. 18, comprised of FIGS. 18A through 18C, there is shown the process carried out in the simple STBs of FIG. 8 and any other embodiment that uses MPEG compression to receive and prepare for display video-on-demand programs. The processes of FIGS. 17 and 18 can also be practiced in alternative embodiments of the STBs disclosed herein, but if MPEG compression is not used, the steps are changed to use whatever decompression scheme is compatible with the transmission process and to use whatever mechanisms are used in the pertinent compression scheme in place of PIDs for multiplexing. The process starts with step 390 which symbolizes the control circuit receiving a command from the remote control that the user wishes to view a VOD selection.

The control circuit responds in step 392 by sending an M&C message on the DOCSIS upstream requesting download of the VOD menu and any application software it needs. In the preferred embodiment, this upstream message tells the headend which QAM channel to which the STB is tuned.

The headend receives this request and sends the VOD menu downstream in MPEG packets on the QAM channel the STB indicated it was tuned to, and sends the requested application software downstream on the DOCSIS PID on the same QAM channel. The application software MPEG packets are extracted by the transport stream demultiplexer and routed to the control circuit 128 which recovers the software and installs it.

In some embodiments, the VOD menu data is sent on the DOCSIS PID and the control circuit recovers the video data and sends it to the NTSC encoder 156 by a data path not shown in FIG. 8 or through the conditional access circuit 150 via path 137. The NTSC encoder then converts the video data to a video signal on line 157 which gets converted in remodulation circuit 160 into an RF carried modulated with a video signal for display.

In other embodiments, the VOD menu data is sent on MPEG packets having a specific PID such as the private data PID or some other PID and the headend sends a downstream message to the control circuit on the DOCSIS PID telling the control circuit on which PID the VOD menu data is transmitted. The control circuit then programs the transport stream demultiplexer to extract the MPEG packets with the PID of the VOD menu and send them to the conditional access circuit 150. If the VOD menu data is not encrypted, the conditional access circuit forwards the packets to the MPEG decoder which decodes them and sends them to the NTSC encoder 156 for conversion to a video signal. The process of receiving and displaying the the VOD menu and receiving and installing the application software is represented by step 394.

After viewing the VOD menu, the user moves the cursor to a VOD selection and selects it. The navigation software of the settop box receives the commands to move the cursor and knows where it is on the VOD menu when the user presses the select button. This select command is converted to an infrared or radio frequency command which the control circuit receives in step 396.

The control circuit responds in step 398 by sending an upstream message on the DOCSIS upstream which indicates which VOD selection the user wants to view. In the preferred embodiment, the upstream message also requests downloading of the session key for the selected program. In some embodiments, the upstream message also indicates the QAM channel to which the STB is tuned if that has not been previously indicated in another upstream M&C message and the downstream M&C message needed to properly program the transport stream demultiplexer is not sent on all QAM channels.

The headend responds to the VOD selection message by finding a server which has the requested program and starting a stream of data of MPEG packets containing the requested VOD program. The headend then finds a QAM channel that has an open MPEG transport stream and encodes the MPEG packets containing the requested program onto the MPEG transport stream. Each VOD program is stored on the server hard disk as MPEG packets. When a VOD program is ordered, the MPEG packets are encapsulated in IP packets having as their destination address the IP address of a particular QAM channel which has been assigned to transport the packets. The headend apparatus assigns a different IP address to every QAM channel. This IP address is used by the head end routing equipment to route the IP packets containing the MPEG packets ordered by a customer to the proper transmitter which is assembling the MPEG transport stream to be transmitted on the QAM channel assigned to the program. When the IP packets get to this transmitter, the IP packet headers are stripped off, and the MPEG packets are merged with the other packets the transmitter has composed that make up the MPEG transport stream. The headend circuitry assigns PIDs to the video, audio, PCR timing and any supplemental data that comprise the VOD program and records those PIDs in a PMT table for the requested program. The PMT table is transmitted as part of the transport stream. The headend then sends one or more downstream messages on the DOCSIS PID which indicates upon which QAM channel and transport stream the requested program is being sent and giving the PID of the PMT table, and, in embodiments where a data carousel is not used, the session key will also be sent either on the DOCSIS PID or on some PID listed in the CAT table or as defined in a downstream message to the STB. The PID of the CAT table may also be sent downstream on the DOCSIS PID if it is not listed in the PMT or some other table in some embodiments. In some embodiments, the downstream message will contain all the PIDs of the component parts of the program instead of the PID of the PMT table and the PID of the EMM message.

To minimize overhead, in the preferred embodiment, these downstream messages are sent only on the QAM channel the STB indicated it was tuned to in the upstream message. However, in other embodiments, these downstream messages (which are addressed to the particular STB in the DOCSIS frame) are sent on all QAM channels and it is unnecessary to send the QAM channel the STB is listening to in the upstream message(s).

In step 400, the STB receives the downstream message(s) mentioned in the paragraph next above on the QAM channel the STB indicated it was listening to. The messages are on the DOCSIS PID so they are routed to the control circuit 128. In the preferred embodiment, the control circuit recovers the EMM message on the DOCSIS PID and sends it to the smart card 125 for decryption. In the preferred embodiment, control circuit also recovers from the downstream messages: the ID of the transport stream on which the VOD program is being transmitted; the PID of the PMT table for the requested VOD program;

and the identity of the QAM channel on which the VOD program will be sent. In other embodiments, the PID 0 packets will be extracted and reconstructed by the control circuit to reconstruct the PAM table and the PAM table will then be consulted to determine the transport stream the requested program is on and the PID of the PMT table. In other embodiments, the PIDs contained in the PMT table for the requested VOD program will be sent directly to the STB by the headend.

Step 402 represents the above described process of extracting and routing downstream messages on the DOCSIS PID to the control circuit and extracting the EMM message packets and routing them to the appropriate circuit for decryption of the session key.

Step 404 represents the process of processing the M&C messages on the DOCSIS PID to extract information regarding the QAM channel, the particular transport stream and the PIDs of the component PES, PCR timing and ECM message of the requested VOD program. The PIDs of the components of the program and ECM messages may be included in the downstream messages directly. However, in the preferred embodiment, the PIDs of the requested program are extracted by reconstructing the PAT table from PID 0 packets to find the PID of the PMT table and extracting the PMT table packets, reconstructing the PMT table for the requested VOD program and extracting the PIDs of the requested program from the PMT table.

Once the downstream message data has been extracted and the PIDs of the ECM message and component parts of the program are obtained, step 406 is performed to send the appropriate tuning commands to the tuner 126. Appropriate configuration data for the downstream DOCSIS channel is also sent to QAM demodulator 132.

The EMM message session key is decrypted in step 408 and sent to the conditional access circuit 150. Depending upon the embodiment, this is done in the smart card 125, the control circuit 128 or the conditional access circuit 150.

In step 410, the PIDs of the components of the VOD program are used to program the transport stream demultiplexer. In the preferred embodiment, this is done by the control circuit receiving the PID 0 packets, reconstructing the PAT table and determining the PID of the PMT table of the requested VOD program and sending this PID to the transport stream demultiplexer. The demultiplexer 136 then extracts the PMT table for the requested VOD program and uses the PIDs therein to extract the MPEG packets containing the video, audio, PCR timing, ECM attribute, supplementary data etc.

In steps 412 and 414, the transport stream demultiplexer uses the PIDS of the requested program to extract the encrypted video data packets and ECM message packets and sends them to the conditional access circuit 150. The demultiplexer also extracts the audio, PCR timing and supplementary packets and sends them to the MPEG decoder 154 as represented by step 418. Step 414 also represents the process of using the decrypted session key previously derived to decrypt the ECM message to derive the working key.

Step 416 represents the process in the conditional access circuit of using the working key to decrypt the encrypted video packets (and/or audio packets if they are encrypted) and send the decrypted video packets to the MPEG decoder.

Step 420 represents the process in the MPEG decoder of using the PCR timing data to synchronize its internal clock to the clock that was used to MPEG encode the program. It then uses its internal clock and DTS timestamps in the video and audio data streams to decode the video and audio data and stores the decoded video and audio data in separate buffers. The video and audio data in the video and audio buffers is output in synchronism as determined by PTS timestamps in the video and audio data stream. In some embodiments,

### LOLA INTERFACE

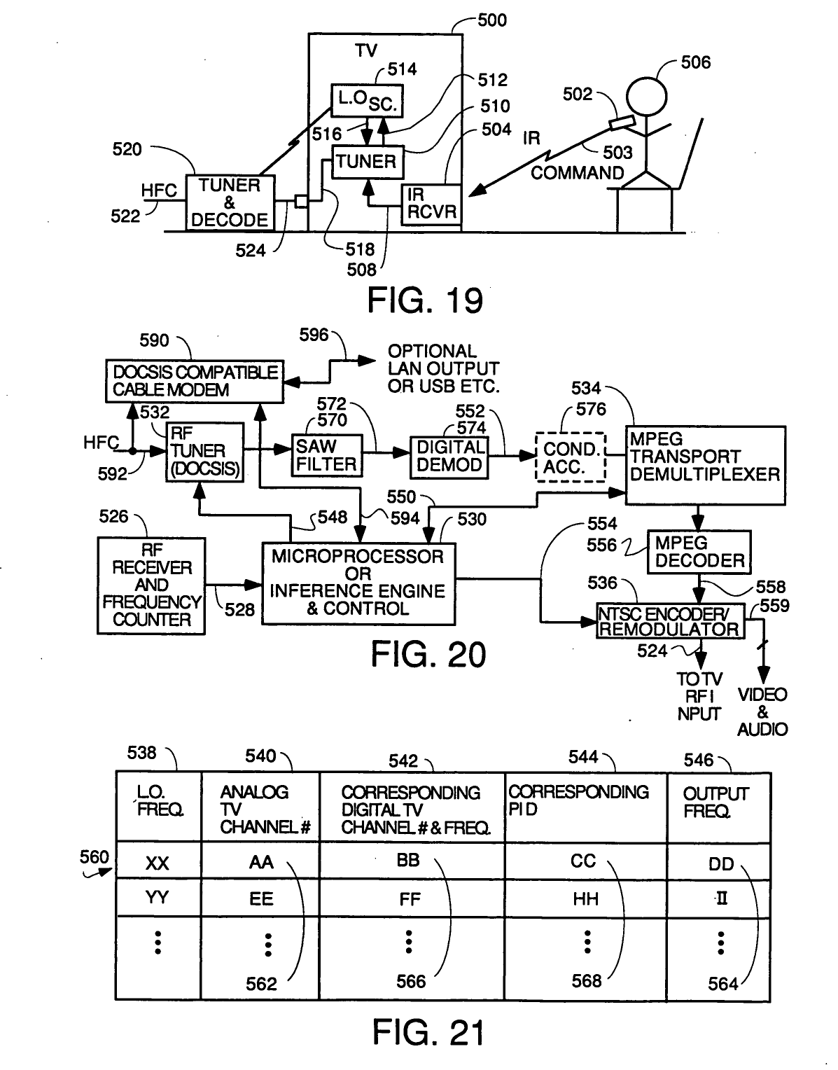

Referring to FIG. 19, there is shown a diagram of the connections of a digital television viewing system which uses a digital tuner/decoder which has no remote control and which does not have to be placed within line of sight of the viewer to receive infrared commands like most digital set top boxes. Television 500 has a remote control 502 which sends infrared commands 503 from user 506 to infrared receiver 504 in the TV. The infrared receiver 504 receives and decodes these infrared commands and sends electrical command signals on line 508 to the television's tuner 550. The tuner 510 is capable of tuning to 158 different channel numbers if the TV is cable ready or to at least channel 69 if the TV is just a VHF and UHF tuner. As the tuner is commanded to tune to a different TV channel, it sends a command on line 552 to local oscillator 514 telling it what frequency local oscillator signal to generate on line 516. The local oscillator signal on line 516 is used by the tuner to mix the incoming RF signal on line 518 down to an intermediate frequency where filtering and other conventional processing by circuitry which is not shown is accomplished. All this circuitry is designed to work with old fashioned analog TV channels which have different center frequencies and which are 6 MHz wide in bandwidth.

To adapt an HFC system which sends analog video channels to a conventional analog TV to delivery of digital braodcast channels and VOD however requires an adapter which can tune the desired digital channel and cull out the MPEG packets in the transport stream having the PID of the desired channel. That is the function of tuner/demodulator 520. This unit 520 functions to detect what channel the tuner 510 is tuned to by detecting the frequency of the radio frequency emissions of the local oscillator 514 and making a deduction as to what channel the user has commanded the tuner 510 to tune in. This channel number is then mapped to a particular digital channel center frequency and a particular subchannel PID within that digital channel. This digital channel is then tuned in by tuner 520 from the signals on HFC coaxial cable 522, and the particular subchannel's MPEG packets are demultiplexed by an MPEG transport stream demultipexer. The resulting MPEG packets of the desired digital channel are then converted to a baseband analog video signal, and that signal is modulated onto an RF carrier having the center frequency of the analog video signal TV channel requested by the user. This conventional analog TV signal at the frequency of the requested analog TV channel is then output on line 524 which is coupled to the RF input of the conventional TV.

FIG. 20 is a more detailed block diagram of a tuner/decoder 520 that does not require its own remote control and which provides digital video tuning capability. A radio frequency receiver 526 detects the RF emissions of local oscillator 514 and counts the frequency thereof. The frequency of these emissions is communicated on bus 528 to a microprocessor or inference engine and control logic 530. The function of the microprocessor or inference engine is to deduce the analog TV channel the user has requested from the frequency of the emissions of the local oscillator 514 and generate suitable control signals to control an RF tuner 532, an MPEG transport demultiplexer 534 and a remodulator 536 to do the right thing. Specifically, the microprocessor or inference engine 530 receives data on line 528 that defines the frequency that local oscillator 514 in FIG. 19 is generating. This data is used as a search key to search a look up table that relates frequency of the local oscillator 514 to the requested analog TV channel number and the corresponding digital TV channel number and frequency, the corresponding subchannel PID number and an output frequency. The term subchannel PID here is used to specify any means for separating out the MPEG packets on a particular digital subchannel including a plurality of PIDS of a particular video program. The results of the search are used to generate a control signal on bus 548 which causes RF tuner 532 to tune to the proper center frequency of the digital QAM channel that maps to the digital broadcast channel that maps to the requested analog TV channel and tune it in. The results of the search are also used to generate control signals on bus 550 which tell the MPEG transport demultiplexer which MPEG packets (selected by the PID or PIDs defined on bus 550) to extract out of the MPEG transport stream on bus 552. The results of the search cause the microprocessor 530 to also generate the proper control signals on bus 554 which tell the remodulator 536 what frequency of RF carrier to generate for purposes of being modulated with the analog TV signal received on line 558 from MPEG decoder 556.

One embodiment of a lookup table used to do the mapping and which is searched by the microprocessor 530 or inference engine is shown in FIG. 21. The table has one column 538 for the local oscillator frequency, a column 540 for the analog TV channel number that corresponds to that local oscillator frequency, a column 542 for the corresponding digital TV channel number and its center frequency that is mapped to the requested analog TV channel number, a column 544 for the corresponding subchannel PID (or PIDS) that is/are mapped to the requested analog TV channel number, and a column 546 that contains the output frequency of the RF carrier onto which the requested digital data is remodulated as a conventional analog TV signal. This will be the center frequency of the requested analog TV channel listed in column 540, so column 540 and 546 can be combined by using a data structure where a certain number of bits define the analog channel number and the remainder of the bits in the field define the output frequency for that channel.

The lookup table is used by the microprocessor 530 as follows. Suppose a local oscillator frequency of XX is detected by the RF receiver and frequency counter 526. This data is used by the microprocessor to search the table and an entry in row 560 is found for that frequency. Field 562 tells the CPU 530 that this frequency of local oscillator emissions means the user requested analog TV channel AA which has a center frequency of DD as indicated by the data in field 564. This also tells the CPU 530 that the corresponding digital channel is BB as indicated by the data in field 566 and that the corresponding subchannel PID or PIDs is/are CC that maps to analog TV channel XX. BB is then used by the CPU to generate a control signal on bus 548. This causes a local oscillator in RF tuner 532 to generate an appropriate frequency to beat down the center frequency of digital channel BB to an IF frequency at the center frequency of a SAW bandpass filter 570. The SAW filter is a bandpass filter with sharp rolloff characteristics which filters out signals that are not part of the desired digital channel. The filtered signal is output on line 572 to a digital demodulator 574. In some embodiments, a bandpass filter inside tuner 532 is used instead of said SAW filter 570.

The digital demodulator is a known circuit, and any digital demodulator in the prior art such as the Hughes DirecTV receivers or the digital demodulator in any set top box with digital video reception capability will suffice for circuit 574. In embodiments where a thin DOCSIS management and control stream is transmitted on the DOCSIS PID and the MPEG packets containing said DOCSIS PID are to be recovered by the combination of tuner 532, demodulator 574 and transport stream demultiplexer 534, the demodulator 574 can be the demodulator of a DOCSIS compatible cable modem. The digital demodulator typically performs the following functions. It filters the received data in a matched filter, it sometimes filters the received data in an equalization filter, it detects the payload data in the received constellation points and uses Viterbi decoding to use the redundant bits to do error correction if Trellis Coded Modulation was used, it outputs payload data, deinterleaves the bits of payload data to reconstruct Reed Solomon code words, error corrects the code words, deinterleaves the RS codewords to reassemble the original MPEG transport stream which is then output on bus 552. An optional conditional access circuit 576 then descrambles the data if the user is an authorized subscriber.

The microprocessor 530 uses the CC data in field 568 to generate programming instructions on bus 550 that indicates the PID or PIDs of the MPEG packets to be culled out of the MPEG transport stream by MPEG transport demultiplexer 534. These MPEG packets are culled out and sent to an MPEG decoder 556. The MPEG decoder 556 converts the MPEG packets to audio and video data signals symbolized by line 558. An encoder in remodulator 536 converts the digital video and audio data on line 558 into an NTSC, PAL or SECAM video signal and an audio signal. These video and audio signals can then be output in baseband form on line 559, or they can be modulated onto an RF carrier having the frequency of analog TV channel 3 or 4 or some other analog TV channel frequency if a LOLA interface is used. In embodiments where the TV has audio and video signal inputs to receive baseband audio and video signals, the remodulator part of block 536 and line 554 to control the frequency of the RF carrier can be deleted as can the programming of the microprocessor 530 to control the RF output frequency of the remodulator part of block 536.

In embodiments where the remodulator is used, the microprocessor 530 then uses the DD data in field 564 to generate a control signal on bus 554 which tells remodulator 536 the desired output frequency of a radio frequency carrier signal the remodulator generates. The analog video signal on line 558 is then modulated onto this carrier signal, and the modulated RF signal is output on line 524 to the TV RF input. The user can then view the selected digital channel simply by selecting a channel number with the conventional TV remote control which maps to that digital TV channel and subchannel PID or PIDs encoding the video signal of the desired program.

It is also possible to manage the circuitry in FIG. 20 from the CMTS by in-band management and control information sent to a DOCSIS compatible cable modem (CM) 590 which is included in some alternative embodiments. The CM 590 is coupled to HFC system 592 and structured to locate a valid DOCSIS downstream channel therein and do all the conventional DOCSIS process of training, registering with the CMTS etc. The CMTS can then send management and control information to the CM which is passed to the microprocessor 530 (or inference engine) via bidirectional bus 594. The microprocessor uses this management and control information to manage the system of FIG. 20. Upstream status information or other requested information is passed back to the CM from the microprocessor on bus 594 and is sent upstream to the CMTS by the CM 590. Additionally, the CM 590 can have an optional LAN, USB, SCSI or other output 196 suitable for coupling to other customer premises equipment such as personal computers, IP telephony equipment including phones, FAXes, video conferencing apparatus, security cameras, digital video recorders with LAN inputs or anything else which can use DOCSIS digital broadband data.

### SUMMARY OF ADVANTAGES

In summary, the advantages of using a DOCSIS M&C channel within an MPEG-2 multiplex delivering interactive and VOD and digital video broadcast services are:

(1) DOCSIS is a proven technology with existing hardware and software already designed and built to implement the various functions described herein;

(2) a thin DOCSIS channel allows network management without an OOB channel and allows STBs to be less complex and more inexpensive in that they only need a single tuner, and this allows them to be managed from the head end;

(3) subscriber management by on-demand, targeted download of conditional access data via the thin DOCSIS channel for one way key transmission downstream only thereby securing the downstream MPEG-2 multiplex programs from unauthorized viewing or access (alternatively, the DOCSIS key exchange protocol can be used to render both the downstream and upstream DOCSIS channels secure and to protect the downstream MPEG-2 multiplex programs from unauthorized viewing or access);

(4) secure software application download of only the applications needed to only the STBs that need it—this simplifies the STBs and makes them less expensive to build and it allows bug fixes and upgrades from the head end and it “future-proofs” the STBs;

(5) the bidirectional nature of the thin DOCSIS channel allows interactive and on-demand services to be implemented, and they can be implemented in a more secure way since the DOCSIS key exchange protocol authenticates the source of a request for an interactive or VOD service;

(6) a thin DOCSIS channel allows event provisioning by allowing collection of requests from the STBs for pay-per-view events and sending of targeted conditional access keys to decrypt the pay-per-view event MPEG packets transmitted in the MPEG-2 multiplex;

(7) on demand delivery of only the program guide data needed to only the STB that requested it can be done over the thin DOCSIS channel thereby preventing the waste of bandwidth of data carousels in either OOB or in-band channels; and

(8) a thin DOCSIS channel also allows emergency alert system data to be transmitted in an MPEG-2 multiplex.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A digital single tuner set top decoder (hereafter STB), comprising:
one or more data paths which can take the form of one or more buses for coupling to a control circuit and hereafter referred to as a bus;
a frequency nimble QAM channel tuner having a control input coupled to said bus, and having an input for coupling to coaxial cable of a cable TV system;
a quadrature amplitude (QAM) demodulator means coupled to receive signals output by said tuner for recovering data of a transport stream or multiplex therefrom;
a transport stream demultiplexer means coupled to receive filter instructions from said bus for extracting and outputting packets having selected PIDs from said transport stream or multiplex including at packets having a DOCSIS PID, and routing said extracted packets to appropriate circuits to process each type of packet;
a conditional access means for receiving a decrypted session key and encrypted packets sent to said conditional access means by said transport stream multiplexer and for decrypting some of said encrypted packets using said session key to recover a working key and using said working key to decrypt encrypted packets of said requested program;
decompression means coupled to receive decrypted video packets from said conditional access means and audio and other packets that comprise said requested program, for decompressing and decoding said packets so as to output YUV or RGB information and properly synchronized audio information;
an encoder means for receiving said YUV or RGB information and generating a video signal therefrom;
a remodulation circuit for receiving said video signal from said encoder and for receiving an audio signal, and for modulating said video and audio signals onto a radio frequency carrier having a predetermined frequency;
a control circuit for receiving user commands and controlling said set top box by communicating with selected circuits in said set top box via said bus or other data paths;
a memory coupled to said control circuit for storing packets routed thereto by said transport stream demultiplexer;
key store means for storing a private user key of said set top decoder in nonvolatile memory and decrypting a session key in an EMM message using said private user key; and
a DOCSIS upstream transmitter coupled to said control circuit by said bus.

2. [conditional access circuit and key store means are removable smart card] The apparatus of claim 1 wherein said key store means and said conditional access means are both embodied in a removable card which contains a secure microprocessor to perform the function of at least said conditional access means, and wherein said decompression means and said encoder means are removable as one or more modules and can be replaced individually or as a unit by one or more modules which contain decompression circuitry for different compression standards and encoder circuitry to encode output from said decompression circuitry into a selected one of a plurality of different television signal standard formats.

3. [two way conditional access] The apparatus of claim 1 wherein control circuit includes means to receive requests for encrypted programs and to send an upstream message requesting transmission of a session key needed to decrypt a working key transmitted with said requested program and to receive a downstream message containing the encrypted session key and decrypt said session key with a private user key and then use the decrypted session key to decrypt a working key transmitted with the encrypted program data and use the decrypted working key to decrypt the encrypted program data.

4. [EMM and ECM decrypted in smart card, CA decrypts video] The apparatus of claim 1 wherein said key store means contains a nonvolatile memory with stores said private user key and contains a secure microprocessor which is programmed to use said private user key to decrypt a session key in EMM message bearing MPEG packet routed to said secure microprocessor by said transport stream demultiplexer, and programmed to use said decrypted session key to decrypt ECM messages in MPEG packets extracted by said transport stream demultiplexer and sent to said secure microprocessor so as to recover a working key, and programmed to send said working key to said conditional access means, and wherein said removable card is connected to the rest of the circuitry of said set top decoder by an edge connector or a series of conductive contact pads with mate with conductors which touch said pads when said card is seated in said set top decoder.

5. [upstream message sent even for request for broadcast and request immediate transmission of I frame and narrowcasting] The apparatus of claim 1 wherein said control circuit is a microprocessor programmed to receive requests for a broadcast channel or a video-on-demand program or a pay-per-view event, and generate and send upstream requests via said DOCSIS upstream transmitter to download any application programs needed and to download any decryption keys needed to decrypt said requested program and to send an I-frame immediately via said DOCSIS PID or via a “native” transmission normally used to transmit I-frames, and wherein said upstream messages include an indication of the QAM channel(s) on which said set top decoder is tuned to receive downstream M&C messages such that said headend can narrowcast M&C messages to only the cable modems that need them thereby minimizing the number of QAM channels on which downstream messages must be sent.

6. [application programs sent down on DOCSIS PID, extracted and installed] The apparatus of claim 5 wherein said microprocessor is programmed to receive MPEG packets having the DOCSIS PID and extract management and control messages and data therefrom including application programs and programmed to install on said microprocessor any said application program needed to do any necessary processing in said set top decoder for functions for which the software is not resident and execute said program.

7. [functions of control circuit for both VOD and b cast] The apparatus of claim 1 wherein said control circuit performs the following functions:
receive user commands including commands to view digital video broadcast channel lineups or video-on-demand menus;
receive and display channel lineup data and/or video-on-demand menus, and navigate on on-screen menus, channel lineup tables etc. in response to user commands, and receive user selection commands such as requests to view particular video broadcast channels or view particular video-on-demand selections;
send management and control data on a DOCSIS upstream including requests for video on demand programs, reports of channel selections for video broadcasts, requests for conditional access keys for selected programs, requests to download software applications needed to provide various services, and indicating to which QAM channel the STB is tuned;
receive downstream messages on the DOCSIS PID in an MPEG transport stream and recover the data therein;
receive requested software applications transmitted in MPEG packets having the DOCSIS PID and recover and install them;
search the channel lineup table using data regarding a user selection of a broadcast channel to find a corresponding mapping entry for the selected video broadcast and gather data regarding which QAM channel the requested digital video broadcast will be on and what will be the PIDs of its video, audio, PCR timing, supplemental data, ECM message and, in some embodiments, the EMM message carrying the session key for the selected channel or program;
receive and recover the data from downstream messages on the DOCSIS PID in response to upstream VOD requests, said downstream messages indicating the QAM channel on which said VOD request will be sent, the transport stream on which said VOD request will be sent and information from which the PIDS of the component parts of said requested VOD program can be obtained directly or indirectly;
perform all necessary functions to send tuning commands and any other data needed to cause said tuner to tune and receive the appropriate QAM channel containing the requested program;
send appropriate configuration data to said QAM demodulator so that it can demodulate, deinterleave and error correct the received data of an MPEG multiplex or transport stream sent on a QAM channel;
determine the PIDs of the component parts of the requested video program including at least the video, audio, and PCR timing, and the ECM message data or attribute if said ECM message is sent as part of the video program;
receive EMM messages containing encrypted session keys and addressed or encrypted so that only said STB which sent said upstream request for a video program can decrypt them using a private user key of said STB, and either decrypt said session key using said private user key or send the EMM messages to key store means for decryption so as to obtain a decrypted session key;
send the decrypted session key to appropriate circuitry for decryption of a working key in said ECM message or recover said working key in said control circuit using said decrypted session key and send said working key to said conditional access means; and
generate and send to said transport stream demultiplexer appropriate filter commands to cause MPEG packets having PID 0 and the DOCSIS PID to be selected from said MPEG multiplex and sent to said control circuit and to cause MPEG packets having the video PID to be extracted and sent to said conditional access means for decryption and to cause MPEG packets having the audio PID, PCR PID and supplemental data PID to be extracted and sent to the appropriate circuits for processing to decode said audio data and synchronize it with decoded video data, and to extract MPEG packets having a PID indicating they carry an EMM message and sent them to the appropriate circuit for decryption of the session key.

8. The apparatus of claim 7 wherein said control circuit is a microprocessor programmed to find the PIDs of the component parts of the requested VOD program by performing the following functions:
construct a PAT table from said MPEG packets having PID 0 which are extracted by said transport stream demultiplexer and stored in said memory for processing by said control circuit when a video-on-demand program has been selected;
use the PAT table to determine the transport streams that are in any multiplex output from said quadrature amplitude demodulator and the programs that are in each transport stream;
process the PAT table to determine the PID of packets encoding a PMT table for particular requested video-on-demand program carried on a particular transport stream;
send filter commands to the transport stream demultiplexer telling it to filter out MPEG packets having the PID of said PMT table and use said PMT table to determine the PIDs of the component parts of the requested VOD program.

9. The apparatus of claim 8 wherein said microprocessor is programmed to perform the step of using the PCT table to determine the PIDS of the component parts of the requested VOD program by performing the following steps:
receive MPEG packets having the PID of said PMT table from said transport stream demultiplexer and reconstruct said PMT table;
determine from data in said PMT table which PIDs MPEG packets encoding various parts of said requested VOD program will have;
generate and send to said transport stream demultiplexer filter commands suitable to cause said transport stream demultiplexer to filter out at least MPEG packets bearing video, audio, ECM and PCR timing data of said requested video-on-demand program and send said extracted MPEG packets to appropriate circuitry in said STB for decoding.

10. The apparatus of claim 1 wherein said control circuit is a microprocessor programmed to receive MPEG packets having the DOCSIS PID which contain a channel lineup table which contains all information needed to determine all necessary information to tune to a digital video broadcast table including the PIDS of at least channels to which said set top decoder has a subscription, and is further programmed to reconstruct said channel lineup table and seach said channel lineup table for the channel for which a request to view has been received from a user and determine the PIDs of video, audio, PCR and other components of said requested channel and use said PID information to program said transport stream demultiplexer and use other information gleaned from said channel lineup table to send appropriate commands to said tuner and said quadrature amplitude demodulator to properly receive said requested channel.

11. The apparatus of claim 1 wherein said control circuit is a microprocessor programmed to receive a request for a VOD program(s) and generate and send via said DOCSIS upstream transmitter a request to download only the conditional access key(s) needed to decrypt the requested VOD program(s).

12. [requests immediate download of an I-frame] The apparatus of claim 1 wherein said control circuit is a microprocessor programmed to receive a request for a VOD program(s) and generate and send via said DOCSIS upstream transmitter a request to download only the conditional access key(s) needed to decrypt the requested VOD program(s) and download of the MPEG data of the program and any application program software needed to service the request, and wherein said microprocessor is further programmed to request immediate download of an MPEG I-frame for the requested program such that decoding of the requested program data in the Decompression means can begin immediately upon receipt of the I-frame and the rest of the MPEG data of the program does not have to wait for the I-frame for the program to come in the natural order of the MPEG transport stream.

13. The apparatus of claim 1 wherein said tuner is structured such that it can be tuned to a frequency of a downstream channel on which an MPEG multiplex is modulated and filter out radio frequency signals outside said downstream channel, and reduce the frequency of the received signal to an intermediate frequency and digitize said intermediate frequency signal.

14. The apparatus of claim 1 wherein said control circuit is a microprocessor programmed to receive a request to tune a digital broadcast channel or a video-on-demand program and respond by sending an upstream request for immediate downstream transmission of an I-Frame for said requested broadcast channel or video-on-demand program.

15. The apparatus of claim 1 wherein said tuner contains narrowband excision circuitry to remove narrowband noise.

16. The apparatus of claim 1 wherein said control circuit includes a LOLA interface for detecting the digital broadcast channel a user wishes to view by receiving electromagnetic radiation from the local oscillator of a television set coupled to said STB.

17. The apparatus of claim 1 wherein said tuner comprises:
a gain control circuit controlled by commands received at said control input;
a broad bandpass filter coupled to receive signals output by said gain control circuit and filter out unwanted radio frequency signals outside a frequency band which includes said selected channel;
a mixer and local oscillator coupled to mix output signals from said broad bandpass filter down to an intermediate frequency;
a narrow passband filter controlled by said control circuit to have a passband bandwidth equal to the bandwidth of said selected channel;
an analog-to-digital converter for digitizing the filtered signal output from said narrow passband filter.

18. The apparatus of claim 1 wherein said control circuit is a microprocessor programmed to execute a resident operating system and navigation program and programmed to request download of any other application program needed to carry out any function requested by a user which cannot be performed by said navigation program.

19. The apparatus of claim 1 wherein said control circuit is a microprocessor programmed to receive requests for encrypted digital video broadcast channels or encrypted video-on-demand programs and send upstream requests on a DOCSIS channel requesting downstream transmission of an encrypted session key for only said requested broadcast channel or video-on-demand program.

20. The apparatus of claim 1 wherein said control means is a microprocessor, and wherein said transport stream demultiplexer is structured or programmed to select out MPEG packets having PID 0 encoding a PAT table and storing said packets in said memory, and wherein said microprocessor is programmed to:
construct said PAT table from said MPEG packets having PID 0 stored in said memory;
use said PAT table to determine the transport stream that are in any multiplex output from said quadrature amplitude demodulator;
process said PAT table to determine the PID of a packets encoding PMT table for an MPEG transport stream containing programs or services which have been requested;
send filter commands to said transport stream demultiplexer means telling it to filter out M packets having said PID of said PMT table and store them in said memory;
construct said PMT table from said packets with said PID of said PMT table which have been stored in said memory;
compare the video programs or services which has been requested by a user to data in said PMT table to determine the PIDs which MPEG packets encoding said requested programs or services will have;
generate and send to said transport stream demultiplexer filter commands suitable to cause said transport stream demultiplexer to filter out MPEG packets bearing data of said requested programs and/or services.

21. The apparatus of claim 1 wherein said conditional access means comprises means for decrypting requested programs and services using a DOCSIS key exchange protocol.

22. The apparatus of claim 1 wherein said control circuit is programmed to receive EMM messages as a data carousel on the DOCSIS PID and select only EMM messages having the address or ID of said STB in the DOCSIS frame and recover an encrypted session key from said EMM messages corresponding to a requested video program using a private user key for said STB.

23. The apparatus of claim 1 wherein said control circuit is programmed to receive EMM messages as a data carousel on the DOCSIS PID and select only EMM messages having the address or ID of said STB in the DOCSIS frame and recover an encrypted session key from said EMM messages corresponding to a requested video program and send said encrypted session key to said key store means for decryption using a private user key for said STB.

24. A set top decoder apparatus comprising:
a quadrature amplitude modulated channel radio frequency tuner having an input for coupled to a hybrid fiber coaxial cable system;
a quadrature amplitude modulated channel digital demodulator coupled to receive digital sample data output from said tuner and functioning to recover MPEG packets;
an transport stream demultiplexer coupled to receive packets output from said demodulator and functioning to extract packets having selected PIDs or other identifiers and route them to appropriate circuitry in said set top decoder for further processing;
a decoder coupled to receive extracted compressed data packets from said transport stream demultiplexer for generating synchronized video and audio data of a requested video program;
an encoder to receive said video and audio data output by said decoder and generate video and audio signals therefrom;
a microprocessor coupled at least to said transport stream demultiplexer and said tuner for controlling said set top decoder; and
means for receiving user commands and transferring data to said microprocessor.

25. The apparatus of claim 24 further comprising a DOCSIS compatible cable modem bidirectionally coupled to said microprocessor and having an input for coupling to said hybrid fiber coaxial cable system and having a bus and/or local area network port, for sending and receiving broadband digital data over DOCSIS upstream and downstream channel on said hybrid fiber coaxial cable system.

26. The apparatus of claim 24 wherein said means for receiving user commands is a LOLA interface.

27. The apparatus of claim 24 further comprising a remodulator coupled to receive said audio and video signals from said encoder and convert them to an RF carrier on channel 3 or channel 4 modulated with said audio and video signals.

28. The apparatus of claim 24 wherein said means for receiving user commands is a LOLA interface, and further comprising a remodulator coupled to receive said audio and video signals from said encoder and coupled to receive RF output frequency commands from said microprocessor, and functioning to modulate said audio and video signals received from said encoder onto an RF carrier having a frequency defined by a command from said microprocessor such that said RF carrier can be used by a conventional TV to display a requested video program.

29. A set top decoder apparatus comprising:
a radio frequency tuner having an input for coupled to a hybrid fiber coaxial cable system;
a QAM channel digital demodulator coupled to receive digital sample data output from said tuner and functioning to recover packets;
an transport stream demultiplexer coupled to receive packets output from said demodulator and functioning to extract packets having selected PIDs or other identifiers and route them to appropriate circuitry in said set top decoder for further processing;
a decompression decoder coupled to receive extracted packets from said transport stream demultiplexer and decompress them so as to generate synchronized video and audio data of a requested program;
an encoder for converting said video and audio data to video and audio signals;
a DOCSIS compatible cable modem having an input for coupling to a hybrid fiber coaxial cable system and having a bus and/or local area network output for coupling to one or more computers or other devices which need to send and/or receive DOCSIS data on DOCSIS upstream and downstream channels;
a microprocessor coupled to said DOCSIS compatible cable modem and coupled at least to said transport stream demultiplexer and said tuner, for controlling said set top decoder to receive requested video broadcasts and/or video-on-demand or pay-per-view programs, and programmed to receive management and control data from a headend via packets transmitted as part of said transport stream containing one or more video programs and for sending upstream management and control data via said DOCSIS compatible cable modem; and
means for receiving user commands specifying desired video programs to view and transferring data to said microprocessor.

30. An apparatus comprising:
a radio frequency receiver and frequency counter to receive and determine the frequency of radio frequency emissions of a local oscillator of a tuner of an analog TV which has been tuned to a requested analog TV channel;
a computer or inference engine coupled to receive the frequency detected by said radio frequency receiver and frequency counter and programmed or structured to use said frequency to look up the frequency of a corresponding analog TV channel and map that frequency to the frequency of a corresponding digital quadrature amplitude modulated radio frequency channel broadcast on a hybrid fiber coaxial cable CATV system by a headend and the PID or PIDs of a requested video program carried on a corresponding subchannel in an MPEG transport stream or MPEG multiplex carried on said quadrature amplitude modulated radio frequency channel;
means coupled to said computer or inference engine for receiving control signals generated by said computer or inference engine to tune to and receive said digital quadrature amplitude modulated radio frequency channel and recover the MPEG packets of said MPEG transport stream or MPEG multiplex and extract therefrom MPEG packets having said PID or PIDs of said requested video program and convert said MPEG packets to a video signal suitable for viewing on a TV;
a DOCSIS compatible cable modem coupled bidirectionally to said computer and inference engine and having an input for coupling to said hybrid fiber coaxial cable system and having a standard bus or local area network interface for coupling to personal computers, voice-over-IP telephony equipment or any other device that needs to send data to and/or received digital data from said headend.

31. The apparatus of claim 30 further comprising a remodulator for modulating said video signal onto an RF carrier having the frequency of said requested analog TV channel;

32. A set top decoder apparatus comprising:
a radio frequency tuner having an input for coupled to a hybrid fiber coaxial cable system;
a QAM channel digital demodulator coupled to receive digital sample data output from said tuner and functioning to recover packets;
an transport stream demultiplexer coupled to receive packets output from said demodulator and functioning to extract packets having selected identifiers and route them to appropriate circuitry in said set top decoder for further processing;
decompression means coupled to receive extracted packets from said transport stream demultiplexer for generating synchronized video and audio data of a requested video program;
an encoder means for receiving said video and audio data output by said decompression means and generating therefrom one or more signals carrying video and audio information of said selected program;
a microprocessor coupled at least to said transport stream demultiplexer and said tuner and programmed to control said set top decoder;
a buffer memory coupled to said transport stream demultiplexer and said microprocessor, and coupled to said decompression means;
conditional access means coupled to said transport stream demultiplexer, said buffer memory and said microprocessor, for carrying out a bidirectional conditional access protocol for requesting a session key for a requested program from a headend, decrypting a session key in EMM message data sent in response to said request, said EMM message data containing a session key for a requested encrypted video program, said decryption done using a private user key and for using the decrypted session key to decrypt ECM message data sent as part of said transport stream which carries said requested, encrypted video program to derive a working key and for using said working key to decrypt said requested encrypted video program;
a bulk storage medium for storing data;
a high data throughput bulk storage controller coupled to said microprocessor, said buffer memory and said bulk storage medium for controlling write and read operations of said bulk storage medium;
means for receiving user commands and transferring data to said microprocessor;
and wherein said microprocessor is programmed to control circuits in said set top decoder and said bulk storage medium through said bulk storage controller so as to cause said set top decoder to have personal video recorder capabilities.

33. The apparatus of claim 32 further comprising an analog-to-digital (A/D) converter coupled to analog video and audio data inputs of said STB, and an MPEG encoder having an input coupled to an output of said A/D converter and having an output coupled to said buffer memory.

34. The apparatus of claim 32 wherein said decompression means and said encoder means are removable as one or more modules and can be replaced individually or as a unit by one or more modules which contain decompression circuitry for different compression standards and encoder circuitry to encode output from said decompression circuitry into a selected one of a plurality of different television signal standard formats.

35. The apparatus of claim 32 wherein said conditional access means is removable and can be replaced by a substituted conditional access means.
